(19) United States
(12) Patent Application Publication
(10) Pub. No.: US 2004/0024750 A1
(43) Pub. Date: Feb. 5, 2004

(54) Intelligent mechatronic control suspension system based on quantum soft computing

(76) Inventors: Sergei V. Ulyanov, Cream (IT); Sergei A. Panfilov, Crema (IT); Viktor S. Ulyanov, Crema (IT); Takahide Hagiwara, Iwata (JP); Kazuki Takahashi, Crema (IT); Ludmila Litvintseva, Crema (IT)

Correspondence Address: KNOBBE MARTENS OLSON & BEAR LLP, 2040 MAIN STREET, FOURTEENTH FLOOR, IRVINE, CA, 92614, US

(21) Appl. No.: 10/210,865

(22) Filed: Jul. 31, 2002

(51) Int. Cl. G06F 7/00

(52) U.S. Cl. 707/3

(57) ABSTRACT

A control system for optimizing a shock absorber having a non-linear kinetic characteristic is described. The control system uses a fitness (performance) function that is based on the physical laws of minimum entropy and biologically inspired constraints relating to mechanical constraints and/or rider comfort, driveability, etc. In one embodiment, a genetic analyzer is used in an off-line mode to develop a teaching signal. The teaching signal can be approximated online by a fuzzy controller that operates using knowledge from a knowledge base. A learning system is used to create the knowledge base for use by the online fuzzy controller. In one embodiment, the learning system uses a quantum search algorithm to search a number of solution spaces to obtain information for the knowledge base. The online fuzzy controller is used to program a linear controller.

### BACKGROUND

1. Field of the Invention

The disclosed invention is relates generally to control systems, and more particularly to electronically controlled suspension systems.

2. Description of the Related Art

Feedback control systems are widely used to maintain the output of a dynamic system at a desired value in spite of external disturbances that would displace it from the desired value. For example, a household space-heating furnace, controlled by a thermostat, is an example of a feedback control system. The thermostat continuously measures the air temperature inside the house, and when the temperature falls below a desired minimum temperature the thermostat turns the furnace on. When the interior temperature reaches the desired minimum temperature, the thermostat turns the furnace off. The thermostat-furnace system maintains the household temperature at a substantially constant value in spite of external disturbances such as a drop in the outside temperature. Similar types of feedback controls are used in many applications.

A central component in a feedback control system is a controlled object, a machine, or a process that can be defined as a “plant”, having an output variable or performance characteristic to be controlled. In the above example, the “plant” is the house, the output variable is the interior air temperature in the house and the disturbance is the flow of heat (dispersion) through the walls of the house. The plant is controlled by a control system. In the above example, the control system is the thermostat in combination with the furnace. The thermostat-furnace system uses simple on-off feedback control system to maintain the temperature of the house. In many control environments, such as motor shaft position or motor speed control systems, simple on-off feedback control is insufficient. More advanced control systems rely on combinations of proportional feedback control, integral feedback control, and derivative feedback control. A feedback control based on a sum of proportional feedback, plus integral feedback, plus derivative feedback, is often referred as PID control.

A PID control system is a linear control system that is based on a dynamic model of the plant. In classical control systems, a linear dynamic model is obtained in the form of dynamic equations, usually ordinary differential equations. The plant is assumed to be relatively linear, time invariant, and stable. However, many real-world plants are time-varying, non-linear, and unstable. For example, the dynamic model may contain parameters (e.g., masses, inductance, aerodynamics coefficients, etc.), which are either only approximately known or depend on a changing environment. If the parameter variation is small and the dynamic model is stable, then the PID controller may be satisfactory. However, if the parameter variation is large or if the dynamic model is unstable, then it is common to add adaptive or intelligent (AI) control functions to the PID control system.

AI control systems use an optimizer, typically a non-linear optimizer, to program the operation of the PID controller and thereby improve the overall operation of the control system.

Classical advanced control theory is based on the assumption that near of equilibrium points all controlled “plants” can be approximated as linear systems. Unfortunately, this assumption is rarely true in the real world. Most plants are highly nonlinear, and often do not have simple control algorithms. In order to meet these needs for a nonlinear control, systems have been developed that use soft computing concepts such as genetic algorithms, fuzzy neural networks, fuzzy controllers and the like. By these techniques, the control system evolves (changes) over time to adapt itself to changes that may occur in the controlled “plant” and/or in the operating environment.

When a genetic analyzer is used to develop a teaching signal for a fuzzy neural network, the teaching signal typically contains unnecessary stochastic noise, making it difficult to later develop an approximation to the teaching signal. Further, a teaching signal developed for one operational condition (e.g. one type of road) may produce poor control quality when used in a different environment (e.g., on a different type of road).

### SUMMARY

The present invention solves these and other problems by providing a quantum algorithm approach for global optimization of a knowledge base (KB) and a robust fuzzy control algorithm design for intelligent mechatronic control suspension system based on quantum soft computing. In one embodiment, a quantum genetic search algorithm is used to develop a universal teaching signal that provided good control qualities over different types of roads. In one embodiment, a genetic analyzer produces a training signal (solutions) for each type of road, and a quantum search algorithm searches the training signals for information needed to construct the universal training signal. In one embodiment, an intelligent suspension control system, with quantum-logic feedback for the simulation of robust look-up tables is provided. The principle of minimal entropy production rate is used to guarantee conditions for robustness of fuzzy control. Gate design for dynamic simulation of genetic and quantum algorithms is provided. Dynamic analysis and information analysis of the quantum gates leads to “good” solutions with the desired accuracy and reliability.

In one embodiment, the control system uses a fitness (performance) function that is based on the physical laws of minimum entropy and biologically inspired constraints relating to rider comfort, driveability, etc. In one embodiment, a genetic analyzer is used in an off-line mode to develop a teaching signal for one or more roads having different statistical characteristics. Each teaching signal is optimized by the genetic algorithm for a particular type of road. A quantum algorithm is used to develop a single universal teaching signal from the teaching signals produced by the genetic algorithm. An information filter is used to filter the teaching signal to produce a compressed teaching signal. The compressed teaching signal can be approximated online by a fuzzy controller that operates using knowledge from a knowledge base. The control system can be used to control complex plants described by nonlinear, unstable, dissipative models. The control system is configured to use smart simulation techniques for controlling the shock absorber (plant).

In one embodiment, the control system comprises a learning system, such as a neural network that is trained by a genetic analyzer. The genetic analyzer uses a fitness function that maximizes sensor information while minimizing entropy production based on biologically-inspired constraints.

In one embodiment, a suspension control system uses a difference between the time differential (derivative) of entropy from the learning control unit (that is, the entropy production rate of the control signal) and the time differential of the entropy inside the controlled process (or a model of the controlled process, that is, the entropy production rate of the controlled process) as a measure of control performance. In one embodiment, the entropy calculation is based on a thermodynamic model of an equation of motion for a controlled process plant that is treated as an open dynamic system.

The control system is trained by a genetic analyzer that generates a teaching signal for each solution space. The optimized control system provides an optimum control signal based on data obtained from one or more sensors. For example, in a suspension system, a plurality of angle and position sensors can be used. In an off-line learning mode (e.g., in the laboratory, factory, service center, etc.), fuzzy rules are evolved using a kinetic model (or simulation) of the vehicle and its suspension system. Data from the kinetic model is provided to an entropy calculator that calculates input and output entropy production of the model. The input and output entropy productions are provided to a fitness function calculator that calculates a fitness function as a difference in entropy production rates for the genetic analyzer constrained by one or more constraints obtained from rider preferences. The genetic analyzer uses the fitness function to develop set training signals for the off-line control system, each training signal corresponding to an operational environment. A quantum search algorithm is used to reduce the complexity of the teaching signal data across several solution spaces by developing a universal teaching signal. Control parameters (in the form of a knowledge base) from the off-line control system are then provided to an online control system in the vehicle that, using information from the knowledge base, develops a control strategy.

In one embodiment, the invention includes a method for controlling a nonlinear object (a plant) by obtaining an entropy production difference between a time differentiation (dSᵤ/dt) of the entropy of the plant and a time differentiation (dS_{c}/dt) of the entropy provided to the plant from a controller. A genetic algorithm that uses the entropy production difference as a fitness (performance) function evolves a control rule in an off-line controller. The nonlinear stability characteristics of the plant are evaluated using a Lyapunov function. The genetic analyzer minimizes entropy and maximizes sensor information content. Filtered control rules from the off-line controller are provided to an online controller to control suspension system. In one embodiment, the online controller controls the damping factor of one or more shock absorbers (dampers) in the vehicle suspension system.

In one embodiment, the control method also includes evolving a control rule relative to a variable of the controller by means of a genetic algorithm. The genetic algorithm uses a fitness function based on a difference between a time differentiation of the entropy of the plant (dSᵤ/dt) and a time differentiation (dS_{c}/dt) of the entropy provided to the plant. The variable can be corrected by using the evolved control rule.

In one embodiment, the invention comprises a self-organizing control system adapted to control a nonlinear plant. The AI control system includes a simulator configured to use a thermodynamic model of a nonlinear equation of motion for the plant. The thermodynamic model is based on an interaction with a Lyapunov function (V), and the simulator uses the function V to analyze control for a state stability of the plant. The control system calculates an entropy production difference between a time differentiation of the entropy of said plant (dSᵤ/dt) and a time differentiation (dS_{c}/dt) of the entropy provided to the plant by a low-level controller that controls the plant. The entropy production difference is used by a genetic algorithm to obtain an adaptation function wherein the entropy production difference is minimized in a constrained fashion. The genetic algorithm provides a plurality of teaching signals, corresponding to a plurality of solution spaces. The plurality of teaching signals are processed by a quantum search algorithm to find a global teaching signal. In one embodiment, the global teaching signal is filtered to remove stochastic noise. The global teaching signal is provided to a fuzzy logic classifier that determines one or more fuzzy rules by using a learning process. The fuzzy logic controller is also configured to form one or more control rules that set a control variable of the controller in the vehicle.

In yet another embodiment, the invention comprises a new physical measure of control quality based on minimum production entropy and using this measure for a fitness function of genetic algorithm in optimal control system design. This method provides a local entropy feedback loop in the control system. The entropy feedback loop provides for optimal control structure design by relating stability of the plant (using a Lyapunov function) and controllability of the plant (based on production entropy of the control system). The control system is applicable to a wide variety of control systems, including, for example, control systems for mechanical systems, bio-mechanical systems, robotics, electromechanical systems, etc.

In one embodiment, a Quantum Associative Memory (QuAM) with exponential storage capacity is provided. It employs simple spin-1/2 (two-state) quantum systems and represents patterns as quantum operators. In one embodiment, the QuAM is used in a quantum neural network. In one embodiment, a quantum computational learning algorithm that takes advantages of the unique capabilities of quantum computation to produce a neural networks.

### BRIEF DESCRIPTION OF THE FIGURES

The above and other aspects, features, and advantages of the present invention will be more apparent from the following description thereof presented in connection with the following drawings.

FIG. 1 illustrates a general structure of a self-organizing intelligent control system based on soft computing.

FIG. 2 illustrates the structure of a self-organizing intelligent suspension control system with physical and biological measures of control quality based on soft computing

FIG. 3 illustrates the process of constructing the Knowledge Base (KB) for the Fuzzy Controller (FC).

FIG. 4 shows twelve typical road profiles.

FIG. 5 shows a normalized auto-correlation function for different velocities of motion along the road number 9 from FIG. 4.

FIG. 6A is a plot showing results of stochastic simulations based on a one-dimensional Gaussian probability density function.

FIG. 6B is a plot showing results of stochastic simulations based on a one-dimensional uniform probability density function.

FIG. 6C is a plot showing results of stochastic simulations based on a one-dimensional Reileigh probability density function.

FIG. 6D is a plot showing results of stochastic simulations based on a two-dimensional Gaussian probability density function.

FIG. 6E is a plot showing results of stochastic simulations based on a two-dimensional uniform probability density function.

FIG. 6F is a plot showing results of stochastic simulations based on a two-dimensional hyperbolic probability density function.

FIG. 7 illustrates a full car model.

FIG. 8 shows a control damper layout for a suspension-controlled vehicle having adjustable dampers.

FIG. 9 shows damper force characteristics for the adjustable dampers illustrated in FIG. 8.

FIG. 10 shows the structure of an SSCQ from FIG. 2 for use in connection with a simulation model of the full car and suspension system.

FIG. 11 is a flowchart showing operation of the SSCQ.

FIG. 12 shows time intervals associated with the operating mode of the SSCQ.

FIG. 13 is a flowchart showing operation of the SSCQ in connection with the GA.

FIG. 14 shows the genetic analyzer process and the operations of reproduction, crossover, and mutation.

FIG. 15 shows results of variables for the fuzzy neural network.

FIG. 16A shows control of a four-wheeled vehicle using two controllers.

FIG. 16B shows control of a four-wheeled vehicle using a single controller to control all four wheels.

FIG. 17 shows phase plots of β versus dβ/dt for the dynamic and thermodynamic response of the suspension system to three different roads.

FIG. 18 shows phase plots of S versus dS/dt corresponding to the plots in FIG. 17.

FIG. 19 shows three typical road signals, one signal corresponding to a road generated from stochastic simulations and two signals corresponding to roads in Japan.

FIG. 20 shows the general structure of the intelligent control system based on quantum soft computing.

FIG. 21 shows the structure of a self-organizing intelligent control system with physical and biological measures of control quality based on quantum soft computing

FIG. 22 shows inversion about an average.

FIG. 23 shows inversion about average operation as applied to a superposition where all but one of the components are initially identical and of magnitude O(1/\sqrt{N}) and where one component is initially negative

FIG. 24 shows amplitude distributions resulting from the various quantum gates involved in Grover's quantum search algorithm for the case of three qubits, where the quantum states which are prepared by these gates are (a) |s [symbol] =|000 [symbol] , (b) H^{(2m)}|s [symbol] , (c) Iₓ_{₀}H^{(2m)}|s [symbol] , (d)H ^{2m)}Iₓ_{₀}H^{(2m)}|s [symbol] , (e) —I, H^{(2m)}Iₓ_{₀}H^{(2m)}|s [symbol] ), (f) —H^{(2m)}IₛH^{(2m)}Iₓ_{₀}H^{(2m)}|s [symbol] FIG. 25 shows a comparison of GA and QSA structures.

FIG. 26 shows the structure of the Quantum Genetic Search Algorithm.

FIG. 27 shows the generalized QGSA with counting of good solutions in look-up tables of fuzzy controllers.

FIG. 28 shows how a quantum mechanical circuit inverts the amplitudes of those states for which the function j(x) is 1.

FIG. 29 shows how the operator Q=-I, U⁻¹I, U preserves a 2-dimensional vector space spanned by vₛ and U⁻¹vₜ, and how it rotates each vector in the space by approximately 2|Uₜₛ| radians.

FIG. 30 is a schematic representation of the quantum oracle U_{f,}

FIG. 31 shows a quantum mechanical version of the classical-XOR gate as an example for a quantum gate (CNOT gate), where the input state |x, y [symbol] is mapped into the output state |x, x⊕y [symbol] .

FIG. 32 shows a variation of coefficients under the (R₉₀D) transformation.

FIG. 33 shows fragments of lookup tables generated from different road results.

FIG. 34 shows a general iteration algorithm for information analysis of Grover's algorithm.

FIG. 35 shows a first iteration of the algorithm shown in FIG. 34.

FIG. 36 shows a second iteration of the algorithm shown in FIG. 34.

FIG. 37 shows a scheme Diagram of the QA.

FIG. 38 shows the structure of a Quantum Gate.

FIG. 39 shows methods in Quantum Algorithm Gate Design.

FIG. 40 shows the gate approach for simulation of quantum algorithms using classical computers.

FIG. 41A shows a vector superposition used in a first step of Grover's algorithm.

FIG. 41B shows the superposition from FIG. 41A after applying the operator ⁴H.

FIG. 41C shows the superposition from FIG. 41B after applying the entanglement operator U_{F} with x=001.

FIG. 41D shows the superposition from FIG. 41C after the application of Dₙ [symbol] I.

FIG. 41E shows the superposition from FIG. 41D after further application of the U_{F} operator.

FIG. 41F shows the superposition from FIG. 41E after applying Dₙ [symbol] I.

FIG. 42 shows Grover's quantum algorithm simulation (Circuit representation and corresponding gate design).

FIG. 43 shows preparation of entanglement operators: a) and b) single solution search; c) for two solutions search; d) for three solutions search.

FIG. 44 shows a quantum gate assembly.

FIG. 45 shows the first iteration of Grover's algorithm execution.

FIG. 46 shows results of the Grover's algorithm execution.

FIG. 47 shows interpretation of Grover' quantum algorithm.

FIG. 48 shows examples of result interpretation of Grover's quantum algorithm.

FIG. 49 shows the circuit for Grover's algorithm where: C is the computational register and M is the memory register; U_{B} is the black box query transformation, H is a Hadamard transformation on every qubit of the C register, and f₀ is a phase flip in front of the |00 . . . 0 [symbol] _{C}. FIG. 50 shows the dependence of the mutual information between the M and the C registers as a function of the number of times.

FIG. 51a shows information analysis of execution dynamics of Grover's QSA.

FIG. 51b shows entanglement in Grover's quantum algorithm for 10 qubits as a function of number of iterations.

FIG. 52 shows dependence of the required memory for number of qubit.

FIG. 53 shows the time required for a fixed number of iterations for a number of qubit for various Intel Pentium III processors.

FIG. 54 shows the time required for 100 iterations with different internal frequency using an Intel Pentium III CPU.

FIG. 55 shows the time required for fixed number of iterations regarding to number of qubit for Intel Pentium III processors of different internal frequency.

FIG. 56 shows the time required for 10 iterations with different internal frequency of Intel Pentium III processor.

FIG. 57 shows the time required for making one iteration with 11 qubit on PC with 512 MB physical memory.

FIG. 58 shows CPU time required for making one iteration versus the number of qubits.

FIG. 59 shows a dynamic iteration process of a fast quantum search algorithm.

FIG. 60a) shows the steps of the quantum database search algorithm for the simplest case of 4 items, when the first item is desired by the oracle.

FIG. 60b) shows the effect of the Grover algorithm when N=4 and the solution is j=I.

FIG. 61 shows the structure of a new quantum oracle algorithm in four-dimensional Hilbert space.

FIGS. 62a an 62b show binary search trees for an unsorted database search using truly mixed spin states in spin Liouville space, where the nodes indicate the input states for the binary database search oracle function f.

FIG. 63 shows general representation of a particular database function f operating on spins I₁, I₂, I₃ as a permutation using ancilla bit I₀ with the output stored on I₀.

FIG. 64 shows quantum search algorithm in spin Liouville space.

FIG. 65 shows general representation of a particular database function f operating on spins I₁, I₂, I₃ as a permutation using ancilla bit I₀ with the output stored on I₀. FIG. 66 shows experimental results of NMR based quantum search.

FIG. 67 shows effects of D operation: (a) States before operation; (b) States after operation.

FIG. 68 shows finding 1 out of N items. (a) Uniform superposition is prepared initially. Every item has equal amplitude (1/\sqrt{N}); (b) Oracle U_{f} recognizes and marks the solution item k; (c) Operator D amplifies the amplitude of the marked item and suppresses amplitudes of other items.

FIG. 69 shows geometric interpretation of the iterative procedure.

FIG. 70 shows the design process of KB for fuzzy P-controller with QGSA.

FIG. 71 shows a quantum genetic search algorithm structure.

FIG. 72 shows a geometrical interpretation of a new quantum oracle.

FIG. 73 shows a gate structure of a new quantum oracle.

FIG. 74 shows a gate structure of quantum genetic search algorithm.

In the drawings, the first digit of any three-digit element reference number generally indicates the number of the figure in which the referenced element first appears. The first two digits of any four-digit element reference number generally indicate the figure in which the referenced element first appears.

### DESCRIPTION

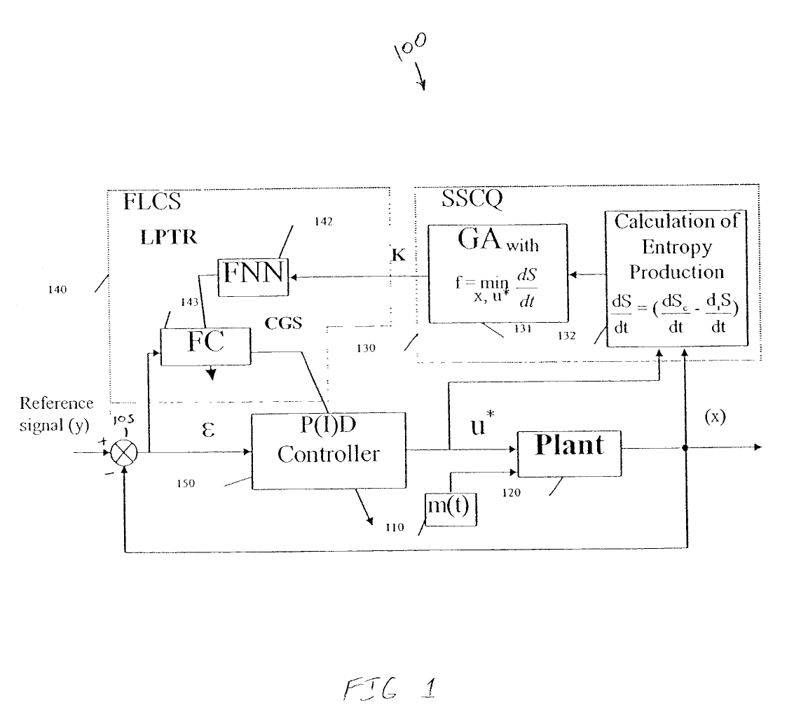

FIG. 1 is a block diagram of a control system 100 for controlling a plant based on soft computing. In the controller 100, a reference signal y is provided to a first input of an adder 105. An output of the adder 105 is an error signal E, which is provided to an input of a Fuzzy Controller (FC) 143 and to (an input of a Proportional-Integral-Differential (PID) controller 150. An output of the PID controller 150 is a control signal u*, which is provided to a control input of a plant 120 and to a first input of an entropy-calculation module 132. A disturbance m(t) 110 is also provided to an input of the plant 120. An output of the plant 120 is a response x, which is provided to a second input the entropy-calculation module 132 and to a second input of the adder 105. The second input of the adder 105 is negated such that the output of the adder 105 (the error signal 6) is the value of the first input minus the value of the second input.

An output of the entropy-calculation module 132 is provided as a fitness function to a Genetic Analyzer (GA) 131. An output solution from the GA 131 is provided to an input of a FNN 142. An output of the FNN 142 is provided as a knowledge base to the FC 143. An output of the FC 143 is provided as a gain schedule to the PID controller 150.

The GA 131 and the entropy calculation module 132 are part of a Simulation System of Control Quality (SSCQ) 130. The FNN 142 and the FC 143 are part of a Fuzzy Logic Classifier System (FLCS) 140.

Using a set of inputs, and the fitness function 132, the genetic algorithm 131 works in a manner similar to a biological evolutionary process to arrive at a solution which is, hopefully, optimal. The genetic algorithm 131 generates sets of “chromosomes” (that is, possible solutions) and then sorts the chromosomes by evaluating each solution using the fitness function 132. The fitness function 132 determines where each solution ranks on a fitness scale. Chromosomes (solutions) which are more fit are those chromosomes which correspond to solutions that rate high on the fitness scale. Chromosomes which are less fit are those chromosomes which correspond to solutions that rate low on the fitness scale.

Chromosomes that are more fit are kept (survive) and chromosomes that are less fit are discarded (die). New chromosomes are created to replace the discarded chromosomes. The new chromosomes are created by crossing pieces of existing chromosomes and by introducing mutations.

The PID controller 150 has a linear transfer function and thus is based upon a linearized equation of motion for the controlled “plant” 120. Prior art genetic algorithms used to program PID controllers typically use simple fitness and thus do not solve the problem of poor controllability typically seen in linearization models. As is the case with most optimizers, the success or failure of the optimization often ultimately depends on the selection of the performance (fitness) function.

Evaluating the motion characteristics of a nonlinear plant is often difficult, in part due to the lack of a general analysis method. Conventionally, when controlling a plant with nonlinear motion characteristics, it is common to find certain equilibrium points of the plant and the motion characteristics of the plant are linearized in a vicinity near an equilibrium point. Control is then based on evaluating the pseudo (linearized) motion characteristics near the equilibrium point. This technique is scarcely, if at all, effective for plants described by models that are unstable or dissipative.

Computation of optimal control based on soft computing includes the GA 131 as the first step of global search for an optimal solution on a fixed space of positive solutions. The GA searches for a set of control weights for the plant. Firstly the weight vector K={k₁, . . . kₙ} is used by a conventional proportional-integral-differential (PID) controller 150 in the generation of a signal u*=δ(K) which is applied to the plant. The entropy S(δ(K)) associated to the behavior of the plant 120 on this signal is used as a fitness function by the GA 131 to produce a solution that gives minimum entropy production. The GA 131 is repeated several times at regular time intervals in order to produce a set-of weight vectors K. The vectors K generated by the GA 131 are then provided to the FNN 142 and the output of the FNN 142 to the fuzzy controller 143. The output of the fuzzy controller 143 is a collection of gain schedules for the PID controller 150 that controls the plant. For the soft computing system 100 based on a genetic analyzer, there is very often no real control law in the classical control sense, but rather, control is based on a physical control law such as minimum entropy production.

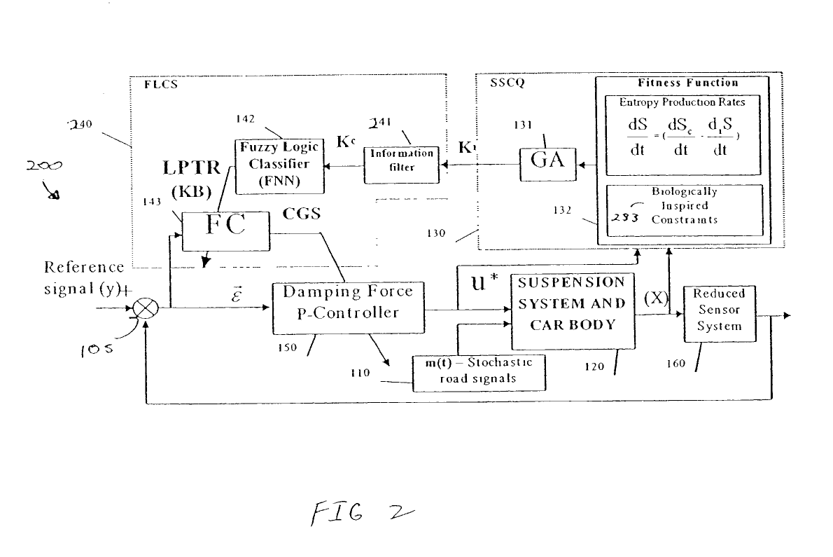

In order to realize an intelligent mechatronic suspension control system, the structure depicted on FIG. 1 is modified, as shown on FIG. 2 to produce a system 200 for controlling a plant, such as suspension system. The system 200 is similar to the system 100 with the addition of an information filter 241 and biologically-inspired constraints 233 in the fitness function 132. The information filter 241 is placed between the GA 131 and the FNN 142 such that a solution vector output Kᵢ from the GA 131 is provided to an input of the information filter 241. An output of the information filter 241 is a filtered solution vector Kc that is provided to the input of the FNN 142. In FIG. 2, the disturbance 110 is a road signal m(t). (e.g., measured data or data generated via stochastic simulation). In FIG. 2, the plant 120 is a suspension system and car body. The fitness function 132, in addition to entropy production rate, includes biologically-inspired constraints based on mechanical and/or human factors. In one embodiment, the filter 241 includes an information compressor that reduces unnecessary noise in the input signal of the FNN 142. In FIG. 2, the PID controller 150 is shown as a proportional damping force controller.

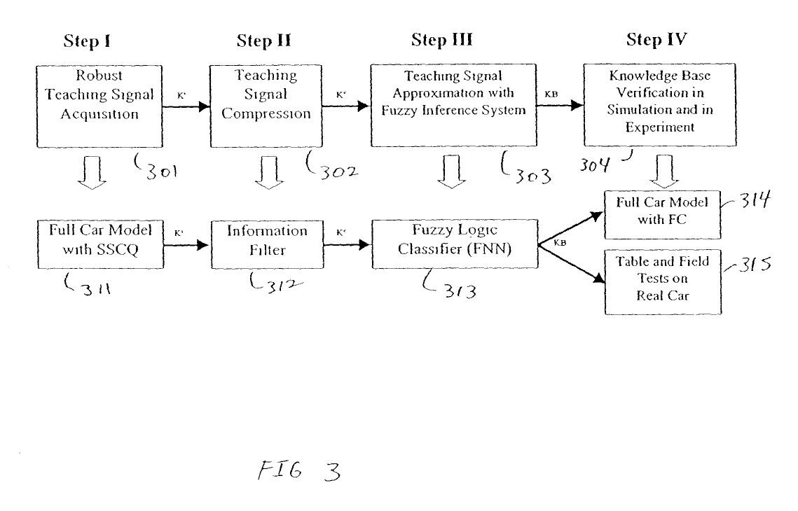

As shown in FIG. 3, realization of the structure depicted in FIG. 2 is divided into four development stages. The development stages include a teaching signal acquisition stage 301, a teaching signal compression stage 302, a teaching signal approximation stage 303, and a knowledge base verification stage 304.

The teaching signal acquisition stage 301 includes the acquisition of a robust teaching signal without the loss of information. In one embodiment, the stage 301 is realized using stochastic simulation of a full car with a Simulation System of Control Quality (SSCQ) under stochastic excitation of a road signal. The stage 301 is based on models of the road, of the car body, and of models of the suspension system. Since the desired suspension system control typically aims for the comfort of a human, it is also useful to develop a representation of human needs, and transfer these representations into the fitness function 132 as constraints 233.

The output of the stage 301 is a robust teaching signal K₁, which contains information regarding the car behavior and corresponding behavior of the control system.

Behavior of the control system is obtained from the output of the GA 131, and behavior of the car is a response of the model for this control signal. Since the teaching signal Kᵢ is generated by a genetic algorithm, the teaching signal Kᵢ typically has some unnecessary stochastic noise in it. The stochastic noise can make it difficult to realize (or develop a good approximation for) the teaching signal K₁. Accordingly, in a second stage 302, the information filter 241 is applied to the teaching signal K₁ to generate a compressed teaching signal K_{c}. The information filter 241 is based on a theorem of Shannon's information theory (the theorem of data compression). The information filter 241 reduces the content of the teaching signal by removing that portion of the teaching signal Kᵢ that corresponds to unnecessary information. The output of the second stage 302 is a compressed teaching signal K_{c}.

The third stage 303 includes approximation of the compressed teaching signal K_{c} by building a fuzzy inference system using a fuzzy logic classifier (FLC) based on a Fuzzy Neural Network (FNN). Information of car behavior can be used for training an input part of the FNN, and corresponding information of controller behavior can be used for output-part training of the FNN.

The output of the third stage 303 is a knowledge base (KB) for the FC 143 obtained in such a way that it has the knowledge of car behavior and knowledge of the corresponding controller behavior with the control quality introduced as a fitness function in the first stage 301 of development. The KB is a data file containing control laws of the parameters of the fuzzy controller, such as type of membership functions, number of inputs, outputs, rule base, etc.

In the fourth stage 304, the KB can be verified in simulations and in experiments with a real car, and it is possible to check its performance by measuring parameters that have been optimized.

To summarize, the development of the KB for an intelligent control suspension system includes:

I. Obtaining a stochastic model of the road or roads.

II. Obtaining a realistic model of a car and its suspension system.

III. Development of a Simulation System of Control Quality with the car model for genetic algorithm fitness function calculation, and introduction of human needs in the fitness function.

IV. Development of the information compressor (information filter).

V. Approximation of the teaching signal with a fuzzy logic classifier system (FLCS) and obtaining the KB for the FC

VI. Verification of the KB in experiment and/or in simulations of the full car model with fuzzy control

I. Obtaining Stochastic Models of the Roads

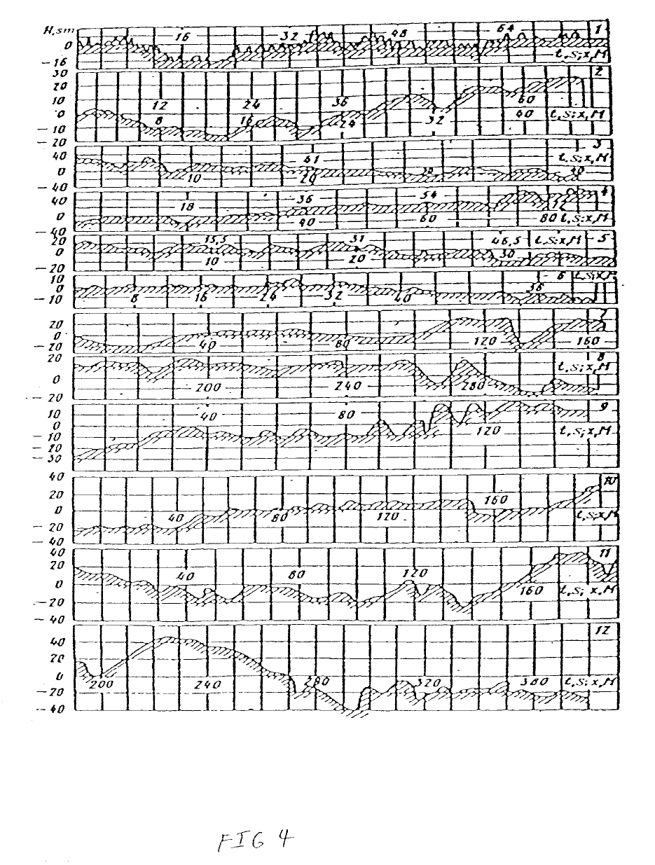

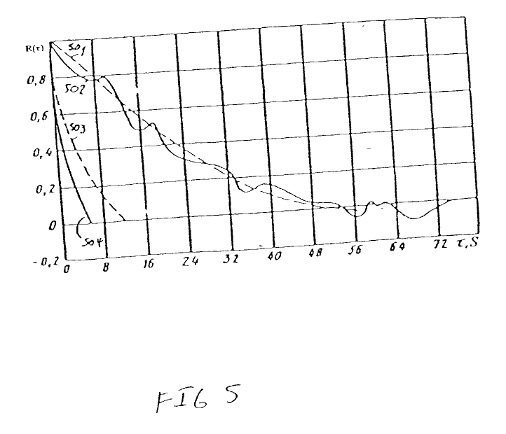

It is convenient to consider different types of roads as stochastic processes with different auto-correlation functions and probability density functions. FIG. 4 shows twelve typical road profiles. Each profile shows distance along the road (on the x-axis), and altitude of the road (on the y-axis) with respect to a reference altitude. FIG. 5 shows a normalized auto-correlation function for different velocities of motion along the road number 9 (from FIG. 4). In FIG. 5, a curve 501 and a curve 502 show the normalized auto-correlation function for a velocity [symbol] =1 meter/sec, a curve 503 shows the normalized auto-correlation function for [symbol] =5 meter/sec, and a curve 504 shows the normalized auto-correlation function for [symbol] =10 meter/sec.

The results of statistical analysis of actual roads, as shown in FIG. 4, show that it is useful to consider the road signals as stochastic processes using the following three typical auto-correlation functions.

R(τ)=B(0)exp{−a₁ [symbol] |τ|}; (1.1)

R(τ)=B(0)exp{−α, [symbol] |τ|}cos β₁ [symbol] τ; (1.2)

$$R ( τ ) = B ( 0 ) exp \{ - {α}_{1} ϑ \vert τ \vert \} [ cos {β}_{1} ϑτ + \frac{{α}_{1}}{{β}_{1}} sin ( {β}_{1} ϑ \vert τ \vert ) ] , \qquad ( 1.3 )$$

where α₁ and β₁ are the values of coefficients for single velocity of motion. The ranges of values of these coefficients are obtained from experimental data as:

α₁=0.014 to 0.111; β₁=0.025 to 0.140.

For convenience, the roads are divided into three classes:

| | |
|---|---|
| A. | \sqrt{B(0)} ≦ 10 sm—small obstacles; |
| B. | \sqrt{B(0)} = 10 sm to 20 sm—medium obstacles; |
| C. | \sqrt{B(0)} > 20 sm—large obstacles. |

The presented auto-correlation functions and its parameters are used for stochastic simulations of different types of roads using forming filters. The methodology of forming filter structure can be described according to the first type of auto-correlation functions (1.1) with different probability density functions.

Consider a stationary stochastic process X(t) defined on the interval [xₗ, xᵣ], which can be either bounded or unbounded. Without loss of generality, assume that X(t) has a zero mean. Then xₗ<0 and xᵣ>0. With the knowledge of the probability density p(x) and the spectral density Φₓₓ(ω) of X(t), one can establish a procedure to model the process X(t).

Let the spectral density be of the following low-pass type:

$${Φ}_{XX} ( ω ) = \frac{α {σ}^{2}}{π ( {ω}^{2} + {α}^{2} )} , α > 0 , \qquad ( 2.1 )$$

where σ² is the mean-square value of X(t). If X(t) is also a diffusive Markov process, then it is governed by the following stochastic differential equation in the Ito sense:

dX=−αXdt+D(X)dB(t), (2.2)

where α is the same parameter in (2.1), B(t) is a unit Wiener process, and the coefficients −αX and D(X) are known as drift and the diffusion coefficients, respectively. To demonstrate that this is the case, multiply (2.2) by X(t−τ) and take the ensemble average to yield

$$\frac{ⅆ R ( τ )}{ⅆ τ} = - α R ( τ ) , \qquad ( 2.3 )$$

where R(τ) is the correlation function of X(t), namely, R(τ)=E [X(t−τ)X(t)]. Equation (2.3) has a solution

R(τ)=Aexp(−α|τ|) (2.4)

in which A is arbitrary. By choosing A=σ², equations (2.1) and (2.4) become a Fourier transform pair. Thus equation (2.2) generates a process X(t) with a spectral density (2.1). Note that the diffusion coefficient D(X) has no influence on the spectral density.

Now it is useful to determine D(X) so that X(t) possesses a given stationary probability density p(x). The Fokker-Planck equation, governing the probability density p(x) of X(t) in the stationary state, is obtained from equation (2.2) as follows:

$$\frac{ⅆ}{ⅆ x} G = \frac{ⅆ}{ⅆ x} \{ α xp ( x ) + \frac{1}{2} \frac{ⅆ}{ⅆ x} [ {D}^{2} ( x ) p ( x ) ] \} = 0 , \qquad ( 2.5 )$$

where G is known as the probability flow. Since X(t) is defined on [x₁, xᵣ], G must vanish at the two boundaries x=xₗ and x=xᵣ. In the present one-dimensional case, G must vanish everywhere; consequently, equation (2.5) reduces to

$$α xp ( x ) + \frac{1}{2} \frac{ⅆ}{ⅆ x} [ {D}^{2} ( x ) p ( x ) ] = 0. \qquad ( 2.6 )$$

Integration of equation (2.6) results in

$${D}^{2} ( x ) p ( x ) = - 2 α {\int }_{{x}_{l}}^{{x}_{r}} up ( u ) ⅆ u + C , \qquad ( 2.7 )$$

where C is an integration constant. To determine the integration constant C, two cases are considered. For the first case, if xₗ=−∞, or xᵣ=∞, or both, then p(x) must vanish at the infinite boundary; thus C=0 from equation (2.7). For the second case, if both xₗ and xᵣ are finite, then the drift coefficient −αxₗ at the left boundary is positive, and the drift coefficient −αxᵣ at the right boundary is negative, indicating that the average probability flows at the two boundaries are directed inward. However, the existence of a stationary probability density implies that all sample functions must remain within [xₗ, xᵣ], which requires additionally that the drift coefficient vanish at the two boundaries, namely, D² (xₗ)=D² (xᵣ)=0. This is satisfied only if C=0. In either case,

$${D}^{2} ( x ) = - \frac{2 α}{p ( x )} {\int }_{{x}_{l}}^{{x}_{r}} up ( u ) ⅆ u . \qquad ( 2.8 )$$

Function D² (x), computed from equation (2.8), is non-negative, as it should be, since p(x)≧0 and the mean value of X(t) is zero. Thus the stochastic process X(t) generated from (2.2) with D(x) given by (2.8) possesses a given stationary probability density p(x) and the spectral density (2.1).

The Ito type stochastic differential equation (2.2) may be converted to that of the Stratonovich type as follows:

$$\dot{X} = - α X - \frac{1}{4} \frac{ⅆ {D}^{2} ( X )}{ⅆ X} + \frac{D ( X )}{\sqrt{2 π}} ξ ( t ) , \qquad ( 2.9 )$$

where ξ(t) is a Gaussian white noise with a unit spectral density. Equation (2.9) is better suited for simulating sample functions. Some illustrative examples are given below.

### EXAMPLE 1

Assume that X(t) is uniformly distributed, namely

$$p ( x ) = \frac{1}{2 Δ} , - Δ \leq x \leq Δ . \qquad ( 2.10 )$$

Substituting (2.10) into (2.8)

D² (x)=α(Δ²−x²). (2.11)

In this case, the desired Ito equation is given by

dX=−αXdt+\sqrt{α(Δ²−X²)}dB(t). (2.12)

It is of interest to note that a family of stochastic processes can be obtained from the following generalized version of (2.12):

dX=−αXdt+\sqrt{αβ(Δ²−X²)}dB(t). (2.13)

Their appearances are strikingly diverse, yet they share the same spectral density (2.1).

### EXAMPLE 2

Let X(t) be governed by a Rayleigh distribution

p(x)=γ²xexp(−γx),γ>0,0≦x<∞. (2.14)

Its centralized version Y(t)=X(t)−2/γ has a probability density

p(y)=γ(γy+2)exp(−γy+2),−2/γ≦y<∞. (2.15)

From equation (2.8),

$${D}^{2} ( y ) = \frac{2 α}{γ} ( y + \frac{2}{γ} ) . \qquad ( 2.16 )$$

The Ito equation for Y(t) is

$$dY = - α Ydt + {[ \frac{2 α}{γ} ( Y + \frac{2}{γ} ) ]}^{1 / 2} d B ( t ) \qquad ( 2.17 )$$

and the correspondence equation for X(t) in the Stratonovich form is

$$\dot{X} = - α X + \frac{3 α}{2 γ} + {( \frac{α}{π γ} X )}^{1 / 2} ξ ( t ) . \qquad ( 2.18 )$$

Note that the spectral density of X(t) contains a delta function (4/γ²)δ(ω) due to the nonzero mean 2/γ.

### EXAMPLE 3

Consider a family of probability densities, which obeys an equation of the form

$$\frac{ⅆ}{ⅆ x} p ( x ) = J ( x ) p ( x ) . \qquad ( 2.19 )$$

Equation (2.19) can be integrated to yield

p(x)=C₁exp(∫J(x)dx) (2.20)

where C₁ is a normalization constant. In this case

D²(x)=−2αexp[−J(x)]∫xexp[J(x)]dx. (2.21)

Several special cases may be noted. Let

J(x)=−x²−δx⁴,−∞<x<∞ (2.22)

where γ can be arbitrary if δ>0. Substitution of equation (2.22) into equation (2.8) leads to

$${D}^{2} ( x ) = \frac{α}{2} \sqrt{π / δ} exp [ {δ ( {x}^{2} + \frac{γ}{2 δ} )}^{2} ] erfc [ \sqrt{δ} ( {x}^{2} + \frac{γ}{2 δ} ) ] , \qquad ( 2.23 )$$

where erfc(y) is the complementary error function defined as

$$erfc ( y ) = \frac{2}{\sqrt{π}} {\int }_{y}^{∞} {ⅇ}^{- {t}^{2}} ⅆ t . \qquad ( 2.24 )$$

The case of γ<0 and δ>0 corresponds to a bimodal distribution, and the case of γ>0 and δ=0 corresponds to a Gaussian distribution.

The Pearson family of probability distributions corresponds to

$$J ( x ) = \frac{{a}_{1} x + {a}_{0}}{{b}_{2} {x}^{2} + {b}_{1} x + {b}_{0}} \qquad ( 2.25 )$$

In the special case of a₀+b₁=0,

$${D}^{2} ( x ) = - \frac{2 α}{{a}_{1} + {b}_{2}} ( {b}_{2} {x}^{2} + {b}_{1} x + {b}_{0} ) . \qquad ( 2.26 )$$

From the results of statistical analysis of forming filters with auto-correlation function (1.1) one can describe typical structure of forming filters as in Table 2.1:

TABLE 2.1
The Structures of Forming Filters for Typical Probability
Density Functions p(x)

| Auto-correlation | Probability density | |
|---|---|---|
| function | function | Forming filter structure |
| ${R}_{y} ( τ ) = {σ}^{2} {e}^{- ατ \vert}$ | Gaussian | $\dot{y} + αy = {σ}^{2} ξ ( t )$ |
| ${R}_{y} ( τ ) = {σ}^{2} {e}^{- ατ \vert}$ | Uniform | $\dot{y} + \frac{α}{2} y = \frac{{σ}^{2}}{\sqrt{2 π}} \sqrt{α ( {Δ}^{2} - {y}^{2} )} ξ ( t )$ |
| ${R}_{y} ( τ ) = {σ}^{2} {e}^{- ατ \vert}$ | Rayleigh | $\dot{y} + αy \pm \frac{2 α}{γ} = \frac{{σ}^{2}}{\sqrt{2 π}} \sqrt{\frac{2 α}{γ} ( y + \frac{2}{γ} )} ξ ( t )$ |
| ${R}_{y} ( τ ) = {σ}^{2} {e}^{- ατ \vert}$ | Pearson | $\dot{y} + αy + \frac{α}{{a}_{1} + 2 {b}_{2}} ( {b}_{2} x + {b}_{1} ) = \frac{{σ}^{2}}{\sqrt{2 π}} \sqrt{\frac{2 α}{{a}_{1} + 2 {b}_{2}} ( {b}_{2} {y}^{2} + {b}_{1} y + {b}_{0} )} ξ ( t )$ |

The structure of a forming filter with an auto-correlation function given by equations (1.2) and (1.3) is derived as follows. A two-dimensional (2D) system is used to generate a narrow-band stochastic process with the spectrum peak located at a nonzero frequency. The following pair of Ito equations describes a large class of 2D systems:

dx₁=(a₁₁x₁+a₁₂x₂)dt+D₁(x₁, x₂)dB₁(t), dx₂=(a₂₁x₁+a₂₂x₂)dt+D₂(x₁, x₂)dB₂(t), (3.1)

where Bᵢ, i=1, 2 are two independent unit Wiener processes.

For a system to be stable and to possess a stationary probability density, is required that a₁₁<0, a₂₂<0 and a₁₁a₂₂−a₁₂a₂₁>0. Multiplying (3.1) by x₁(t−τ) and taking the ensemble average, gives

$$\frac{ⅆ}{ⅆ τ} {R}_{11} ( τ ) = {a}_{11} {R}_{11} ( τ ) + {a}_{12} {R}_{12} ( τ ) \\ \frac{ⅆ}{ⅆ τ} {R}_{12} ( τ ) = {a}_{21} {R}_{11} ( τ ) + {a}_{22} {R}_{12} ( τ ) \qquad ( 3.2 )$$

where R₁₁(τ)=M [x₁(t−τ)x₁(t)], R,₁₂ (τ)=M[x₁(t−τ)x₂ (t)] with initial conditions R₁₁(0)=m₁₁=M[x₁²], R₁₂(0)=m₁₂=M[x₁x₂].

Differential equations (3.2) in the time domain can be transformed (using the Fourier transform) into algebraic equations in the frequency domain as follows

$$ⅈω {\overline{R}}_{11} - \frac{{m}_{11}}{π} = {a}_{11} {\overline{R}}_{11} + {a}_{12} {\overline{R}}_{12} \\ ⅈ ω {\overline{R}}_{12} - \frac{{m}_{12}}{π} = {a}_{21} {\overline{R}}_{11} + {a}_{22} {\overline{R}}_{12} , \qquad ( 3.3 )$$

where \overline{R}ᵢⱼ(ω)) define the following integral Fourier transformation:

$${\overline{R}}_{ij} ( ω ) = Θ [ {\overline{R}}_{ij} ( τ ) ] = \frac{1}{π} {\int }_{0}^{∞} {R}_{ij} ( τ ) {ⅇ}^{- ⅈωτ} ⅆ τ .$$

Then the spectral density S₁₁(ω) of x₁(t) can be obtained as

$${S}_{11} ( ω ) = \frac{1}{2 π} {\int }_{- ∞}^{∞} {R}_{11} ( τ ) {ⅇ}^{- ⅈ ω τ} ⅆ τ = Re [ {\overline{R}}_{11} ( ω ) ] , \qquad ( 3.4 )$$

where Re denotes the real part.

Since R_{y}(τ)→0 as τ→∞, it can be shown that

$$Θ ( \frac{ⅆ {R}_{i j} ( τ )}{ⅆ τ} ) = ⅈ ω {\overline{R}}_{i j} ( ω ) - \frac{1}{π} {R}_{i j} ( 0 )$$

and equation (3.3) is obtained using this relation.

Solving equation (3.3) for \overline{R}_{y}(ω) and taking its real part, gives

$${S}_{11} ( ω ) = \frac{- ( {a}_{11} {m}_{11} + {a}_{12} {m}_{12} ) {ω}^{2} + {A}_{2} ( {a}_{12} {m}_{12} - {a}_{22} {m}_{11} )}{π [ {ω}^{4} + ( {A}_{1}^{2} - 2 {A}_{2} ) {ω}^{2} + {A}_{2}^{2} ]} , \qquad ( 3.5 )$$

where A₁=a₁₁+a₂₂, and A₂=a₁₁a₂₂−a₁₂a₂₁.

Expression (3.5) is the general expression for a narrow-band spectral density. The constants aᵢⱼ, i, j=1, 2, can be adjusted to obtain a best fit for a target spectrum. The task is to determine non-negative functions D₁²(x₁, x₂) and D₂² (x₁, x₂) for a given p(x₁, x₂).

Forming filters for simulation of non-Gaussian stochastic processes can be derived as follows. The Fokker-Planck-Kolmogorov (FPK) equation for the joint density p(x₁, x₂)of x₁(t) and x₂(t) in the stationary state is given as

$$\frac{\partial }{{x}_{1}} ( ( {a}_{11} {x}_{1} + {a}_{12} {x}_{2} ) p - \frac{1}{2} \frac{\partial }{ {x}_{1}} [ {D}_{1}^{2} ( {x}_{1} , {x}_{2} ) p ] ) + \frac{\partial }{{x}_{2}} ( ( {a}_{21} {x}_{1} + {a}_{22} {x}_{2} ) p - \frac{1}{2} \frac{\partial }{ {x}_{2}} [ {D}_{2}^{2} ( {x}_{1} , {x}_{2} ) p ] ) = 0$$

If such D₁² (x₁, x₂) and D₂²(x₁, x₂) functions can be found, then the equations of forming filters for the simulation in the Stratonovich form are given by

$$\begin{matrix}{\dot{x}}_{1} = {a}_{11} {x}_{1} + {a}_{12} {x}_{2} - \frac{1}{4} \frac{\partial }{ {x}_{1}} {D}_{1}^{2} ( {x}_{1} , {x}_{2} ) + \frac{{D}_{1} ( {x}_{1} , {x}_{2} )}{\sqrt{2 π}} {ξ}_{1} ( t ) , \\ {\dot{x}}_{2} = {a}_{21} {x}_{1} + {a}_{22} {x}_{2} - \frac{1}{4} \frac{\partial }{ {x}_{2}} {D}_{2}^{2} ( {x}_{1} , {x}_{2} ) + \frac{{D}_{2} ( {x}_{1} , {x}_{2} )}{\sqrt{2 π}} {ξ}_{2} ( t ) ,\end{matrix} \qquad ( 3.6 )$$

where ξᵢ(t), i 1, 2, are two independent unit Gaussian white noises.

Filters (3.1) and (3.6) are non-linear filters for simulation of non-Gaussian random processes. Two typical examples are provided. CL EXAMPLE 1

Consider two independent uniformly distributed stochastic process x₁ and x₂, namely,

$$p ( {x}_{1} , {x}_{2} ) = \frac{1}{4 {Δ}_{1} {Δ}_{2}} ,$$

−Δ₁≦x₁≦Δ₁, −Δ₂≦x₂≦Δ₂.

In this case, from the FPK equation, one obtains

$${a}_{11} - \frac{1}{2} \frac{{\partial }^{2}}{{x}_{1}^{2} } {D}_{1}^{2} + {a}_{22} - \frac{1}{2} \frac{{\partial }^{2}}{{x}_{2}^{2} } {D}_{2}^{2} = 0 ,$$

which is satisfied if

D₁²=−a₁₁(Δ₁−x₁²), D₂²=−₂₂(Δ₂−x₂²)

The two non-linear equations in (3.6) are now

$$\begin{matrix}{\dot{x}}_{1} = \frac{1}{2} {a}_{11} {x}_{1} + {a}_{12} {x}_{2} + \sqrt{- \frac{{a}_{11}}{2 π} ( {Δ}_{1} - {x}_{1}^{2} )} {ξ}_{1} ( t ) \\ {\dot{x}}_{1} = \frac{1}{2} {a}_{21} {x}_{1} + {a}_{22} {x}_{2} + \sqrt{- \frac{{a}_{22}}{2 π} ( {Δ}_{2} - {x}_{2}^{2} )} {ξ}_{2} ( t ) ,\end{matrix} \qquad ( 3.7 )$$

which generate a uniformly distributed stochastic process x, (t) with a spectral density given by (3.5).

### Example 2

Consider a joint stationary probability density of x₁(t) and x₂(t) in the form

p(x₁, x₂)=ρ(λ)=C₁(λ+b)^{-δ}, b>0, δ>1, and

$$λ = \frac{1}{2} {x}_{1}^{2} - \frac{{a}_{12}}{2 {a}_{21}} {x}_{2}^{2} .$$

A large class of probability densities can be fitted in this form. In this case

$$\begin{matrix}{D}_{1} ( {x}_{1} , {x}_{2} ) = - \frac{2 {a}_{11}}{δ - 1} ( λ + b ) , {D}_{2} ( {x}_{1} , {x}_{2} ) = \frac{2 {a}_{11} {a}_{12}}{{a}_{21} ( δ - 1 )} ( λ + b ) \\ and \\ p ( {x}_{1} ) = {C}_{1} {\int }_{- ∞}^{∞} {( \frac{1}{2} {x}_{1}^{2} - \frac{{a}_{12}}{2 {a}_{21}} {u}^{2} + b )}^{δ} ⅆ u .\end{matrix}$$

The forming filter equations (3.6) for this case can be described as following

$${\dot{x}}_{1} = {a}_{11} {x}_{1} + {a}_{12} {x}_{2} - \frac{2 {a}_{11}^{2}}{{( δ - 1 )}^{2}} [ \frac{1}{2} {x}_{1}^{2} - \frac{{a}_{12}}{2 {a}_{21}} {x}_{2}^{2} + b ] {x}_{1} - \frac{2 {a}_{11}}{\sqrt{2 π} ( δ - 1 )} \cdot \cdot [ \frac{1}{2} {x}_{1}^{2} - \frac{{a}_{12}}{2 {a}_{21}} {x}_{2}^{2} + b ] {ξ}_{1} ( t ) \\ {\dot{x}}_{2} = {a}_{21} {x}_{1} + {a}_{22} {x}_{2} - \frac{2 {a}_{22}^{2} {a}_{12}^{3}}{{( δ - 1 )}^{2}} [ \frac{1}{2} {x}_{1}^{2} - \frac{{a}_{12}}{2 {a}_{21}} {x}_{2}^{2} + b ] {x}_{2} - \frac{2 {a}_{22} {a}_{12}}{\sqrt{2 π} ( δ - 1 )} \cdot \cdot [ \frac{1}{2} {x}_{1}^{2} - \frac{{a}_{12}}{2 {a}_{21}} {x}_{2}^{2} + b ] {ξ}_{2} ( t ) \qquad ( 3.8 )$$

If σᵢₖ(x, t) are bounded functions and the functions Fᵢ(x, t) satisfy the Lipshitz condition ∥F(x′−x)∥≦K∥x′−x∥, K=const>0, then for every smoothly-varying realization of process y(t) the stochastic equations can be solved by the method of successive substitution which is convergent and defines smoothly-varying trajectories x(t). Thus, Markovian process x(t) has smoothly trajectories with the probability 1. This result can be used as a background in numerical stochastic simulation.

The stochastic differential equation for the variable xᵢ is given by

$$\frac{ⅆ {x}_{i}}{ⅆ t} = {F}_{i} ( x ) + {G}_{i} ( x ) {ξ}_{i} ( t ) , i = 1 , 2 , … , N , x = ( {x}_{1} , {x}_{2} , … , {x}_{N} ) . \qquad ( 4.1 )$$

These equations can be integrated using two different algorithms: Milshtein; and Heun methods. In the Milshtein method, the solution of stochastic differential equation (4.1) is computed by the means of the following recursive relations:

$${x}_{i} ( t + δ t ) = [ {F}_{i} ( x ( t ) ) + \frac{{σ}^{2}}{2} {G}_{i} ( x ( t ) ) \frac{ⅆ {G}_{i} ( x ( t ) )}{ⅆ {x}_{i}} ] δ t + {G}_{i} ( x ( t ) ) \sqrt{{σ}^{2} δ t} {η}_{i} ( t ) , \qquad ( 4.2 )$$

where ηᵢ(t) are independent Gaussian random variables and the variance is equal tol.

The second term in equation (4.2) is included because equation (4.2) is interpreted in the Stratonovich sense. The order of numerical error in the Milshtein method is δt. Therefore, small δt (i.e., (δt=1×10⁻⁴ for σ²=1) is be used, while its computational effort per time step is relatively small. For large σ, where fluctuations are rapid and large, a longer integration period and small δt is used. The Milshtein method quickly becomes impractical.

The Heun method is based on the second-order Runge-Kutta method, and integrates the stochastic equation by using the following recursive equation:

$${x}_{i} ( t + δ t ) = {x}_{i} ( t ) + \frac{δ t}{2} [ {F}_{i} ( x ( t ) ) + {F}_{i} ( y ( t ) ) ] + \frac{\sqrt{{σ}^{2} δ t}}{2} {η}_{i} ( t ) [ {G}_{i} ( x ( t ) ) + {G}_{i} ( y ( t ) ) ] , \qquad ( 4.3 )$$

where

y₁(t)=xᵢ(t)+F(xᵢ(t))δt+G(xᵢ(t))\sqrt{σ²δt}ηᵢ(t).

The Heun method accepts larger δt than the Milshtein method without a significant increase in computational effort per step. The Heun method is usually used for σ²>2.

The time step δt can be chosen by using a stability condition, and so that averaged magnitudes do not depend on δt within statistical errors. For example, δt=5×10⁻⁴ for σ²=1 land δt=1×10⁻⁵ for σ²⁼¹⁵. The Gaussian random numbers for the simulation were generated by using the Box-Muller-Wiener algorithms or a fast numerical inversion method.

Table 3.1 summarizes the stochastic simulation of typical road signals.

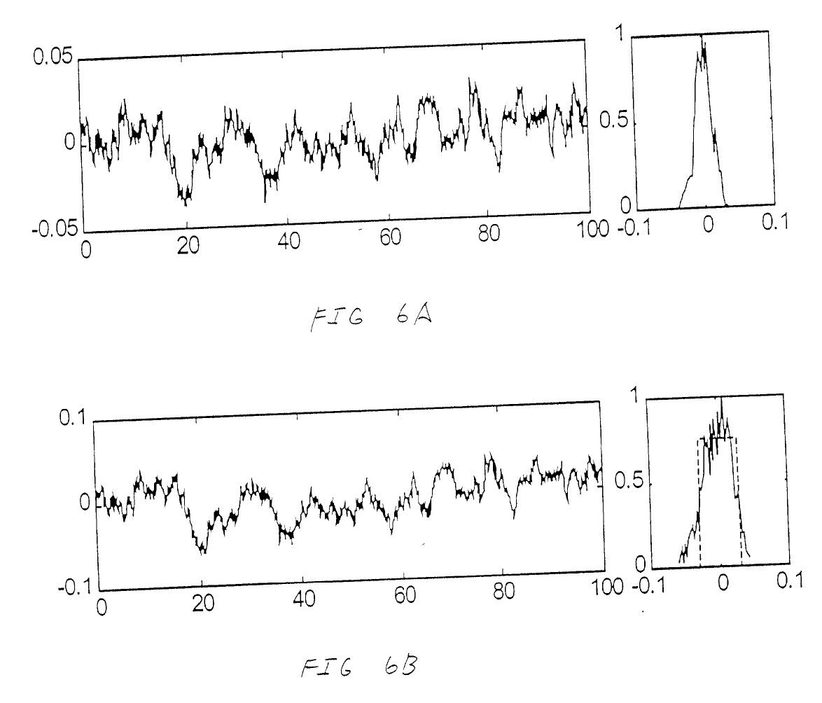

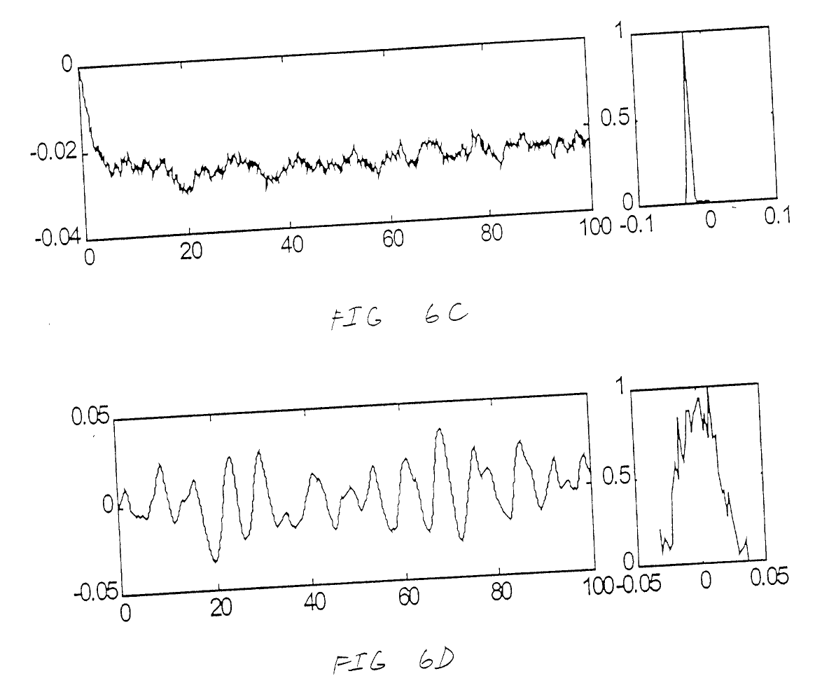

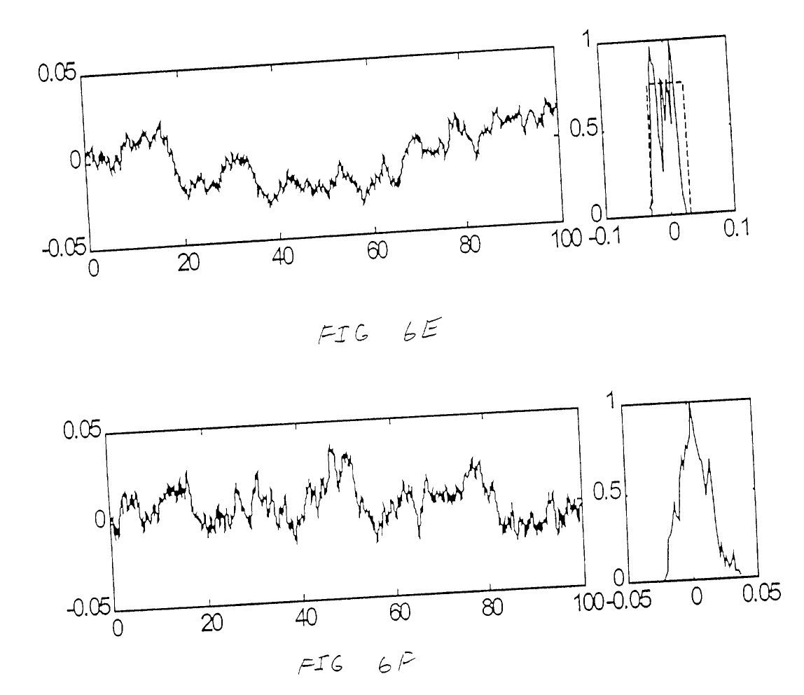

TABLE 3.1

| Types of | | | Results of |
|---|---|---|---|
| Correlation | Type of Probabilty | | Stochastic |
| Function | Density Function | Forming Filter Equations | Simulations |
| | 1D Gaussian | | |
| $R ( τ ) = {σ}^{2} {e}^{- ατ \vert}$ | $p ( y ) = \frac{1}{σ \sqrt{2 π}} {e}^{- \frac{1}{2} ( \frac{y - μ}{σ} )}$ | $\dot{y} + αy = {σ}^{2} ξ ( t )$ | |
| | 1D Uniform | | |
| | $p ( y ) = \{ \begin{matrix}0 , & y ∉ [ {y}_{0} - \\ \frac{1}{2 Δ} , & y ∈ [ {y}_{0} -\end{matrix}$ | $\dot{y} + \frac{α}{2} y = \frac{{σ}^{2}}{\sqrt{2 π}} \sqrt{α ( {Δ}^{2} - {y}^{2} )} ξ ( t )$ | |
| | 1D Rayleigh | | |
| | $p ( y ) = \begin{matrix}y \\ {μ}^{2}\end{matrix} {e}^{- ( \frac{{y}^{2}}{2 {μ}^{2}} )}$ | $\dot{y} + \frac{α}{2} y + \frac{2 α}{μ} = \frac{{σ}^{2}}{\sqrt{2 π}} \sqrt{\frac{2 α}{μ} ( y + \frac{2}{μ} )} ξ ( t )$ | |
| | 2D Gaussian | | |
| $R ( τ ) = {σ}^{2} {e}^{- ατ \vert} ( cos ω τ + \frac{α}{ω} sin \vert τ \vert )$ | $p ( {y}_{1} , {y}_{2} ) = \begin{matrix}1 \\ 2 {πσ}_{1} {σ}_{2}\end{matrix} {e}^{- \frac{1}{2} ( {( \frac{{y}_{1} - {μ}_{1}}{{σ}_{1}} )}^{2} + ( \frac{{y}_{2} -}{σ}}$ | $\ddot{y} + 2 α \dot{y} + ( {α}^{2} + {ω}^{2} ) y = \sqrt{2 {ασ}^{2} ( {α}^{2} + {ω}^{2} )} ξ ( t )$ | |
| | 2D Uniform | | |
| | $\begin{matrix}p ( {y}_{1} , {y}_{2} ) = \begin{matrix}1 \\ 4 {Δ}_{1} {Δ}_{2}\end{matrix} - {Δ}_{1} < {y}_{1} < {Δ}_{1} - \\ {Δ}_{2} < {y}_{2} < {Δ}_{2}\end{matrix}$ | $\begin{matrix}{\dot{y}}_{1} = \frac{1}{2} {a}_{11} {y}_{1} + {a}_{12} {y}_{2} + \sqrt{( - \frac{{a}_{11}}{2 π} ( {Δ}_{1} - {y}_{1}^{2} ) )} {ξ}_{1} ( t ) \\ {\dot{y}}_{2} = \frac{1}{2} {a}_{22} {y}_{2} + {a}_{21} {y}_{1} + \sqrt{( - \frac{{a}_{22}}{2 π} ( {Δ}_{2} - {y}_{2}^{2} ) )} {ξ}_{2} ( t )\end{matrix}$ | |
| | 2D Hyperbolic | | |
| | $\begin{matrix}p ( {y}_{1} , {y}_{2} ) = \\ ρ ( λ ) = {{C}_{1} ( λ + b )}^{- δ} \\ b > 0 ; δ > 1 \\ λ = \frac{1}{2} {y}_{1}^{2} - \frac{{a}_{12}}{2 {a}_{21}} {y}_{2}^{2}\end{matrix}$ | $\begin{matrix}{y}_{1} = {a}_{11} {y}_{1} + {a}_{12} {y}_{2} - \frac{2 {a}_{11}^{2}}{{( δ - 1 )}^{2}} [ \frac{1}{2} {y}_{1}^{2} - \frac{{a}_{12}}{2 {a}_{21}} {y}_{2}^{2} + b ] {y}_{1} - \\ \frac{2 {a}_{11}}{\sqrt{2 π} ( δ - 1 )} [ \frac{1}{2} {y}_{1}^{2} - \frac{{a}_{12}}{2 {a}_{21}} {y}_{2}^{2} + b ] {ξ}_{1} ( t ) \\ {\dot{y}}_{2} = {a}_{21} {y}_{1} + {a}_{22} {y}_{2} + \frac{2 {a}_{22}^{2} {a}_{12}^{3}}{{{a}_{21}^{3} ( δ - 1 )}^{2}} [ \frac{1}{2} {y}_{1}^{2} - \frac{{a}_{12}}{2 {a}_{21}} {y}_{2}^{2} + b ] {y}_{2} + \\ \frac{2 {a}_{22} {a}_{12}}{\sqrt{2 π} {a}_{21} ( δ - 1 )} [ \frac{1}{2} {y}_{1}^{2} - \frac{{a}_{12}}{2 {a}_{21}} {y}_{2}^{2} + b ] {ξ}_{2} ( t )\end{matrix}$ | FIG. 6F |

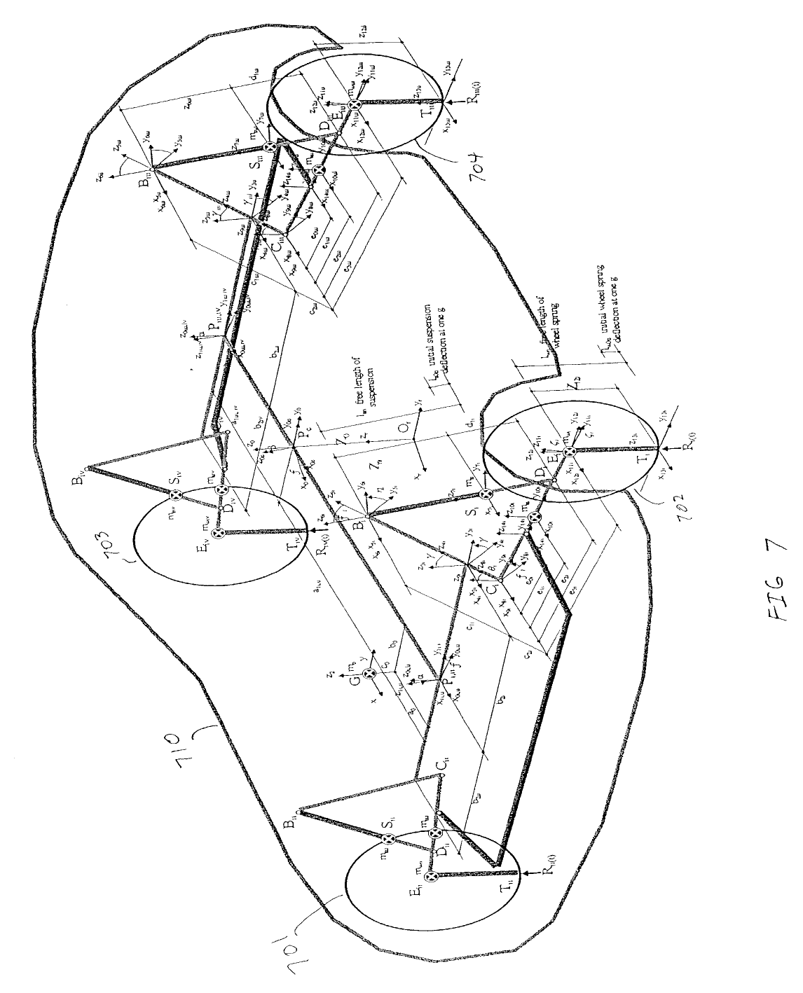

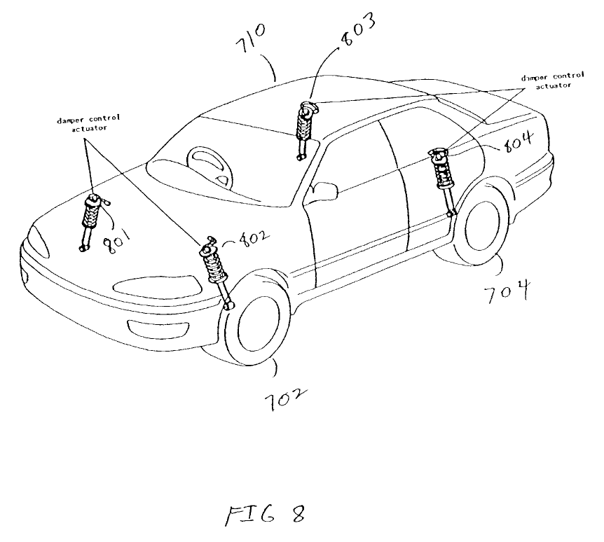

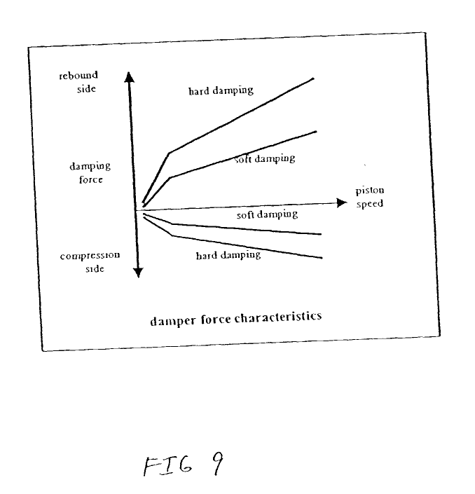

FIG. 7 shows a vehicle body 710 with coordinates for describing position of the body 710 with respect to wheels 701-704 and suspension system. A global reference coordinate xᵣ, yᵣ, zᵣ is assumed to be at the geometric center Pᵣ of the vehicle body 710. The following are the transformation matrices to describe the local coordinates for the suspension and its components:

{2} is a local coordinate in which an origin is the center of gravity of the vehicle body 710;

{7} is a local coordinate in which an origin is the center of gravity of the suspension;

{10n} is a local coordinate in which an origin is the center of gravity of the n'th arm;

{12n} is a local coordinate in which an origin is the center of gravity of the n'th wheel;

{13n} is a local coordinate in which an origin is a contact point of the n'th wheel relative to the road surface; and

{14} is a local coordinate in which an origin is a connection point of the stabilizer.

Expressions for the entropy production of the suspension system shown in FIG. 7 are developed in U.S. application Ser. No. 09/176,987 hereby incorporated by reference in its entirety.

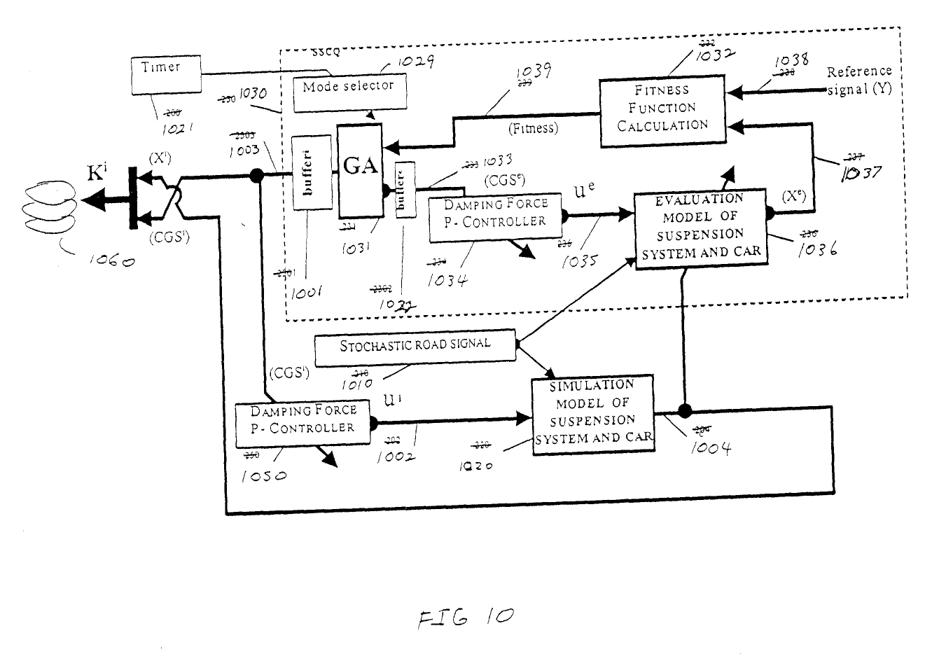

FIG. 8 shows the vehicle body 710 and the wheels 702 and 704 (the wheels 701 and 703 are hidden). FIG. 8 also shows dampers 801-804 configured to provide adjustable damping for the wheels 701-704 respectively. In one embodiment, the dampers 801-804 are electronically-controlled dampers. In one embodiment, a stepping motor actuator on each damper controls an oil valve. Oil flow in each rotary valve position determines the damping factor provided by the damper.

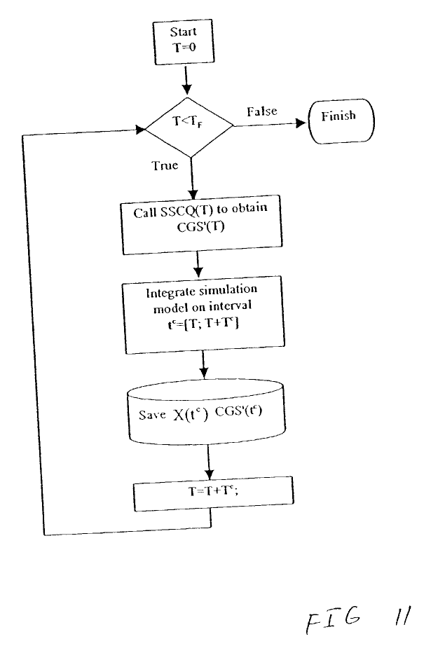

FIG. 9 shows damper force characteristics as damper force versus piston speed characteristics when the rotary valve is placed in a hard damping position and in a soft damping position. The valve is controlled by the stepping motor to be placed between the soft and the hard damping positions to generate intermediate damping force.

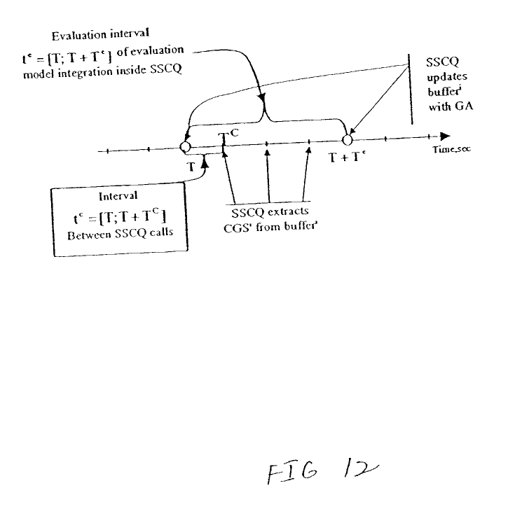

The SSCQ 130, shown in FIG. 2, is an off-line block that produces the teaching signal Ki for the FLCS 140. FIG. 10 shows the structure of an SSCQ 1030 for use in connection with a simulation model of the full car and suspension system. The SSCQ 1030 is one embodiment of the SSCQ 130. In addition to the SSCQ 1030, FIG. 10 also shows a stochastic road signal generator 1010, a suspension system simulation model 1020, a proportional damping force controller 1050, and a timer 1021. The SSCQ 1030 includes a mode selector 1029, an output buffer 1001, a GA 1031, a buffer 1022, a proportional damping force controller 1034, a fitness function calculator 1032, and an evaluation model 1036.

The Timer 1021 controls the activation moments of the SSCQ 1030. An output of the timer 1021 is provided to an input of the mode selector 1029. The mode selector 1029 controls operational modes of the SSCQ 1030. In the SSCQ 1030, a reference signal y is provided to a first input of the fitness function calculator 1032. An output of the fitness function calculator 1032 is provided to an input of the GA 1031. A CGS^{e} output of the GA 1031 is provided to a training input of the damping force controller 1034 through the buffer 1022. An output U^{e} of the damping force controller 1034 is provided to an input of the evaluation model 1036. An X^{e} output of the evaluation model 1036 is provided to a second input of the fitness function calculator 1032. A CGSⁱ output of the GA 1031 is provided (through the buffer 1001) to a training input of the damping force controller 1050. A control output from the damping force controller 1050 is provided to a control input of the suspension system simulation model 1020. The stochastic road signal generator 1010 provides a stochastic road signal to a disturbance input of the suspension system simulation model 1020 and to a disturbance input of the evaluation model 1036. A response output Xⁱ from the suspension system simulation model 1020 is provided to a training input of the evaluation model 1036. The output vector Kⁱ from the SSCQ 1030 is obtained by combining the CGS¹ output from the GA 1031 (through the buffer 1001) and the response signal X¹ from the suspension system simulation model 1020.

Road signal generator 1010 generates a road profile. The road profile can be generated from stochastic simulations as described above in connection with FIGS. 4-6F, or the road profile can be generated from measured road data. The road signal generator 1010 generates a road signal for each time instant (e.g., each clock cycle) generated by the timer 1021.

The simulation model 1020 is a kinetic model of the full car and suspension system with equations of motion, as obtained, for example, in connection with FIG. 7. In one embodiment, the simulation model 1020 is integrated using high-precision order differential equation solvers.

The SSCQ 1030 is an optimization module that operates on a discrete time basis. In one embodiment, the sampling time of the SSCQ 1030 is the same as the sampling time of the control system 1050. Entropy production rate is calculated by the evaluation model 1036, and the entropy values are included into the output (X^{e}) of the evaluation model 1036.

The following designations regarding time moments are used herein:

T = Moments of SSCQ calls
T_{c} = the sampling time of the control system 1050
Tₑ = the evaluation (observation) time of the SSCQ 1030
t_{c} = the integration interval of the simulation model 1004 with
fixed control parameters, t_{c}ε[T;T + T_{c}]
tₑ = Evaluation (Observation) time interval of the SSCQ, tₑε[T;T + Tₑ]

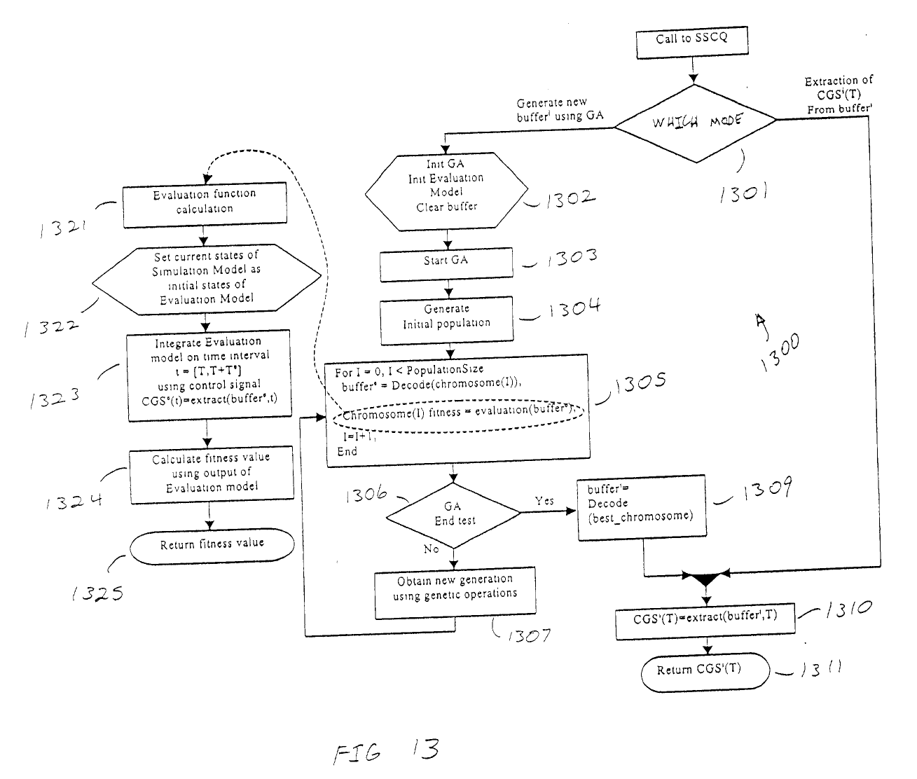

FIG. 11 is a flowchart showing operation of the SSCQ 1030 as follows:

1. At the initial moment (T=0) the SSCQ 1030 is activated and the SSCQ 1030 generates the initial control signal CGSⁱ(T).

2. The simulation model 1020 is integrated using the road signal from the stochastic road generator 1010 and the control signal CGSⁱ(T) on a first time interval t_{c} to generate the output Xⁱ.

3. The output X¹ and with the output CGS¹(T) are is saved into the data file 1060 as a teaching signal Kⁱ.

4. The time interval T is incremented by T_{c}(T=T+T_{c}).

5. The sequence 1-4 is repeated a desired number of times (that is while T<T_{F}). In one embodiment, the sequence 1-4 is repeated until the end of road signal is reached

Regarding step 1 above, the SSCQ block has two operating modes:

1. Updating of the buffer 1001 using the GA 1031

2. Extraction of the output CGS¹(T) from the buffer 1001.

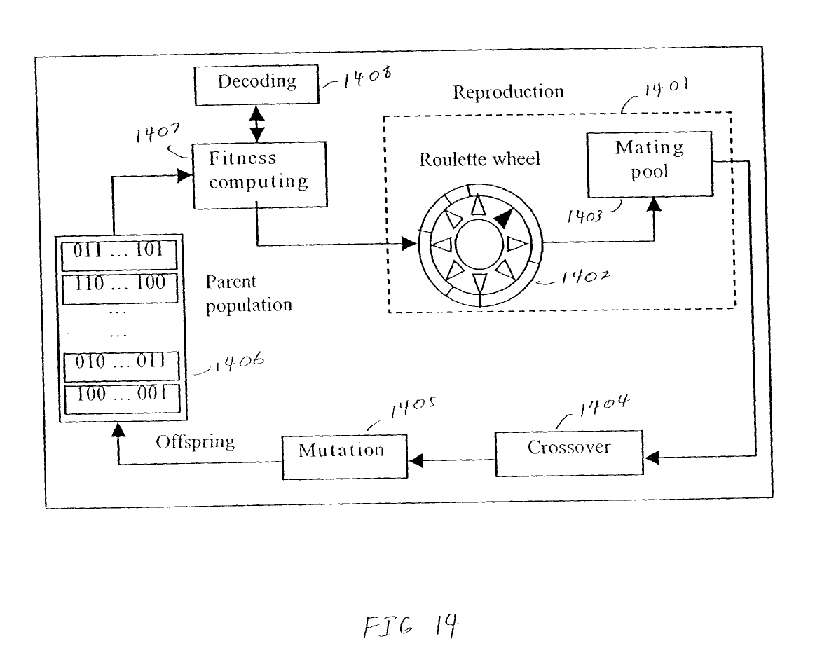

The operating mode of the SSCQ 1030 is controlled by the mode selector 1029 using information regarding the current time moment T, as shown in FIG. 12. At intervals of Tₑ the SSCQ 1030 updates the output buffer 1001 with results from the GA 1031. During the interval Tₑ at each interval T_{c}, the SSCQ extracts the vector CGS₁ from the output buffer 1001.

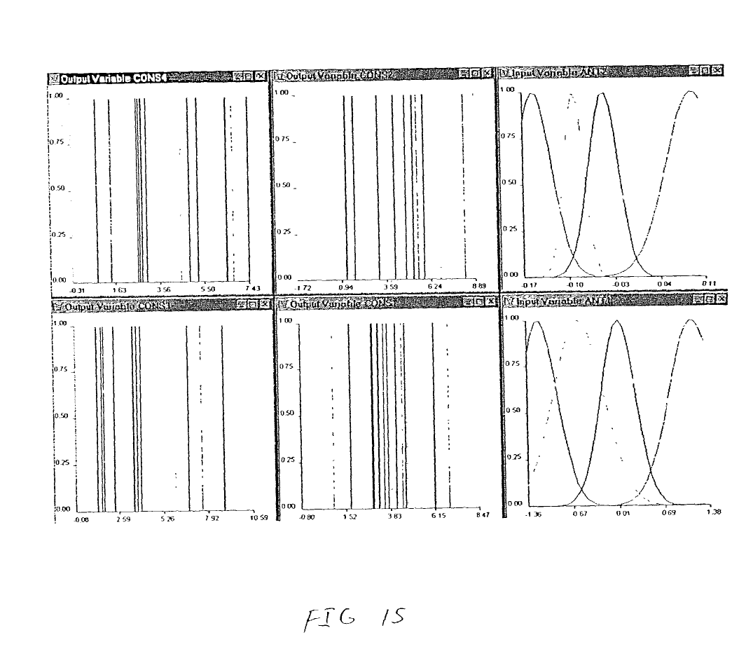

FIG. 13 is a flowchart 1300 showing operation of the SSCQ 1030 in connection with the GA 1031 to compute the control signal CGSⁱ. The flowchart 1300 begins at a decision block 1301, where the operating mode of the SSCQ 1030 is determined. If the operating mode is a GA mode, then the process advances to a step 1302; otherwise, the process advances to a step 1310. In the step 1302, the GA 1031 is initialized, the evaluation model 1036 is initialized, the output buffer 1001 is cleared, and the process advances to a step 1303. In the step 1303, the GA 1031 is started, and the process advances to a step 1304 where an initial population of chromosomes is generated. The process then advances to a step 1305 where a fitness value is assigned to each chromosome. The process of assigning a fitness value to each chromosome is shown in an evaluation function calculation, shown as a sub-flowchart having steps 1322-1325. In the step 1322, the current states of X¹(T) are initialized as initial states of the evaluation model 1036, and the current chromosome is decoded and stored in the evaluation buffer 1022. The sub-process then advances to the step 1323. The step 1323 is provided to integrate the evaluation model 1036 on time interval te using the road signal from the road generator 1010 and the control signal CGS^{e}(tₑ) from the evaluation buffer 1022. The process then advances to the step 1324 where a fitness value is calculated by the fitness function calculator 1032 by using the output X^{e} from the evaluation model 1036. The output X^{e} is a response from the evaluation model 1036 to the control signals CGS^{e}(tₑ) which are coded into the current chromosome. The process then advances to the step 1325 where the fitness value is returned to the step 1305. After the step 1305, the process advances to a decision block 1306 to test for termination of the GA. If the GA is not to be terminated, then the process advances to a step 1307 where a new generation of chromosomes is generated, and the process then returns to the step 1305 to evaluate the new generation. If the GA is to be terminated, then the process advances to the step 1309, where the best chromosome of the final generation of the GA, is decoded and stored in the output buffer 1001. After storing the decoded chromosome, the process advances to the step 1310 where the current control value CGS¹(T) is extracted from the output buffer 1001.

The structure of the output buffer 1001 is shown below as a set of row vectors, where first element of each row is a time value, and the other elements of each row are the control parameters associated with these time values. The values for each row include a damper valve position VP_{FL}, VP_{FR}, VP_{RL}, VP_{RR}, corresponding to front-left, front-right, rear-left, and rear-right respectively.

| Time | CGS¹ | | | |
|---|---|---|---|---|
| T | VP_{FL}(T) | VP_{FR}(T) | VP_{RL}(T) | VP_{RR}(T) |
| T + | VP_{FL}(T + T^{c}) | VP_{FR}(T + T^{c}) | VP_{RL}(T + T^{c}) | VP_{RR}(T + T^{c}) |
| T^{c} | | | | |
| . . . | . . . | . . . | . . . | . . . |
| T + | VP_{FL}(T + T^{e}) | VP_{FR}(T + T^{e}) | VP_{RL}(T + T^{e}) | VP_{RR}(T + T^{e}) |
| T^{e} | | | | |

The output buffer 1001 stores optimal control values for evaluation time interval tₑ from the control simulation model, and the evaluation buffer 1022 stores temporal control values for evaluation on the interval tₑ for calculation of the fitness function.

Two similar models are used. The simulation model 1020 is used for simulation and the evaluation model 1036 is used for evaluation. There are many different methods for numerical integration of systems of differential equations. Practically, these methods can be classified into two main classes: (1) variable-step integration methods with control of integration error; and (2) fixed-step integration methods without integration error control.

Numerical integration using methods of type (1) is very precise, but time-consuming. Methods of type (2) are typically faster, but with smaller precision. During each SSCQ call in the GA mode, the GA 1031 evaluates the fitness function 1032 many times and each fitness function calculation requires integration of the model of dynamic system (the integration is done each time). By choosing a small-enough integration step size, it is possible to adjust a fixed-step solver such that the integration error on a relatively small time interval (like the evaluation interval tₑ) will be small and it is possible to use the fixed-step integration in the evaluation loop for integration of the evaluation model 1036. In order to reduce total integration error it is possible to use the result of high-order variable-step integration of the simulation model 1020 as initial conditions for evaluation model integration. The use of variable-step solvers to integrate the evaluation model can provide better numerical precision, but at the expense of greater computational overhead and thus longer run times, especially for complicated models.

The fitness function calculation block 1032 computes a fitness function using the reference signal Y and the response (X^{e}) from the evaluation model 1036 (due to the control signal CGS^{e}(tₑ) provided to the evaluation module 1036).

The fitness function 1032 is computed as a vector of selected components of a matrix (x^{e}) and its squared absolute value using the following form:

$${Fitness}^{2} = {\sum }_{t ∈ [ T , {T}^{e} ]}^{} [ {\sum }_{i}^{} {{w}_{i} ( {x}_{it}^{e} )}^{2} + {\sum }_{j}^{} {{w}_{j} ( {y}_{j} - {x}_{jt}^{e} )}^{2} + {\sum }_{k}^{} {w}_{k} {f ( {x}_{kt}^{e} )}^{2} ] \to min , \qquad ( 6.1 )$$

where:

i denotes indexes of state variables which should be minimized by their absolute value; j denotes indexes of state variables whose control error should be minimized; k denotes indexes of state variables whose frequency components should be minimized; and wᵣ, r=i, j, k are weighting factors which represent the importance of the corresponding parameter from the human feelings point of view. By setting these weighting function parameters, it is possible to emphasize those elements from the output of the evaluation model that are correlated with the desired human requirements (e.g., handling, ride quality, etc.). In one embodiment, the weighting factors are initialized using empirical values and then the weighting factors are adjusted using experimental results.

Extraction of frequency components can be done using standard digital filtering design techniques for obtaining the filter parameters. Digital filtering can be provided by a standard difference equation applied to elements of the matrix X^{e}:

$$a ( 1 ) f ( {x}_{k}^{e} ( {t}^{e} ( N ) ) ) = b ( 1 ) {x}_{k}^{e} ( {t}^{e} ( N ) ) + b ( 2 ) {x}_{k}^{e} ( {t}^{e} ( N - 1 ) ) + … + b ( {n}_{b} + 1 ) {x}_{k}^{e} ( {t}^{e} ( N - {n}_{b} ) ) -- a ( 2 ) {x}_{k}^{e} ( {t}^{e} ( N - 1 ) ) - … - a ( {n}_{a} + 1 ) {x}_{k}^{e} ( {t}^{e} ( N - {n}_{a} ) ) \qquad ( 6.2 )$$

where a, b are parameters of the filter, N is the number of the current point, and n_{b}, nₐ describe the order of the filter. In case of a Butterworth filter, n_{b}=nₐ.

In one embodiment, the GA 1031 is a global search algorithms based on the mechanics of natural genetics and natural selection. In the genetic search, each a design variable is represented by a finite length binary string and then these finite binary strings are connected in a head-to-tail manner to form a single binary string. Possible solutions are coded or represented by a population of binary strings. Genetic transformations analogous to biological reproduction and evolution are subsequently used to improve and vary the coded solutions. Usually, three principle operators, i.e., reproduction (selection), crossover, and mutation, are used in the genetic search.

The reproduction process biases the search toward producing more fit members in the population and eliminating the less fit ones. Hence, a fitness value is first assigned to each string (chromosome) the population. One simple approach to select members from an initial population to participate in the reproduction is to assign each member a probability of selection on the basis of its fitness value. A new population pool of the same size as the original is then created with a higher average fitness value.

The process of reproduction simply results in more copies of the dominant or fit designs to be present in the population. The crossover process allows for an exchange of design characteristics among members of the population pool with the intent of improving the fitness of the next generation. Crossover is executed by selecting strings of two mating parents, randomly choosing two sites.

Mutation safeguards the genetic search process from a premature loss of valuable genetic material during reproduction and crossover. The process of mutation is simply to choose few members from the population pool according to the probability of mutation and to switch a 0 to 1 or vice versa at randomly sites on the chromosome.

FIG. 14 illustrates the processes of reproduction, crossover and mutation on a set of chromosomes in a genetic analyzer. A population of strings is first transformed into decimal codes and then sent into the physical process 1407 for computing the fitness of the strings in the population. A biased roulette wheel 1402, where each string has a roulette wheel slot sized in proportion to its fitness is created. A spinning of the weighted roulette wheel yields the reproduction candidate. In this way, a higher fitness of strings has a higher number of offspring in the succeeding generation. Once a string has been selected for reproduction, a replica of the string based on its fitness is created and then entered into a mating pool 1401 for waiting the further genetic operations. After reproduction, a new population of strings is generated through the evolutionary processes of crossover 1404 and mutation 1405 to produce a new parent population 1406. Finally, the whole genetic process, as mentioned above, is repeated again and again until an optimal solution is found.

The Fuzzy Logic Control System (FLCS) 240 shown in FIG. 2 includes the information filter 241, the FNN 142 and the FC 143. The information filter 241 compresses the teaching signal Kⁱ to obtain the simplified teaching signal K^{c}, which is used with the FNN 142. The FNN 142, by interpolation of the simplified teaching signal K_{c}, obtains the knowledge base (KB) for the FC 143.

As it was described above, the output of the SSCQ is a teaching signal Kⁱ that contains the information of the behavior of the controller and the reaction of the controlled object to that control. Genetic algorithms in general perform a stochastic search. The output of such a search typically contains much unnecessary information (e.g., stochastic noise), and as a result such a signal can be difficult to interpolate. In order to exclude the unnecessary information from the teaching signal K¹, the information filter 241 (using as a background the Shannon's information theory) is provided. For example, suppose that A is a message source that produces the message a with probability p(a), and further suppose that it is desired to represent the messages with sequences of binary digits (bits) that are as short as possible. It can be shown that the mean length L of these bit sequences is bounded from below by the Shannon entropy H(A) of the source: L≧H(A), where

$$H ( A ) = - {\sum }_{a}^{} p ( s ) {log}_{2} p ( a ) \qquad ( 7.1 )$$

Furthermore, if entire blocks of independent messages are coded together, then the mean number \overline{L} of bits per message can be brought arbitrary close to H(A).

This noiseless coding theorem shows the importance of the Shannon entropy H(A) for the information theory. It also provides the interpretation of H(A) as a mean number of bits necessary to code the output of A using an ideal code. Each bit has a fixed ‘cost’ (in units of energy or space or money), so that H(A) is a measure of the tangible resources necessary to represent the information produced by A.

In classical statistical mechanics, in fact, the statistical entropy is formally identically to the Shannon entropy. The entropy of a macrostate can be interpreted as the number of bits that would be required to specify the microstate of the system.

Suppose x₁, . . . , x_{N} are N independent, identical distributed random variables, each with mean \overline{x} and finite variance. Given δ, ε>0, there exist N₀ such that, for N≧N₀,

$$P ( \vert \frac{1}{N} {\sum }_{i}^{} {x}_{i} - \overline{x} \vert > δ ) < ϵ \qquad ( 7.2 )$$

This Standard result is known as the weak law of large numbers. A sufficiently long sequence of independent, identically distributed random variables will, with a probability approaching unity, have an average that is close to mean of each variable.

The weak law can be used to derive a relation between Shannon entropy H(A) and the number of ‘likely’ sequences of N identical random variables. Assume that a message source A produces the message a with probability p(a). A sequence α=a₁ a₂ . . . a_{N} of N independent messages from the same source will occur in ensemble of all N sequences with probability P(α)=p(a₁)·p(a₂) . . . p(a_{N}). Now define a random variable for each message by x=−log₂ p(a), so that H(A)=\overline{x}. It is easy to see that

$$- {log}_{2} P ( α ) = {\sum }_{i}^{} {x}_{i} .$$

From the weak law, it follows that, if ε, δ>0, then for sufficient large N

$$P ( \vert - \frac{1}{N} {log}_{2} P ( α ) - H ( A ) \vert > δ ) < ϵ \qquad ( 7.3 )$$

for N sequences of α. It is possible to partition the set of all N sequences into two subsets:

a) A set A of “likely” sequences for which

$$\vert - \frac{1}{N} {log}_{2} P ( α ) - H ( A ) \vert \leq δ$$

b) A set of ‘unlikely’ sequences with total probability less than a, for which this inequality fails.

This provides the possibility to exclude the ‘unlikely’ information from the set A which leaves the set of sequences A, with the same information amount as in set Abut with a smaller number of sequences.

The FNN 142 is used to find the relations between (Input) and (Output) components of the teaching signal K^{c}. The FNN 142 is a tool that allows modeling of a system based on a fuzzy logic data structure, starting from the sampling of a process/function expressed in terms of input-output values pairs (patterns). Its primary capability is the automatic generation of a database containing the inference rules and the parameters describing the membership functions. The generated Fuzzy Logic knowledge base (KB) represents an optimized approximation of the process/function provided as input. FNN performs rule extraction and membership function parameter tuning using learning different learning methods, like error back propagation, fuzzy clustering, etc. The KB includes a rule base and a database. The rule base stores the information of each fuzzy rule. The database stores the parameters of the membership functions. Usually, in the training stage of FNN, the parts of KB are obtained separately.

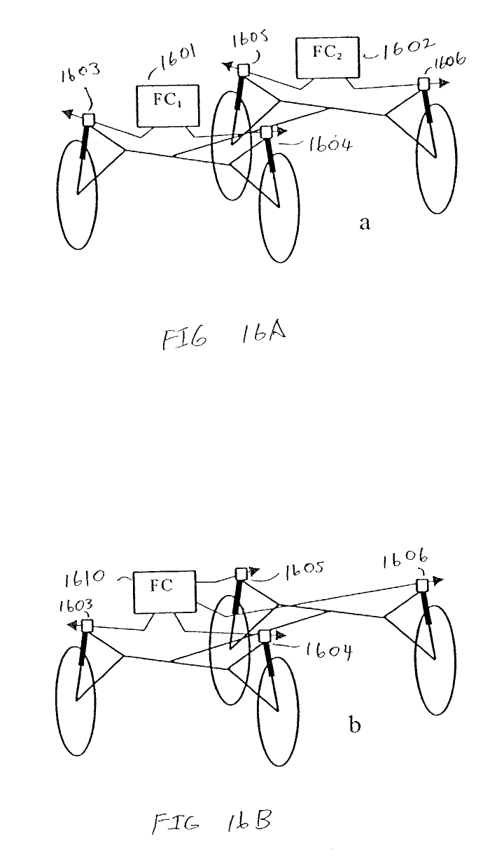

An example of a KB of a suspension system fuzzy controller obtained using the FNN 142 is presented in FIG. 15. The knowledge base of a fuzzy controller includes two parts, a database where parameters of membership functions are stored, and a database of rules where fuzzy rules are stored. In the example shown in FIG. 15, the fuzzy controller has two inputs (ANT1) and (ANT2) which are pitch angle acceleration and roll angle acceleration, and 4 output variables (CONS1, . . . CONS4), are the valve positions of FL, FR, RL, RR wheels respectively. Each input variable has 5 membership functions, which gives total number of 25 rules.

The type of fuzzy inference system in this case is a zero-order Sugeno-Takagi Fuzzy inference system. In this case the rule base has the form presented in the list below.

IF ANT1 is MBF1_1 and ANT2 is MBF2_1 then CONS1 is A1_1 and . . . and CONS4 is A4_1

IF ANT1 is MBF1_1 and ANT2 is MBF2_2 then CONS1 is A1_2 and . . . and CONS4 is A4_2

. . .

IF ANT1 is MBF1_5 and ANT2 is MBF2_5 then CONS1 is A1_25 and . . . and CONS4 is A4_25

In the example above, when there are only 25 possible combinations of input membership functions, so it is possible to use all the possible rules. However, when the number of input variables is large, the phenomenon known as “rule blow” takes place. For example, if number of input variables is 6, and each of them has 5 membership functions, then the total number of rules could be: N=5⁶=15625 rules. In this case practical realization of such a rule base will be almost impossible due to hardware limitations of existing fuzzy controllers. There are different strategies to avoid this problem, such as assigning fitness value to each rule, and exclusion of rules with small fitness from the rule base. The rule base will be incomplete, but realizable.

The FC 143 is an on-line device that generates the control signals using the input information from the sensors comprising the following steps: (1) fuzzyfication; (2) fuzzy inference; and (3) defuzzyfication.

Fuzzyfication is a transferring of numerical data from sensors into a linguistic plane by assigning membership degree to each membership function. The information of input membership function parameters stored in the knowledge base of fuzzy controller is used.

Fussy inference is a procedure that generates linguistic output from the set of linguistic inputs obtained after fuzzyfication. In order to perform the fuzzy inference, the information of rules and of output membership functions from knowledge base is used.

Defuzzyfication is a process of converting of linguistic information into the digital plane. Usually, the process of defuzzyfication include selecting of center of gravity of a resulted linguistic membership function.

Fuzzy control of a suspension system is aimed at coordinating damping factors of each damper to control parameters of motion of car body. Parameters of motion can include, for example, pitching motion, rolling motion, heave movement, and/or derivatives of these parameters. Fuzzy control in this case can be realized in the different ways, and different number of fuzzy controllers used. For example, in one embodiment shown in FIG. 16A, fuzzy control is implemented using two separate controllers, one controller for the front wheels, and one controller for the rear wheels, as shown in FIG. 16A, where a first fuzzy controller 1601 controls front-wheel damper actuators 1603 and 1604 and a second fuzzy controller 1602 controls rear-wheel damper actuators 1605 and 1606. In one embodiment, shown in FIG. 16B, a single controller 1610 controls the actuators 1603-1606.

Quantum Searching

As discussed above, the GA uses a global search algorithm based on the mechanics of natural genetics and natural selection. In the genetic search, each design variable is presented by a finite length binary string and the set of all possible solutions is so encoded into a population of binary strings. Genetic transformations, analogous to biological reproduction and evolution, are subsequently used to vary and improve the encoded solutions. Usually, three main operators, reproduction, crossover and mutation are used in the genetic search.

The reproduction process is one that biases the search toward producing more fit members in the population and eliminating the less fit ones. Hence, a fitness value is first assigned to each string in the population. One simple approach to select members from an initial population to participate in the reproduction is to assign each member a probability of being selected, on the basis of its fitness value. A new population pool of the same size as the original is then created with a higher average fitness value. The process of reproduction results in more copies of the dominant design to be present in the population.

The crossover process allows for an exchange of design characteristics among members of the population pool with the intent of improving the fitness of the next generation. Crossover is executed, for example, by selecting strings of two mating parents, randomly choosing two sites on the strings, and swapping strings of 0's and 1's between these chosen sites.

Mutation helps safeguard the genetic search process from a premature loss of valuable genetic material during reproduction and crossover. The process of mutation involves choosing a few members from the population pool on the basis of their probability of mutation and switch 0 to 1 or vice versa at a randomly selected mutation rate on the selected string.

For 1-point crossover χ and mutation μ, the Walsh-Hadamard transform of the (2-bit representation) mixing matrix is given by:

$$\hat{M} = ( \begin{matrix}1 & \frac{1}{2} - μ & \frac{1}{2} - μ & {( \frac{1}{2} - μ )}^{2} ( 2 - χ ) \\ \frac{1}{2} - μ & 0 & {( \frac{1}{2} - μ )}^{2} χ & 0 \\ \frac{1}{2} - μ & {( \frac{1}{2} - μ )}^{2} χ & 0 & 0 \\ {( \frac{1}{2} - μ )}^{2} ( 2 - χ ) & 0 & 0 & 0\end{matrix} )$$

The matrix \hat{M} is sparse, containing nine non-zero entries. The Walsh-Hadamard transform of the twist of the (2-bit representation) mixing matrix is given by:

$${\hat{M}}^{x} = ( \begin{matrix}1 & 0 & 0 & 0 \\ \frac{1}{2} - μ & \frac{1}{2} - μ & 0 & 0 \\ \frac{1}{2} - μ & 0 & \frac{1}{2} - μ & 0 \\ {( \frac{1}{2} - μ )}^{2} ( 2 - χ ) & {( \frac{1}{2} - μ )}^{2} χ & {( \frac{1}{2} - μ )}^{2} χ & {( \frac{1}{2} - μ )}^{2} ( 2 - χ )\end{matrix} )$$

The mixing matrix is lower triangular. With the above matrix representation of a GA, it is possible to describe the GA in terms of a quantum gate as described in more detail below.

Typically, the GA uses function evaluations alone and does not require function derivatives. While derivatives contribute to a faster convergence towards an optimum, derivatives may also direct the search towards a local optimum. Furthermore, since the search proceeds from several points in the design space to another set of design points, the GA method has a higher probability of locating a global minimum as opposed to those schemes that proceed from one point to another. In addition, genetic algorithms often work on a coding of design variables rather than variables themselves. This allows for an extension of these algorithms to a design space having a mix of continuous, discrete, and integer variables. These properties and the gate representation of GA are used below in a quantum genetic search algorithm.

As discussed above, FIG. 1 shows an intelligent control suspension system 100 based on soft computing to control the plant 120. The GA 131 searches for a set of control weights for the plant 120. The weight vector (k₁, . . . , kₕ) is used, in the general case, by the proportional-integral-differential (PID) controller 150 in the generation of a signal u*=δ(k₁, . . . , kₕ), which is applied to the plant. The entropy S(δ(k₁, . . . , kₕ)) associated to the behavior of the plant on this signal is assumed as a fitness function to be minimize by the GA 131. The GA 131 is repeated several times at regular time intervals in order to produce a set of weight vectors. The vectors generated by the 131 GA are then provided to the FNN 142. The output of the FNN 142 is provided to the fuzzy controller 143. The output of the fuzzy controller 143 is a collection of gain schedules for the PID controller 150.

For soft computing systems based on a genetic algorithm, there is very often no real control law in the classic control sense, but rather, control is based on a physical control law such as minimum entropy production. This allows robust control because the GA, combined with feedback, guarantee robustness. However, robust control is not necessarily optimal control.

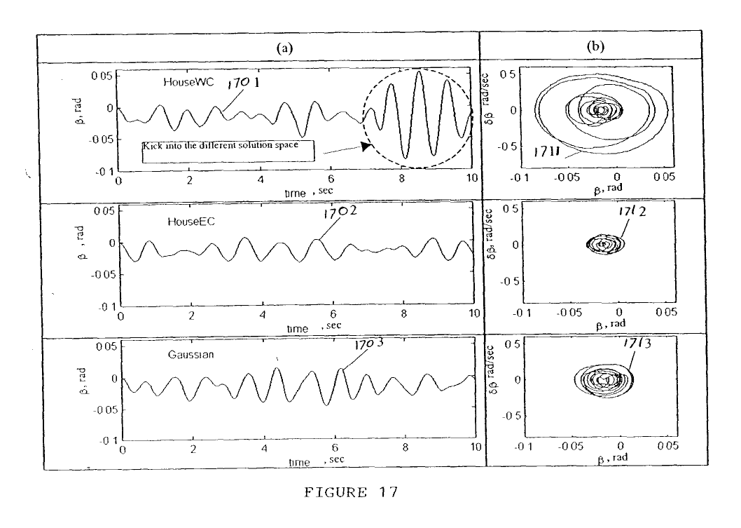

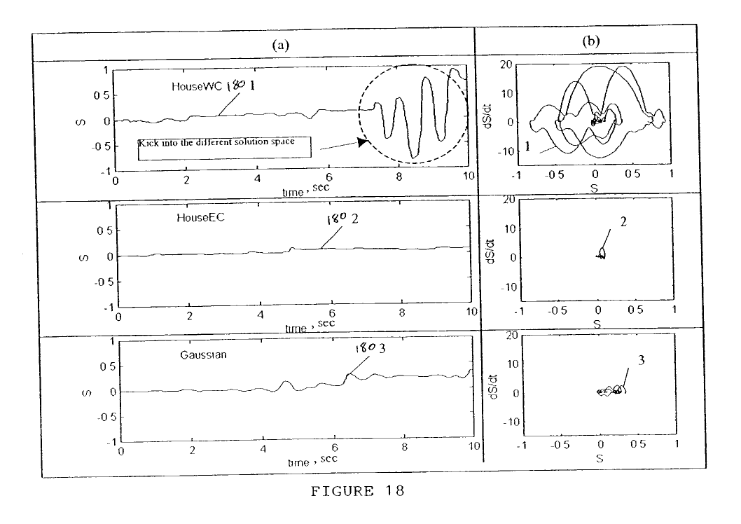

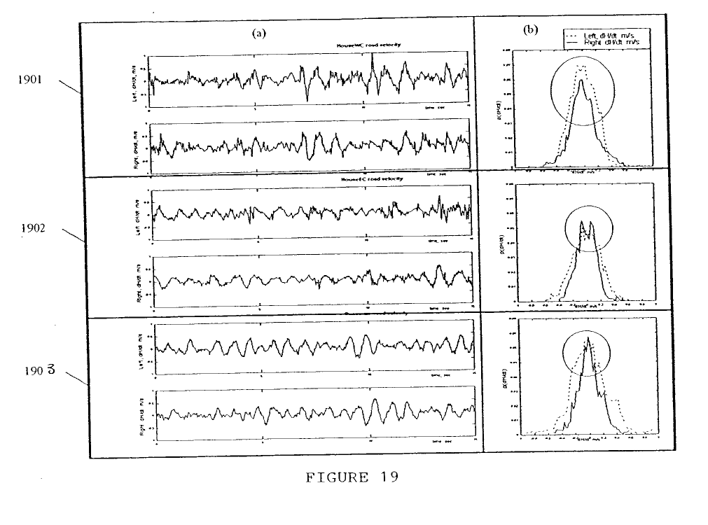

For random excitations with different statistical properties the GA attempts to find a global optimum solution for a given solution space. The GA produces look-up tables for the FC 143. A random disturbance m(t) can force the output of the GA 131 into a different solution space. FIGS. 17 and 18 show an example of how a random excitation on a control object can disturb the single space of solutions for a fuzzy controller. The KB of the intelligent suspension control system was generated from stochastic simulation using a random Gaussian signal 1703 as the road. After on-line simulation with the Gaussian road, two actual road signals (based on roads measured in Japan) were simulated, as shown in curves 1701 and 1702. Relatively large oscillations in the curve 1701 show that the changes in statistical characteristics of the roads can disturb the single space of solutions for a fuzzy controller. FIG. 18 shows plots of the entropy in the suspension system for the roads corresponding to curves 1701-1702. Again, oscillations in the curve 1801 show that disturbances to the suspension system have forced the fuzzy controller 143 out of its solution space.

A new solution can be found by repeating the simulation with the GA and finding another single space solution with the entropy-based fitness function for the fuzzy controller with non-Gaussian excitation on the control object. As result, it is possible to generate different look-up tables for the fuzzy controller 143 for different road classes with different types of statistical characteristics.

The control system 100 uses the GA 131 to minimise the dynamic behaviour of the dynamic system (car and suspension system) by minimising the entropy production rate. Different kinds of random signals (stochastic disturbances) are presented by the profiles of roads. Some of these signals were measured from real roads, in Japan, and some of them were created using stochastic simulations with forming filters based on the FPK (Fokker—Planck—Kolmogorov) equation discussed above. FIG. 19 shows three typical road signals. FIG. 19 includes plots 1901, 1902, and 9103 that show the changing rates of the road signals. The assigned time scale (that is, the x axis of the charts 1901-1903) is calculated to simulate a vehicle speed of 50 kilometres per hour (kph). The charts 1901 and 1902 correspond to measured roads in Japan. The third chart, 1903 corresponds to a Gaussian road obtained by stochastic simulation with the fixed type of the correlation function. The dynamic characteristics of these roads are similar, but the statistical characteristics in chart 1901 are very different from the statistical characteristics of charts 1902 and 1903. The chart 1901 shows a road having a so-called non-Gaussian (colored) stochastic process.

The statistical characteristics of the road signals produce different responses in the dynamic suspension system and as a result, require different control solution strategies.

FIGS. 17 and 18 illustrate the dynamic and thermodynamic response of the suspension system (plant) to the above-mentioned excitations. Curves 1701-1703 show the dynamic behaviour of the pitch angle β of the vehicle under the roads corresponding to charts 1901-1903 respectively. Curves 1711-1713 in FIG. 17 are phase plots showing β versus dβ/dt. Curves 1811-1813 in FIG. 18 are phase plots showing S versus dS/dt. The knowledge base, as a look-up table for the fuzzy controller 143, in this simulation was obtained using the Gaussian road signal shown in chart 1903, and then applied to the roads shown in charts 1901 and 1902.

The system responses from the roads with the same characteristics are similar, which means that the GA 131 has found a good solution for Gaussian-like signal shapes. However, the response obtained from the system on the non-Gaussian road (shown in chart 1901) is a completely different signal. For this non-Gaussian road, a different GA control strategy based on solutions from a different space of solutions is needed. The differences in the system responses are visible on the phase plots 1711-1713.

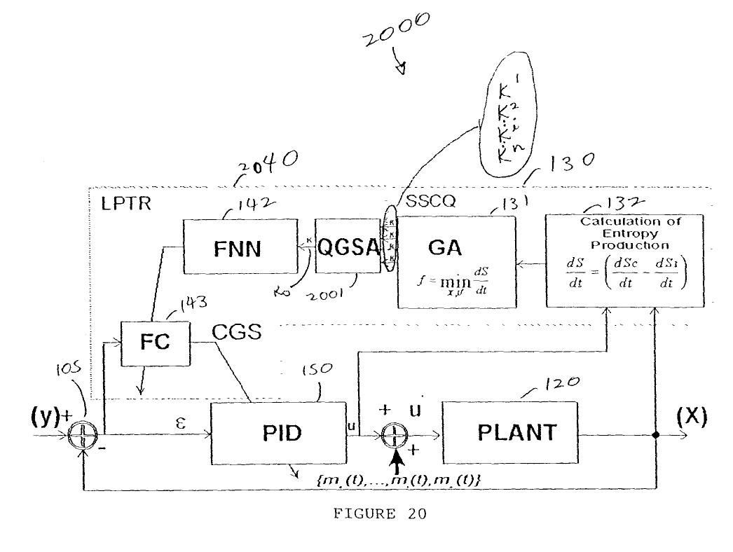

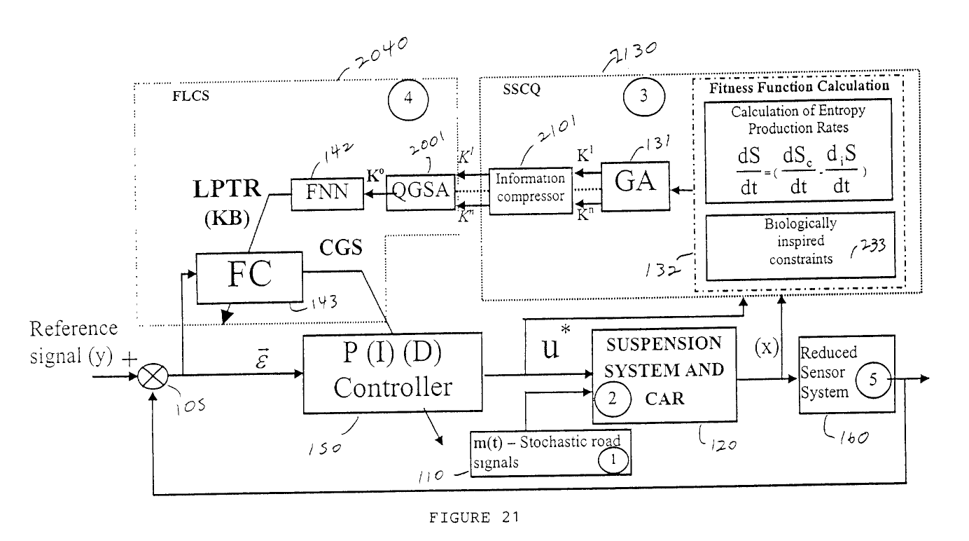

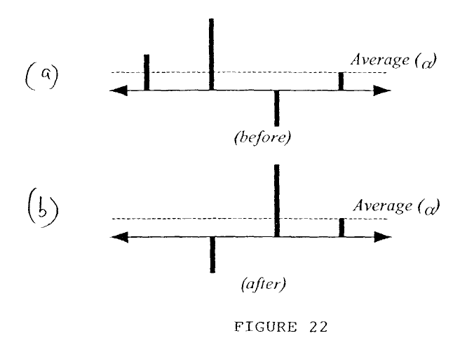

The GA 131 searches for a global optimum in a single solution space. It is desirable, however, to search for a global optimum in multiple solution spaces to find a “universal” global optimum. A quantum genetic search algorithm provides the ability to search multiple spaces simultaneously (as described below) to find a universal optimum. FIGS. 20 and 21 show a modified version of the intelligent control systems (from FIGS. 1 and 2 respectively) wherein a Quantum Genetic Search Algorithm (QGSA) 2001 is interposed between the GA 131 and the FNN 142. The QGSA searches several solution spaces, simultaneously, in order to find a universal optimum, that is, a solution that is optimal considering all solution spaces. In FIG. 20, K₁, . . . Kₙ solutions (teaching signa|s [symbol] from the GA 131 are provided to inputs of the QGSA 2001, and a universal output solution (teaching signal) K₀ from the QGSA 2001 is provided to the FNN 142. In FIG. 21, the K₁ . . . Kₙ solutions from the GA 131 are provided to inputs of an information compressor 2101 and compressed solutions K₁ . . . Kₙ are provided to the QGSA 2001. The information compressor 2101 performs information filtering similar to that provided by the information filter 241.

The QGSA 2001 uses a quantum search algorithm. The Quantum search algorithm is a global random searching algorithms based on the laws of quantum mechanics and quantum effects. In the quantum search, the state of a system is represented by a finite complex linear superposition of classical basis states. A quantum gate, made of the composition of three elementary unitary operators, manipulates the initial quantum state|input [symbol] in such a way that a measurement of the final state of the system yields the correct output. The quantum search begins by transforming an initial basis state into a complex linear combination of basis states. The three main operators used in quantum search algorithms are called superposition, entanglement and interference operators (these operators are described in more detail in Appendix I attached hereto). A unitary operator encoding a classical function is then applied to the superposed state introducing non-local quantum correlation (entanglement) among the different qubits. An operator such as Quantum Fourier Transform (interference) acts in order to assure that, when a measurement is performed, the outcome is correct. Depending on the output, the quantum search procedure is repeated several times and the computation can be completed with some classical post-processing.

Superposition is fundamental in quantum mechanics and when applied to composite quantum systems it leads to the notion of entanglement. Interference on the other hand is usually used for classical mechanics. The superposition, entanglement and interference operators are used as three separate terms because they are standard components of a quantum gate.

A quantum computation involves preparing an initial superposition of states, operating on those states with a series of unitary matrices, and then making a measurement to obtain a definite final answer. The amplitudes of the states determine the probability that this final measurement produced a desired result. Using this as a search method, one can obtain each final state with some probability, and some of these states will be solutions. Thus, this is a probabilistic computation in which at each trial produces some probability of a solution, but no guarantee of a solution. This means the quantum search method is incomplete in that it can find a solution if one exists but can never guarantee a solution in one does not exist.

A useful conceptual view is provided by the path integral approach to quantum mechanics. In this view, the final amplitude of a given state is obtained by summing over all possible paths that produce that state, weighted by suitable amplitudes. In this way, various possibilities involved in a computation can interfere with each other, either constructively or destructively. This differs from the classical combination of probabilities of different ways to reach the same outcome, where the probabilities are simply added, giving no possibility for interference.

Consider, for example, a computation that depends on a single choice. The possible choice can be represented as an input bit with value 1 or −1. Assume that the result of the computation from a choice is also a single value, 1 or −1, representing, for example, some consequence of the choice. If one is interested in whether the two results are the same, classically this requires evaluating each choice separately. With a quantum computation one can instead prepare a superposition of the inputs,

$$\frac{1}{\sqrt{2}} ( \vert 0 ⟩ + \vert 1 ⟩ )$$

using the matrix H, then do the evaluation to give

$$\frac{1}{\sqrt{2}} ( {f}_{0} \vert 0 ⟩ + {f}_{1} \vert 1 ⟩ )$$

where fᵢ is the evaluation from input i, and equals 1 or −1. Finally one can combine the states again using

$$H \to U ( - \frac{π}{4} )$$

to obtain

$$\frac{1}{2} ( ( {f}_{0} + {f}_{1} ) \vert 0 ⟩ + ( {f}_{0} - {f}_{1} ) \vert 1 ⟩ ) .$$

Now if both choices give the same value for f, this result is ±|0 [symbol] so the final measurement process will give 0. Conversely, if the values are different, this resulting state is ±|1 [symbol] and the measurement gives 1. Thus, with the effort required to compute one value classically, it is possible to determine definitely whether the two evaluations are the same or different.

In this example, it was assumed that one could arrange to be in a single state at the end of the computation and hence have no probability for obtaining the wrong answer by the measurement. This result is viewed as summing over the different paths; e.g., the final amplitude for |0 [symbol] , was the sum over the paths |0 [symbol] →|0 [symbol] →|0 [symbol] and |0 [symbol] →|1 [symbol] →|0 [symbol] . The various formulations of quantum mechanics, involving operators, matrices or sums over paths are equivalent but suggest different thought processes when constructing possible quantum algorithms.

One example of a robust quantum search algorithm is the algorithm due to Grover. In each iteration of the Grover's quantum search algorithm, there are two steps: 1) a selective inversion of the amplitude of the marked state, which is a phase rotation of π of the marked state; 2) an inversion about the average of the amplitudes of all basis states (both of these operations are described in Appendix 2). The second step can be realized by two Walsh-Hadamard transformations and a rotation of π on all basis states different from |0 [symbol] .

The success of Grover's quantum search algorithm and its multi-object generalization is attributable to two main sources: 1) the notion of amplitude amplification; and 2) the reduction to invariant sub-spaces of low dimension for the unitary operators involved. Indeed, the second of these can be said to be responsible for the first: A proper geometrical formulation of the process shows that the algorithm operates primarily within a two-dimensional real sub-space of the Hilbert space of quantum states. Since the state vectors are normalized, the state is confined to a one-dimensional unit circle and (if moved at all) initially has nowhere to go except toward the place where the amplitude for the sought-for state is maximized. This accounts for the robustness of Grover's quantum search algorithm—that is, the fact that Grover's original choice of initial state and of the Walsh-Hadamard transformation can be replaced by (almost) any initial state and (almost) any unitary transformation.

In general form, Grover's quantum search algorithm is a series of rotations in an SU(2) space spanned by |x₀), the marked state and

$$\vert s ⟩ = \frac{1}{\sqrt{N - 1}} {\sum }_{x \neq {x}_{0}}^{} \vert x ⟩ .$$

Each iteration rotates the state vector of the quantum computer system an angle

$$ψ = 2 arcsin \frac{1}{\sqrt{N}}$$

towards the |x₀ [symbol] basis of the SU(2) space. The Walsh-Hadamard transformation can be replaced by almost any unitary transformation. The inversion of the amplitudes can be rotated by arbitrary phases. If one rotates the phases of the states arbitrarily, the resulting transformation is still a rotation of the state vector of the quantum computer towards the |x₀ [symbol] basis in the SU(2) space, but the angle of rotation is smaller than ψ. For reasons of efficiency, the phase rotation π is generally used. The inversion of the amplitude of the marked state in step 1 is replaced by a rotation through an angle between 0 and π to produce a smaller angle of SU(2) rotation towards the end of a quantum search calculation so that the amplitude of the marked state in the computer system state vector is exactly 1. When the rotation of the phase of the marked state is not π, one cannot simply construct a quantum search algorithm. In vicinity of π, the Grover's algorithm still works, though the height of the norm cannot reach 1. But it can still reach a relatively large value. This shows that Grover's algorithm is robust with respect of phase rotation to π. Grover's quantum search algorithm has good tolerance for a phase rotating angle near π. In other words, a small deviation from π will not destroy the algorithm. This is useful, as an imperfect gate operation may lead to a phase rotation not exactly equal to π.

From the mathematical point of view, a large class of problems can be specified as search problems of the form “find some x such that P(x) is true” for some predicate P. Such problems range from sorting to graph coloring to database search, etc. For example:

Given an ne lement vector A, find a permutation π on [1, . . . , n] such that ∀1≦i<n:A_{π(i)}<A_{π(i+1)}.

Given a graph (V, E) with n vertices V and e edges E⊂V×V and a set of k colors C, find a mapping c from V to C such that ∀(vν₁, ν₂)εE:c(ν₁) ≠c(ν₂).

For certain types of problems, where there is some problem structure that can be exploited, efficient algorithms are known. Many search problems, such as constraint satisfaction problems involving graph colorability, or searching an alphabetized list, have structured search spaces in which full solutions can be built from smaller partial solutions. But in the general case with no structure, randomly testing predicates P(xᵢ) one by one is the best that can be done classically. For a search space of size N, the general unstructured search problem is of complexity O(N), once the time it takes to test the predicate P is factored out. On a quantum computer, however, the unstructured search problem can be solved with bounded probability within O(\sqrt{N}) time. Thus Grover's search algorithm is more efficient than any algorithm that could run on a classical computer. Grover's quantum search algorithm searches a completely unstructured solution space. While Grover's algorithm is optimal, for completely unstructured searches, most search problems involve searching a structured solution space.

Quantum algorithms that use the problem structure in a similar way to classical heuristic search algorithms can be useful. One problem with this approach is that the introduction of problem structure often makes the algorithms complicated enough that it is hard to determine the probability that a single iteration of the algorithm will give a correct answer. Therefore it is difficult to know how efficient structured quantum algorithms are. Classically, the efficiency of heuristic algorithms is estimated by empirically testing the algorithm. But, as there is an exponential slow down when simulating a quantum computer on a classical one, empirical testing of quantum algorithms is currently infeasible except in small cases.

Grover's algorithm searches an unstructured list of size N. Let n be such that 2ⁿ≧N. Assume that predicate P on n-bit values x is implemented by a quantum gate Uₚ:

Uₚ:|x,0 [symbol] →x, P(x))

where “True” is encoded as 1.

The first step is the standard step for quantum computing: Compute P for all possible inputs x₁ by applying Uₚ to a register containing the superposition

$$\frac{1}{\sqrt{{2}^{n}}} {\sum }_{x = 0}^{n - 1} \vert x ⟩$$

of all 2ⁿ possible inputs x together with a register set to 0, such that

$${U}_{p} \text{:} \frac{1}{\sqrt{{2}^{n}}} {\sum }_{x = 0}^{n - 1} \vert x , 0 ⟩ -> \frac{1}{\sqrt{{2}^{n}}} {\sum }_{x = 0}^{n - 1} \vert x , P ( x ) ⟩ .$$

For any x₀ such that P(x₀) is true, |x₀, 1 [symbol] will be part of the superposition

$$\frac{1}{\sqrt{{2}^{n}}} {\sum }_{x = 0}^{n - 1} \vert x , P ( x ) ⟩ ,$$

but since its amplitude is

$$\frac{1}{\sqrt{{2}^{n}}} ,$$

the probability that a measurement of the 1 ‘-’ superposition produces x₀ is only 2⁻ⁿ. It is useful to change the quantum state

$$\frac{1}{\sqrt{{2}^{n}}} {\sum }_{x = 0}^{n - 1} \vert x , P ( x ) ⟩$$

so as to greatly increase the amplitude of vectors |x, 0) for which the predicate is false.

Once such a transformation of the quantum state has been performed, one can simply measure the last qubit of the quantum state, which represents P(x). Because of the amplitude change, there is a high probability that the result will be 1. If this is the case, the measurement has projected the state

$$\frac{1}{\sqrt{{2}^{n}}} {\sum }_{x = 0}^{n - 1} \vert x , P ( x ) ⟩$$

onto the subspace

$$\frac{1}{\sqrt{{2}^{k}}} {\sum }_{x = 0}^{k} \vert {x}_{i} , 1 ⟩$$

where k is the number of solutions. Further, measurement of the remaining bits will provide one of these solutions. If the measurement of qubit P(x) yields 0, then the whole process is started over and the superposition

$$\frac{1}{\sqrt{{2}^{n}}} {\sum }_{x = 0}^{n - 1} \vert x , P ( x ) ⟩$$

is computed again.

Grover's algorithm includes of the following steps:

1. Prepare a register containing a superposition of all of the possible values xᵢε[0 . . . 2ⁿ⁻¹];

2. Compute P(xᵢ) on this register;

3. Change the amplitude aⱼ to −aⱼ for xⱼ such that P(xⱼ)=1. An efficient algorithm for changing selected signs is described in Appendix 2. A plot of the amplitudes after this step is shown in FIG. 22A (before inversion) and 22B (after inversion).

4. Apply inversion about the average to increase the amplitude of xⱼ with P(xⱼ)=1. A quantum algorithm to efficiently perform inversion about the average is given in Appendix 2. The resulting amplitudes look as shown, where the amplitude of all the xᵢ's with P(xᵢ)=0 have been diminished imperceptibly.

5. Repeat steps 2 through

$$4 \frac{π}{4} \sqrt{{2}^{n}}$$

times.

6. Read the result.

Grover's algorithm is optimal up to a constant factor, no quantum algorithm can perform an unstructured search faster. If there is only a single x₀, such that P(x₀) is true, then after

$$\frac{π}{8} \sqrt{{2}^{n}}$$

iterations of steps 2 through 4 the failure rate, is 0.5. After iterating

$$\frac{π}{4} \sqrt{{2}^{n}}$$

times the failure rate drops to 2⁻ⁿ. Additional iterations will increase the failure rate. For example, after

$$\frac{π}{2} \sqrt{{2}^{n}}$$

iterations the failure rate is close to 1.

There are many classical algorithms in which a procedure is repeated over and over again for ever better results. Repeating quantum procedures may improve results for a while, but after a sufficient number of repetitions the results will get worse again. Quantum procedures are unitary transformations, which are rotations of complex space, and thus while a repeated applications of a quantum transform may rotate the state closer and closer to the desired state for a while, eventually it will rotate past the desired state to get farther and farther from the desired state. Thus, to obtain useful results from a repeated application of a quantum transformation, it is useful to know when to stop.

The loop in steps 3-5 above is the heart of the Grover search algorithm. Each iteration of this loop increases the amplitude in the desired state by

$$O ( \frac{1}{\sqrt{N}} ) ,$$

as a result in O(\sqrt{N}) repetitions of the loop, the amplitude and hence the probability of being in the desired state reach O(1). To show that the amplitude increases by

$$O ( \frac{1}{\sqrt{N}} )$$

in each repetition, it is first useful show that the diffusion transform, D, can be interpreted as an inversion about an average. A simple inversion is a phase rotation operation, and it is unitary. The inversion about average operation (as developed Appendix 2) is also a unitary operation and is equivalent to the diffusion transform D as used in steps 3-5 of the above algorithm.

Let α denote the average amplitude over all state, i.e., if αᵢ be the amplitude in the i-th state, then the average is

$$\frac{1}{N} {\sum }_{i = 1}^{N} {α}_{i} .$$

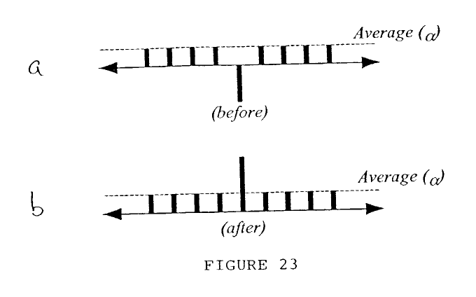

As a result of the operation D, the amplitude in each state increases (decreases) so that after this operation it is as much below (above) α, as it was above (below) α before the operation (see FIG. 23). The diffusion transform D is defined as follows:

$${D}_{ij} = \frac{2}{N} , i \neq j and {D}_{u} = - 1 + \frac{2}{N} .$$

D can be represented in the form D=−I+2P, where operator I is the identity matrix and P is a projection matrix with Pᵢⱼ=1/N for all i, j. The following properties of P are easily verified: first that P²=P; and second, that P acting on any vector \overline{v} gives a vector each of whose components is equal to the average of all components.

In order to see that D is the inversion about average, consider what happens when D acts on an arbitrary vector \overline{v}. Expressing D as −I+2P, it follows that:

D\overline{v}=(−I+2P)\overline{v}=−\overline{v}+2P\overline{v}.

By the discussion above, each component of the vector P\vec{v} is A, where A is the average of all components of the vector \overline{v}. Therefore, the i-th component of the vector D\overline{v} is given by (−vᵢ+2A) which can be written as [A+(A−vᵢ)], which is precisely the inversion about an average.

Next consider the situation, shown in FIG. 23, when this operator is applied to a vector with each of the components, except one, having an amplitude equal to C/\sqrt{N} a where C list between ½ and 1. The one component that is different has an amplitude of (−\sqrt{1−C²}). The average A of all components is approximately equal to C/\sqrt{N}. Since each of the (N−1) components is approximately equal to the average, they do not change significantly as a result of the inversion about average. The one component that was negative now becomes positive and its magnitude increases by 2C/\sqrt{N}.

The quantum search algorithm can also be expressed as follows: Given a function f(xᵢ) on a set χ of input states such that

$$f ( {x}_{i} ) = \{ \begin{matrix}1 , & if {x}_{i} is a target element \\ 0 , & otherwise\end{matrix} \qquad ( 8.1 )$$

find a target element by using the least number of calls to the function f(xᵢ). In general, there might be r target elements, in which case any one will suffice as the answer.

Grover's algorithm can be generalized as follows. First, form a Hilbert space with an orthonormal basis element for each input xᵢεχ. Without loss of generality, write the target states |tᵢ [symbol] and the non-target states as |Iᵢ [symbol] . The basis of input eigenstates is called the measurement basis. Let N=|χ| be the cardinality of χ. The function call is to be implemented by a unitary operator that acts as follows:

|xᵢ [symbol] |y [symbol] →|xᵢ [symbol] |y⊕f(xⁱ) [symbol] (8.2)

where |y [symbol] is either |0 [symbol] or |1 [symbol] . By acting on

$$( {\sum }_{i = 1}^{N - r} {l}_{i} \vert {l}_{i} ⟩ + {\sum }_{j = 1}^{r} {k}_{j} \vert {t}_{j} ⟩ ) \frac{1}{\sqrt{2}} ( \vert 0 ⟩ - \vert 1 ⟩ ) \qquad ( 8.3 )$$

with this operator construct the state

$$( {\sum }_{i = 1}^{N - r} {l}_{i} \vert {l}_{i} ⟩ - {\sum }_{j = 1}^{r} {k}_{j} \vert {t}_{j} ⟩ ) \frac{1}{\sqrt{2}} ( \vert 0 ⟩ - \vert 1 ⟩ ) \qquad ( 8.4 )$$

where the r measurement basis states |tᵢ [symbol] are the target states and N−r measurement basis states |lᵢ [symbol] are the non-target states. Disregarding the state

$$\frac{1}{\sqrt{2}} ( \vert 0 ⟩ - \vert 1 ⟩ ) ,$$

then the phase of the target states has been inverted. Hence, the unitary operator above is equivalent to the operator

$$1 - 2 {\sum }_{i = 1}^{r} \vert {t}_{i} ⟩ ⟨ {t}_{i} \vert \qquad ( 8.5 )$$

(It is not necessary to know what the target states are a priori.) Next, construct the operator Q defined as

$$Q = ( 2 \vert a ⟩ ⟨ a \vert - 1 ) ( 1 - 2 {\sum }_{i = 1}^{r} \vert {t}_{i} ⟩ ⟨ {t}_{i} \vert ) \qquad ( 8.6 )$$

Where |a [symbol] can be thought of as the averaging state. Different choices of |a [symbol] give rise to different unitary operators for performing amplitude amplification. In the original Grover algorithm, the state |a [symbol] was chosen to be

$$\vert a ⟩ = \frac{1}{\sqrt{\vert χ \vert}} {\sum }_{x ∈ χ} \vert x ⟩ \qquad ( 8.7 )$$

and was obtained by applying the Walsh-Hadamard operator, U, to a starting eigenstate |s [symbol] , i.e., |a [symbol] =U|s [symbol] . Hence, the operation (2|a [symbol] [symbol] a|−1), called inversion about the average, is equivalent to −UIₛU⁺ with U being the Walsh-Hadamard operator and Iₛ being 1−2|s [symbol] [symbol] s|.

By knowing more about the structure of the problem one can choose other vectors |a [symbol] that will allow finding a target state faster.

Fortunately, in order to determine what action the operator Q performs, it is sufficient to focus on a two-dimensional subspace. The basis vectors of this subspace can be written as

$$\begin{matrix}\vert t ⟩ = \frac{1}{v} {\sum }_{i = 1}^{r} ⟨ {t}_{i} \vert a ⟩ \vert {t}_{i} ⟩ \\ \vert {a}^{′} ⟩ = \frac{1}{\sqrt{1 - {v}^{2}}} ( \vert a ⟩ - v \vert t ⟩ )\end{matrix} , {v}^{2} = {\sum }_{i = 1}^{r} \vert {⟨ {t}_{i} \vert a ⟩ \vert}^{2} \qquad ( 8.8 )$$

It is observed that |t [symbol] is the normalized projection of |a [symbol] onto the space of target states and |a′ [symbol] is the normalized projection of |a [symbol] onto the space orthogonal to |t [symbol] .

The rest of the Hilbert space (i.e., the space orthogonal to |t [symbol] and |a′ [symbol] ) can be broken up into the space of target states (S_{T}) and the space of non-target states (S_{L}). Q can be written as

Q=cosφ(|t [symbol] [symbol] t|+|a′ [symbol] [symbol] a′|)+sinφ(|t [symbol] −|a′ [symbol] [symbol] t|)+I_{T}−I_{L}, φ≡cos⁻¹[1−2v²] (8.9)

where I_{T} and I_{L} are the identity operators on (S_{T}) and (S_{L}) respectively. From this, it is clear that Q is a rotation matrix on |a′ [symbol] and |t [symbol] and Q acts trivially on the rest of the space.

An arbitrary starting superposition |s [symbol] for the algorithm can be written as

|s [symbol] =α| [symbol] +βe^{ib}|a′ [symbol] +|φₜ [symbol] +|φ_{I} [symbol] (8.10)

where the states |φₜ [symbol] and |φₗ [symbol] (which have a norm less than one if the state |s [symbol] is to be properly normalized overall) are the components of |s [symbol] in (S_{T}) and (S_{L}) respectively. Also, α, β and b are positive real numbers. After n applications of Q on an arbitrary starting superposition |s [symbol] one obtains

Qⁿ|s [symbol] =[α cos(nφ)+βe^{ib} sin(nφ)]|t [symbol] +[βe^{ib} cos(nφ)+α sin(nφ)]|a′ [symbol] +|φₗ [symbol] +(−1)ⁿ|φₗ [symbol] (8.11)

Measuring this state provides the probability of success (i.e., measuring a target state) as given by two terms.

The first term is the magnitude squared of Qⁿ|s [symbol] in the space S_{T}. This magnitude is (φₜ|φₜ [symbol] and is unchanged by Q.

The value g(n) is the magnitude squared of the coefficient of |t [symbol] , which is given by

$$\begin{matrix}\begin{matrix}g ( n ) ≡ {\vert ⟨ t \vert {Q}^{n} \vert s ⟩ \vert}^{2} \\ = {\vert α cos ( n φ ) + β {ⅇ}^{ⅈ b} sin ( n φ ) \vert}^{2} \\ = \frac{{α}^{2} + {β}^{2}}{2} + \frac{{α}^{2} - {β}^{2}}{2} cos ( 2 n φ ) + α β cos b sin ( 2 n φ ) \\ = \frac{{α}^{2} + {β}^{2}}{2} + \frac{1}{2} [ {α}^{2} + {β}^{2} {ⅇ}^{2 ⅈ b} ] cos ( 2 n φ + ψ ) \end{matrix} & ( 8.12 )\end{matrix}$$

where

$$ψ ≡ {cos}^{- 1} [ \frac{{β}^{2} - {α}^{2}}{{α}^{2} + {β}^{2} {ⅇ}^{2 ⅈ b}} ] .$$

This is the term that is affected by Q and is the term to be maximized. The total probability of success after n iterations of Q acting on |s [symbol] is

p(n, r, N)=(φₜ|φₜ [symbol] +g(n) (8.13)

Assuming that n is continuous (an assumption that is justified below) the maxima of g(n), and hence the maxima of the probability of success of Grover's algorithm, are given by the following.

$${n}_{j} = \frac{1}{2 φ} ( - ψ + 2 π j ) , j = 0 , 1 , 2 … \qquad ( 8.14 )$$

The value of g(n) at these maxima is given by

$$g ( {n}_{j} ) = \frac{{α}^{2} + {β}^{2}}{2} + \frac{1}{2} [ {α}^{2} + {β}^{2} {ⅇ}^{2 ⅈ b} ] \qquad ( 8.15 )$$

In practice, the optimal n must be an integer and typically the nⱼ's are not integers. However, since g(n) can be written as

g(nⱼ±δ)=g(nⱼ)−φ²[α²+β²e^{2ib}]δ²+O(δ₄) (8.16)

around nⱼ and most interesting problems will have v<<1 and hence φ≅2v<<1, simply rounding nⱼ to the nearest integer will not significantly change the final probability of success. So,

$$p ( {n}_{max} , r , N ) = \frac{{α}^{2} + {β}^{2}}{2} + \frac{1}{2} [ {α}^{2} + {β}^{2} {ⅇ}^{2 ⅈ b} ] + ⟨ {φ}_{t} \vert {φ}_{t} ⟩ - O ( {v}^{2} ) \qquad ( 8.17 )$$

is the probability of measuring a target state after nₘₐₓ=nⱼ applications of Q.

Grover's algorithm provides for searching a single element in an unsorted database (DB). The above description is presented in a way that makes possible the generalization of the algorithm to perform multi-object search in an unstructured DB.

The Grover's quantum search algorithm was developed for searching a single element in an unsorted database containing N>>1 items and treated the following abstract problem: given a Boolean function f(w)=1, w=1, . . . , N, which is known to be zero for all w except at a single point, say at w=a, where f(a)=1; find the value a. The function can be treated as “oracle” or “black box” wherein all that is known about it is its output for any input. On a classical computer it is necessary to evaluate the function

$$\frac{N + 1}{2}$$

times on average to find the answer to this problem. In contrast, Grover's quantum search algorithm finds a solution in O(\sqrt{N}) steps.

The quantum-mechanical statement of the above search problem is: given an orthogonal basis |w [symbol] :w=1, 2, . . . , N; single out the basis element |a [symbol] for which f(a)=1. Each |w [symbol] is to be an eigenstate of the qubits making up the quantum computing. If N=2ⁿ, then n qubits will be needed. At T=0, prepare the state of the system |ψ [symbol] in a superposition of the state {|w [symbol] }, each with the same probability:

$$\vert ψ ⟩ = \frac{1}{\sqrt{N}} {\sum }_{1}^{N} \vert w ⟩ ≡ \vert s ⟩ .$$

By the Graham-Schmidt construction, extend |a [symbol] to an orthonormal basis for the sub-space spanned by |a [symbol] and |s [symbol] . That is, introduce a normalized vector |r [symbol] orthogonal to |a [symbol] ,

$$\vert r ⟩ = \frac{1}{\sqrt{N - 1}} {\sum }_{w \neq a} \vert w ⟩ ,$$

and find that the initial state has the representation

$$\vert s ⟩ = \sqrt{\frac{N - 1}{N}} \vert r ⟩ + \frac{1}{\sqrt{N}} \vert a ⟩ .$$

Following Grover's quantum search algorithm, now define the unitary operator of inversion about the average, Iₛ=I−2|s [symbol] [symbol] |.

The only action of this operator is to flip the sign of the state |s [symbol] ; that is, Iₛ|s [symbol] =−|s [symbol] but Iₛ|v [symbol] =|v [symbol] if [symbol] s|v [symbol] =0.

Iₛ in this case is written as

$${I}_{s} = - ( 1 - \frac{2}{N} ) [ \vert r ⟩ ⟨ r \vert - \vert a ⟩ ⟨ a \vert ] - 2 \frac{\sqrt{N - 1}}{N} [ \vert r ⟩ ⟨ a \vert + \vert a ⟩ ⟨ r \vert ] \qquad ( 8.18 )$$

or, with respect to the orthonormal basis, the operator (8.18) can be represented by the orthogonal real unitary matrix

$$( \begin{matrix}1 - \frac{2}{N} & - 2 \frac{\sqrt{N - 1}}{N} \\ - 2 \frac{\sqrt{N - 1}}{N} & - ( 1 - \frac{2}{N} )\end{matrix} ) .$$

Similarly, define the operator Iₐ=I−2|a [symbol] [symbol] a| which satisfies Iₐ|a [symbol] =−|a [symbol] . In terms of the oracle function f,

Iₐ|w [symbol] =(−1)^{f(w)}|w

[symbol]

for each |w [symbol] in the original basis for the full state space of the quantum computing.

Therefore, to execute the operation Iₐ one does not need to know a; one only needs to know f. And conversely, being able to execute Iₐ does not mean that one can immediately determine a; √N steps will be needed.

A simple “Grover's iteration” is the unitary operator U≅−IₛIₐ. This product can be calculated easily in either the bra-ket or matrix formalism. In particular, for transition element (a|U|s)

$$\begin{matrix}⟨ a \vert {U}^{m} \vert s ⟩ = ⟨ a \vert [ ( 1 - \frac{2}{N} ) I + 2 \frac{\sqrt{N - 1}}{N} ( \vert a ⟩ ⟨ r \vert - \vert r ⟩ ⟨ a \vert ) ] \vert s ⟩ \\ = ( 1 - \frac{2}{N} ) \frac{1}{\sqrt{N}} + 2 ( 1 - \frac{1}{N} ) \frac{1}{\sqrt{N}} \\ = \frac{1}{\sqrt{N}} + \frac{2}{\sqrt{N}} + O ( {N}^{ - \frac{3}{2}} )\end{matrix}$$

The fact that the matrix element (a|U|s) is nonzero can be used to reinforce the probability amplitude of the unknown state |a [symbol] . Using U as a unitary search operation, then after m>>1 trials the value [symbol] a|U^{m}|s [symbol] can be evaluated as follows:

$$\begin{matrix}⟨ a \vert {U}^{m} \vert s ⟩ = [ 1 \; 0 ] {( \begin{matrix}1 - \frac{2}{N} & - 2 \frac{\sqrt{N - 1}}{N} \\ - 2 \frac{\sqrt{N - 1}}{N} & - ( 1 - \frac{2}{N} )\end{matrix} )}^{m} ( \frac{\frac{1}{\sqrt{N}}}{\sqrt{\frac{N - 1}{N}}} ) \\ = [ 1 \; 0 ] {( \begin{matrix}cos θ & sin θ \\ - sin θ & cos θ\end{matrix} )}^{m} ( \frac{\frac{1}{\sqrt{N}}}{\sqrt{\frac{N - 1}{N}}} ) , θ = {sin}^{- 1} 2 \frac{\sqrt{N - 1}}{N} \\ = [ 1 \; 0 ] ( \begin{matrix}cos m θ & sin m θ \\ - sin m θ & cos m θ\end{matrix} ) ( \frac{\frac{1}{\sqrt{N}}}{\sqrt{\frac{N - 1}{N}}} ) \\ = \frac{1}{\sqrt{N}} cos m θ + \sqrt{\frac{N - 1}{N}} sin m θ or \\ ⟨ a \vert {U}^{m} \vert s ⟩ = cos ( m θ - α ) ; α ≡ {cos}^{- 1} \frac{1}{\sqrt{N}}\end{matrix}$$

Setting | [symbol] a|U^{m}|s [symbol] |²=|cos(mθ−α)|²=1, one can maximize the amplitude of U^{m}|s [symbol] in the state |a [symbol] ; thus

$$\begin{matrix}m θ - α & = 0 \\ m & = \frac{α}{θ}\end{matrix}$$

(if no integer satisfies this equation exactly, take the closest one.)

When N is large,

$$θ \approx \frac{2}{\sqrt{N}} , α \approx \frac{π}{2}$$

and obtain

$$m \approx \frac{α}{θ} \approx \frac{π}{2} / ( \frac{2}{\sqrt{N}} ) = \frac{π}{4} \sqrt{N} . \qquad ( 8.19 )$$

Therefore, after m=O(\sqrt{N}) trials, the state |a [symbol] will be projected out, which is precisely Grover's result. By observing the qubits, a is determined. By constructive interference, it is possible to construct |a [symbol] . Since m only approximately satisfies (8.19), there is a small chance of getting a “bad” a. But, because evaluating f (a) is easy, in that case one will recognize the mistake and start over.

An unstructured search problem, in the case when the initial state is unknown and arbitrary entangled is the most general situation one might expect to have when working with subroutines involving quantum search or counting of solutions in a larger quantum computation. This situation is typical in the case of KB design of robust fuzzy controllers in intelligent control suspension system for different types of roads and connected with partial sorted data after GA optimization and an FNN learning processes. In particular, it is useful to derive an iteration formula for the action of the original Grover's operator and find, similar to the case of an initial state with unknown amplitudes, that the final state is a periodic function of the number of “good” items and can be expressed in terms of first and second order moments of the initial amplitude distribution of states alone.

Considered the problem to find a “good” file, represented as the state |g [symbol] , out of N files |a [symbol] ; a=0, . . . , N−1. The algorithm starts with the preparation of a flat superposition of all states |a [symbol] , i.e.

$$\vert {ψ}_{0} ⟩ = \frac{1}{\sqrt{N}} {\sum }_{a = 0}^{N - 1} \vert a ⟩ \qquad ( 8.20 )$$

and assumes that there is an oracle which evaluates the function H(a), such that H(g) 1 for the “good” state |g [symbol] , and H(g)=0 for the “bad” states |b [symbol] (i.e., the remaining states in the set of all the a's). The unitary transformation for the “search” of |g [symbol] is then defined by G_{H}=−WS_{O}WS_{H}, where the Walsh-Hadamard transform W is defined as

$$W \vert a ⟩ ≡ \frac{1}{\sqrt{N}} {\sum }_{c = 0}^{N - 1} {( - 1 )}^{a c} \vert c ⟩$$

(with

$$a \cdot c ≡ {\sum }_{i} {a}_{i} {c}_{i} mod 2 ,$$

aᵢ(cᵢ.) being the binary digits of a(c), S_{O}≅I−2|0 [symbol] [symbol] 0| and

$${S}_{H} ≡ I - 2 {\sum }_{g} \vert g ⟩ ⟨ g \vert ) .$$

In fact S_{H} can be implemented as an |a [symbol] —“controlled” unitary transformation by tensoring |ψ₀ [symbol] with an extra ancillary qubit |e [symbol] ≅[|0 [symbol] −|1 [symbol] ]/\sqrt{2}, such that U_{H}|a [symbol] |e [symbol] ≅|a [symbol] |e+H(a)mod2).

Thus obtaining

$${U}_{H} \vert {ψ}_{0} ⟩ \to \frac{1}{\sqrt{N}} {\sum }_{a = 0}^{N - 1} \vert a ⟩ {( - 1 )}^{H ( a )} \vert e ⟩ .$$

Iterating G_{H}=Qⁿ for n≅O(\sqrt{N}) times on (8.26) then produces a state whose amplitude is peaked around the searched item |g [symbol] . Classically, it would take of the order of O(N) steps on the average to find the same element g, so that Grover's quantum method achieves a square root speed up compared to its classical analogue. Subsequently, Grover's algorithm has been extended to the case when there are t “good” items |g [symbol] to be searched and when the number of “good” items is not known. The number of steps required in these cases is of the order of O(\sqrt{N/t}), again a square root improvement with respect to the classical algorithms.

New algorithms with exponential speed-up in Appendix 5 are described.

The algorithms discussed above made the essential assumption that the starting state is to be prepared in the flat superposition form given by Equation (8.20). A first attempt to generalize such results occurs when the amplitudes of the initial superposition of states are arbitrary and unknown complex numbers. In particular, by exactly solving certain linear differential equations describing the evolution of the initial amplitudes, one can still express the optimal measurement time and the maximal probability of success in a closed and exact form which depends only on the averages and the variances of the initial amplitude distribution of states.

One of the main resources and ingredients of quantum computation lies, however, not only in the possibility of dealing with arbitrary complex superpositions of qubits, but in the massive exploitation of quantum entanglement. One cannot necessarily deal with the ansatz when the “good” state has a complicated, unknown structure by entanglements by directly and naively using Grover's algorithm. An important case may arise, for instance, when the computational qubits get nontrivially entangled with environment, and encoding/decoding techniques become necessary in order to prevent errors from occurring and spreading in the quantum computer calculations. Different approaches for solving these cases in Appendix 5 are discussed.

Consider, for example, if in the database search problem, one is given the initial superposition

$$\vert ψ ⟩ ≡ \frac{1}{\sqrt{N}} {\sum }_{a = 0}^{N - 1} \vert a ⟩ \vert f ( a ) ⟩ \qquad ( 8.21 )$$

where now the index a simply labels the files, while f(a) corresponds to the actual file content. In fact, one might know the desired states |g [symbol] , but ignore the function f (and, therefore, the file content f(g)), and thus want to extract the states|g [symbol] |f(g)) from the original superposition and eventually read (i.e. measure) or use f(g) only later in another quantum routine.

But, in Grover's algorithm, the application of any unitary transformation acting on the label states |a [symbol] would automatically affect also and nontrivially (e.g., producing complicated entangled states) on |f(a)), with f(a) unknown a priori. Grover's algorithm is generalized, for an arbitrary entangled initial state, by giving an exact formula for the n-th iteration of Grover's operator and comparing the results with those for the case of an initial superposition of states with arbitrary complex amplitudes.

The “good” (orthonormal) states to be found are defined, in number t, as |g [symbol] , the remaining, or “bad” states are defined as |b [symbol] , where, by definition,

$$\begin{matrix}\vert G ⟩ ≡ {\sum }_{g} \vert g ⟩ \vert f ( g ) ⟩ & \vert B ⟩ ≡ {\sum }_{b} \vert b ⟩ \vert f ( b ) ⟩ \\ \vert {G}_{1} ⟩ ≡ {\sum }_{g} \vert g ⟩ & \vert {B}_{1} ⟩ ≡ {\sum }_{b} \vert b ⟩ \\ \vert {G}_{2} ⟩ ≡ {\sum }_{g} \vert f ( g ) ⟩ & \vert {B}_{2} ⟩ ≡ {\sum }_{b} \vert f ( b ) ⟩\end{matrix} \qquad ( 8.22 )$$

Then study what is the effect of acting with Grover's unitary transformation G_{H}=−WS_{O}WS_{H} on the state |ψ [symbol] as defined in Equation (8.11). Using the simplifying notation (8.22), gives

$$\begin{matrix}\vert ψ ⟩ = \frac{1}{\sqrt{N}} [ \vert G ⟩ + \vert B ⟩ ] \\ {G}_{H} \vert ψ ⟩ = \frac{1}{\sqrt{N}} [ \vert G ⟩ + \vert B ⟩ - \frac{2}{N} ( \vert {G}_{1} ⟩ + \vert {B}_{1} ⟩ ) \vert {C}_{2}^{( 1 )} ⟩ ]\end{matrix} \qquad ( 8.23 )$$

where ≡|G₂ [symbol] −|B₂ [symbol] . By induction, the n-th iteration of G_{H}on |ψ [symbol] gives

$${G}_{H}^{n} \vert ψ ⟩ = \frac{1}{\sqrt{N}} [ \vert G ⟩ + {( - 1 )}^{n} \vert B ⟩ - \frac{2}{N} ( \vert {G}_{1} ⟩ \vert {X}_{2}^{( n )} ⟩ + \vert {B}_{1} ⟩ \vert {Y}_{2}^{( n )} ⟩ ) ] \qquad ( 8.24 )$$

where the states |X₂⁽ⁿ⁾ [symbol] and |Y₂⁽ⁿ⁾ [symbol] satisfy the following recurrence relations

$$\begin{matrix}\vert {X}_{2}^{( n )} ⟩ ≡ cos θ \vert {X}_{2}^{( n - 1 )} ⟩ + 2 {cos}^{2} θ \vert {Y}_{2}^{( n - 1 )} ⟩ + \vert {C}_{2}^{( n )} ⟩ \\ \vert {Y}_{2}^{( n )} ⟩ ≡ - 2 {sin}^{2} θ \vert {X}_{2}^{( n - 1 )} ⟩ + cos 2 θ \vert {Y}_{2}^{( n - 1 )} ⟩ + \vert {C}_{2}^{( n )} ⟩\end{matrix} \qquad ( 8.25 )$$

with |C₂⁽ⁿ⁾ [symbol] ≡|G₂ [symbol] +(−1)ⁿ|B₂ [symbol] and sin² θ=t/N, and are subject to the initial condition |X₂⁽¹⁾ [symbol] =|Y₂⁽¹⁾=.

Adopting a more compact matrix notation, i.e. writing \vec{Z}ₙ≡(Xₙ, Yₙ) and \vec{C}ₙ≡Cₙ(1, 1), substituting for |X₂⁽ⁿ⁾ [symbol] →Xₙ,|Y₂⁽ⁿ⁾ [symbol] →Yₙ and |C₂⁽ⁿ⁾ [symbol] →Cₙ and defining the matrices M≡cos 2θI+M₁ with M₁≡cos 2θσₓ+iσ_{y} the recurrence equations (8.25) subject to the initial condition X₁=Y₁=C₁ can be transformed into the simple matrix equation

\vec{Z}ₙ=M\vec{Z}ₙ₋₁+\vec{C}ₙ (8.26)

Equation (8.26) can be solved using standard techniques to give

$${\vec{Z}}_{n} = {M}^{n} [ {\sum }_{k = 0}^{[ ( N - 1 ) / 2 ]} {M}^{- ( 2 k + 1 )} {\vec{C}}_{1} + {\sum }_{k = 0}^{[ N / 2 ]} {M}^{- 2 k} {\vec{C}}_{2} ] \qquad ( 8.27 )$$

(with [k] being the integer part of k), and where the n-th powers of the matrices M and M⁻¹ are given by

$${M}^{\pm n} ≡ cos 2 n θ I \pm \frac{sin 2 n θ}{sin 2 θ} {M}_{1} \qquad ( 8.28 )$$

Inserting equation (8.28) into equation (8.27), one obtains

$${{Z}^{->}}_{n} = \frac{1}{sin 2 θ} \{ A + B \} , \\ where \\ A = sin [ \frac{N + 1}{2} ] 2 θ [ cos ( N - [ \frac{N + 1}{2} ] ) 2 θ \cdot I + \frac{sin ( N - [ \frac{N + 1}{2} ] ) 2 θ}{sin 2 θ} {M}_{1} ] {{C}^{->}}_{1} \\ B = sin [ \frac{N}{2} ] 2 θ [ cos ( N - [ \frac{N}{2} ] - 1 ) 2 θ \cdot I + \frac{sin ( N - [ \frac{N}{2} ] - 1 ) 2 θ}{sin 2 θ} {M}_{1} ] {{C}^{->}}_{2} \qquad ( 8.29 )$$

and, finally, from equation (8.24), the formula for the n-th iteration of G_{H} on the entangled state |ψ [symbol] reads

$${G}_{H}^{n} \vert Ψ ⟩ = \frac{1}{\sqrt{N}} [ \vert G ⟩ + {( - 1 )}^{n} \vert B ⟩ - \frac{2}{N} \frac{sin 2 n θ}{sin 2 θ} \{ \vert {G}_{1} ⟩ ( \frac{tan n θ}{tan θ} \vert {G}_{2} ⟩ - \vert {B}_{2} ⟩ ) + \vert {B}_{1} ⟩ D \} ] \qquad ( 8.30 )$$

where

D=(|G₂ [symbol] +(−1)ⁿ tan θ(tan nθ)⁽⁻¹^{ⁿ}|B₂ [symbol] )

Similar to the case of the original Grover's algorithm acting on an initial flat superposition of states, G_{H}ⁿ|ψ [symbol] is periodic in n with period π/θ, and a Fourier analysis can still be performed in order to find an estimate of θ (as shown below). Moreover, it is easy to check that for the case when |f(a) [symbol] =const, corresponding to a given flat and non-entangled initial superposition of states, one can recover the standard Grover's result, i.e.

G_{H}ⁿ|ψ [symbol] sin [(2n+1)θ]|ω [symbol] +cos[(2n+1)θ]|r [symbol] (8.31)

where |ω [symbol] ≡|G₁ [symbol] /\sqrt{t} and |r [symbol] ≡B₁ [symbol] /\sqrt{N−t}.

A general normalization is given by

$${\sum }_{a = 0}^{N - 1} {\vert ‖ a ⟩ ‖}^{2} = N , {\sum }_{a = 0}^{N - 1} {\vert ‖ f ( a ) ⟩ ‖}^{2} = {N}^{′} ,$$

and substituting for

|f′(g) [symbol] ≡f(g) [symbol] /\sqrt{N′}, |G′ [symbol] ≡|G [symbol] /\sqrt{N′}, |G₂′ [symbol] |G₂ [symbol] /\sqrt{N′} (and similarly, substituting everywhere g→b, for |f′(b) [symbol] , |B′ [symbol] and |B₂′ [symbol] ), one can write the initial normalized and entangled state as |ψ [symbol] ≡|G′ [symbol] +|B′ [symbol] , and rewrite equation (8.30) as

$${G}_{H}^{n} \vert Ψ ⟩ ≡ {\sum }_{g} \vert g ⟩ \vert {μ}_{g}^{( n )} ⟩ + {\sum }_{b} \vert b ⟩ \vert {μ}_{b}^{( n )} ⟩ \qquad ( 8.32 )$$

where the quantities

$$\vert {μ}_{g}^{( n )} ⟩ ≡ \vert {f}^{′} ( g ) ⟩ - \frac{sin 2 n θ}{sin 2 θ} [ tan n θsin2 θ \vert {\overline{G}}_{2}^{′ ( 0 )} ⟩ - 2 {cos}^{2} θ \vert {\overline{B}}_{2}^{′ ( 0 )} ⟩ ] \\ \vert {μ}_{b}^{( n )} ⟩ ≡ {( - 1 )}^{n} \vert {f}^{′} ( b ) ⟩ - \frac{sin 2 n θ}{sin 2 θ} [ 2 {sin}^{2} θ \vert {\overline{G}}_{2}^{′ ( 0 )} ⟩ + {( - 1 )}^{n} sin 2 {θ ( tan n θ )}^{{( - 1 )}^{n}} \vert {\overline{B}}_{2}^{′ ( 0 )} ⟩ ] \qquad ( 8.33 )$$

have been introduced and, by definition, |\overline{G}₂′⁽⁰⁾ [symbol] ≡γ_{G}|G₂′ [symbol] , |\overline{B}₂′⁽⁰⁾ [symbol] ≡γ_{B}|B₂′ [symbol] with γ_{G}≡1/t and γ_{B}≡1/(N−t). Further defining the averages and variances

$$\vert {\overline{G}}_{2}^{′ ( n )} ⟩ ≡ {γ}_{G} {\sum }_{g} \vert {μ}_{g}^{( n )} ⟩ \\ \vert Δ {G}_{2}^{′} ⟩ ≡ \vert {f}^{′} ( g ) ⟩ - {\overline{G}}_{2}^{′ ( 0 )} ⟩ {σ}_{G}^{2 ( n )} ≡ {\sum }_{g} \vert ‖ {μ}_{g}^{( n )} ⟩ - \vert {{\overline{G}}_{2}^{′ ( n )}}^{2} \qquad ( 8.34 )$$

and similarly for |\overline{B}₂′⁽ⁿ⁾ [symbol] , |ΔB₂′ [symbol] and σ_{B}²⁽ⁿ⁾ (after the substitution g→b), one can easily show that

$$\vert {\overline{G}}_{2}^{′ ( n )} ⟩ = cos 2 n θ \vert {\overline{G}}_{2}^{′ ( 0 )} ⟩ + cot θsin 2 n θ \vert {\overline{B}}_{2}^{′ ( 0 )} ⟩ \\ \vert {\overline{B}}_{2}^{′ ( n )} ⟩ = cos 2 n θ \vert {\overline{B}}_{2}^{′ ( 0 )} ⟩ - tan θ \vert {\overline{G}}_{2}^{′ ( 0 )} ⟩ \qquad ( 8.35 )$$

which, inserted into Eqs.(8.33), give

$$\vert {μ}_{g}^{( n )} ⟩ = \vert {\overline{G}}_{2}^{′ ( n )} ⟩ + \vert Δ {G}_{2}^{′} ⟩ \\ \vert {μ}_{b}^{( n )} ⟩ = \vert {\overline{B}}_{2}^{′ ( n )} ⟩ + {( - 1 )}^{n} \vert Δ {B}_{2}^{′} ⟩ \qquad ( 8.36 )$$

and, finally, from Eqs.(8.36) one finds the constants of the motion.

$${σ}_{G}^{2 ( n )} = {γ}_{G} {\sum }_{g} ⟨ Δ {G}_{2}^{′} \vert Δ {G}_{2}^{′} ⟩ ≡ {σ}_{G}^{2} \\ {σ}_{B}^{2 ( n )} = {γ}_{B} {\sum }_{g} ⟨ Δ {B}_{2}^{′} \vert Δ {B}_{2}^{′} ⟩ ≡ {σ}_{B}^{2} \qquad ( 8.37 )$$

Defining the quantities

$$\begin{matrix}\vert {F}_{\pm }^{( n )} ⟩ ≡ \vert {\overline{B}}_{2}^{ ′ ( n )} ⟩ \pm ⅈ tan θ \vert {\overline{G}}_{2}^{ ′ ( n )} ⟩ , \\ α ≡ \sqrt{\frac{⟨ {F}_{+}^{( 0 )} \vert {F}_{+}^{( 0 )} ⟩ + ⟨ {F}_{-}^{( 0 )} \vert {F}_{-}^{( 0 )} ⟩}{2}} \\ exp [ 2 ⅈ φ ] ≡ \frac{⟨ {F}_{+}^{( 0 )} \vert {F}_{+}^{( 0 )} ⟩}{2 {α}^{2}}\end{matrix} \qquad ( 8.38 )$$

and introducing the angle ω≡2θ, makes it possible to rewrite the norms of the states (8.37) as

$$\begin{matrix}⟨ {\overline{G}}_{2}^{ ′ ( n )} \vert {\overline{G}}_{2}^{ ′ ( n )} ⟩ = \frac{{α}^{2}}{2} {cot}^{2} \frac{ω}{2} [ 1 - cos 2 ( n ω - {φ}_{R} ) {ⅇ}^{- 2 {φ}_{I}} ] \\ ⟨ {\overline{B}}_{2}^{ ′ ( n )} \vert {\overline{B}}_{2}^{ ′ ( n )} ⟩ = \frac{{α}^{2}}{2} [ 1 + cos 2 ( n ω - {φ}_{R} ) {ⅇ}^{- 2 {φ}_{I}} ]\end{matrix} \qquad ( 8.39 )$$

where φ≡φ_{R}+iφ₁. Since, from the definition (8.37),

$${σ}_{G}^{2} = {γ}_{G} {\sum }_{g} ⟨ {μ}_{g}^{( n )} \vert {μ}_{g}^{( n )} ⟩ - ⟨ {\overline{G}}_{2}^{ ′ ( n )} \vert {\overline{G}}_{2}^{ ′ ( n )} ⟩ \qquad ( 8.40 )$$

and similarly for σ_{B}₂, the probability of picking up a “good” item after n iterations of G_{H} over the initial entangled state |\overline{ψ} [symbol] , defined as

$$P ( n ) ≡ {\sum }_{g} ⟨ {μ}_{g}^{( n )} \vert {μ}_{g}^{( n )} ⟩ ,$$

can be finally written, using equations (8.36),(8.39) and (8.40), as

$$\begin{matrix}P ( n ) ≡ {P}_{AV} - Δ P cos 2 ( n ω - {φ}_{R} ) {ⅇ}^{- 2 {φ}_{I}} \\ {P}_{AV} ≡ 1 - Δ P - N {cos}^{2} \frac{ω}{2} {σ}_{B}^{2} \\ Δ P ≡ \frac{N}{2} {cos}^{2} \frac{ω}{2} [ ⟨ {\overline{B}}_{2}^{ ′ ( 0 )} \vert {\overline{B}}_{2}^{ ′ ( 0 )} ⟩ + {tan}^{2} \frac{ω}{2} ⟨ {\overline{G}}_{2}^{ ′ ( 0 )} \vert {\overline{G}}_{2}^{ ′ ( 0 )} ⟩ ]\end{matrix} \qquad ( 8.41 )$$

The probability P(n) can be found to be maximized, Pₘₐₓ=P_{AV}+ΔPe^{-2φ}^{_{J}} at nⱼ=[π(2j+1)/2+φ_{R}]/ω (with jεZ. Moreover, one can find a “good” item |g [symbol] (i.e., have Pₘₐₓ=1) either provided that t=N (trivial case) or that the following conditions on the moment of the amplitudes of the initial distribution of states are satisfied

φ_{I}=0, σ_{b}²=0 (8.42)

i.e., for [Re [symbol] \overline{G}₂′⁽⁰⁾|\overline{B}₂′₍₀₎ [symbol] ]²= [symbol] \overline{G}₂′⁽⁰⁾|\overline{G}₂′⁽⁰⁾ [symbol] [symbol] \overline{G}₂′⁽⁰⁾|\overline{G}₂′⁽⁰⁾ [symbol] (which can be true, e.g., if |\overline{G}₂′⁽⁰⁾ [symbol] =c|\overline{G}₂′⁽⁰⁾ [symbol] with cεR) and for γ_{B} [symbol] B′|B′ [symbol] = [symbol] \overline{G}₂′⁽⁰⁾|\overline{G}₂′⁽⁰⁾ [symbol] . In particular, for n=nⱼ,

$${G}_{H}^{nj} \vert \overline{ψ} ⟩ = {\sum }_{g} \vert g ⟩ [ \vert {f}^{′} ( g ) ⟩ - ( 1 + {( - 1 )}^{j} sin {φ}_{R} ) \vert {\overline{G}}_{2}^{ ′ ( 0 )} ⟩ + {( - 1 )}^{j} cos {φ}_{R} cot θ ) \vert {\overline{B}}_{2}^{ ′ ( 0 )} ⟩ ]$$

Of course, the unitary nature of the operator prevents one from naively getting only the exact contribution from the initial “unperturbed” entangled states |f′(g) [symbol] in G_{H}^{nj}|\overline{ψ} [symbol] . However, as some elementary algebra can show, it is still possible, for instance in the case of a large enough number of “good” items g, i.e. for t/N ≦O(1), to make the amplitude contribution coming from the other entangled states |\overline{G}₂′⁽⁰⁾ [symbol] and \overline{B}₂′⁽⁰⁾ [symbol] relatively small compared to that of |f′g) [symbol] , if j is even and provided that [symbol] \overline{G}₂′⁽⁰⁾|\overline{G}₂′⁽⁰⁾ [symbol] [symbol] / [symbol] \overline{B}₂′⁽⁰⁾ [symbol] |\overline{B}₂′⁽⁰⁾ [symbol] \overline{>}O(1).

Finally, it is also straightforward to show that the particular case of an initial state with arbitrarily complex amplitudes can be recovered provided one makes the substitutions |f(g) [symbol] →\sqrt{N}kᵢ,|f(b) [symbol] →\sqrt{N}Iⱼ, t→r and n→t, with kᵢ and lᵢ complex numbers. The maximum probability of success Pₘₐₓ can be achieved again after nⱼ steps, and corresponds to certainty if one has

$$\begin{matrix}\overline{k} ( t ) ≡ {\sum }_{i = 1}^{r} {k}_{i} ( t ) / r and \overline{l} ( t ) ≡ {\sum }_{i = 1}^{N - r} {l}_{i} ( t ) / ( N - r ) : \\ {σ}_{l}^{2} = 0 , Im [ {\overline{k}}^{*} ( 0 ) \overline{l} ( 0 ) ] = 0\end{matrix} \qquad ( 8.43 )$$

i.e. when l₁(t)=l₂(t)=l_{N-r}(t)=\overline{l}(0)=const (constant of the motion) and, using polar coordinates such that \overline{k}(0)=ρ_{\overline{k}}exp [iχ_{\overline{k}}] and \overline{l}(0)=ρ_{\overline{l}}exp [iχ_{\overline{l}}], when χ_{\overline{l}}=χ_{\overline{l}}±mπ(mεZ).

The algorithm COUNT, described below, is used for the case of an initial flat superposition of states. The COUNT algorithm essentially exploits Grover's unitary operation G_{H}, already discussed in the previous section, and Shor's Fourier operation F for extraction the periodicity of a quantum state, defined as (note that one can write the flat superposition as

$$\begin{matrix}W \vert 0 ⟩ = F \vert 0 ⟩ = {\sum }_{a = 0}^{N - 1} \vert a ⟩ / \sqrt{N} \\ F \vert a ⟩ = \frac{1}{\sqrt{k}} {\sum }_{c = 0}^{k - 1} {ⅇ}^{2 ⅈ π a c / k} \vert c ⟩\end{matrix} \qquad ( 8.44 )$$

The COUNT algorithm involves the following sequence of operations:

$$\begin{matrix}1 ) ( W \vert 0 ⟩ ) ( W \vert 0 ⟩ ) = {\sum }_{m = 0}^{P - 1} \vert m ⟩ {\sum }_{a = 0}^{N - 1} \vert a ⟩ ; \\ 2 ) \to ( F ⊗ I ) [ {\sum }_{m = 0}^{P - 1} \vert m ⟩ {G}_{H}^{m} {\sum }_{a = 0}^{N - 1} \vert a ⟩ ] \\ 3 ) \to measure \vert m ⟩ .\end{matrix}$$

Since the amplitude of the set of the good states |g [symbol] after m iterations of G_{H} on |a [symbol] is a periodic function of m, the estimate of such a period by use of the Fourier analysis and the measurement of the ancilla qubit |m [symbol] will give information on the size t of this set, on which the period itself depends. The parameter P determines both the precision of the estimate t and the computational complexity of the COUNT algorithm (which requires P) iterations of G_{H}.

Using the more general normalization

$${\sum }_{a = 0}^{N - 1} {‖ \vert a ⟩ ‖}^{2} = N , {\sum }_{a = 0}^{N - 1} {‖ \vert f ( a ) ⟩ ‖}^{2} = {N}^{′} , {\sum }_{a = 0}^{N - 1} {‖ \vert f ( g ) ⟩ ‖}^{2} ≡ {N}_{1}$$

(with 0<N₁<N′) and the initial (normalized) entangled state |\overline{ψ} [symbol] .) tensor the state |\overline{ψ} [symbol] with an ancillary qubit |0 [symbol] and act on this qubit with a Walsh-Hadamard transform W in order to obtain

$$\vert {\overline{ψ}}_{1} ⟩ ≡ \frac{{\sum }_{m = 0}^{P - 1} \vert m ⟩}{\sqrt{P}} \vert \overline{ψ} ⟩ \qquad ( 8.45 )$$

Then act on |\overline{ψ} [symbol] in equation (8.45) with an |m [symbol] —“controlled” Grover operation G_{H}^{m} and on |m [symbol] with a Fourier transform F, thus getting

$$\vert {\overline{ψ}}_{2} ⟩ ≡ \frac{{\sum }_{m , n = 0}^{P - 1} {ⅇ}^{2 π ⅈ m n / P} \vert n ⟩}{\sqrt{P}} {G}_{H}^{m} \vert \overline{ψ} ⟩ \qquad ( 8.46 )$$

As in the standard COUNT algorithm, requiring that the time needed to compute the repeated Grover operations G_{H}^{m} is polynomial in log k, leads to the choice P≅O[poly(log k)] in equation (8.46).

Summing over n in equation (8.46), after some elementary algebra gives (taking, without loss of generality, P even)

$$\vert {\overline{ψ}}_{3} ⟩ ≡ \frac{1}{\sqrt{{N}^{′}}} [ \vert 0 ⟩ \vert A ⟩ + \vert P / 2 ⟩ \vert B ⟩ + \frac{1}{2 N} {\sum }_{m = 0}^{P - 1} \vert m ⟩ ( {φ}_{m}^{+} {s}_{m}^{+} \vert {C}_{+} ⟩ + {φ}_{m}^{-} {s}_{m}^{-} \vert {C}_{-} ⟩ ) ] \qquad ( 8.47 )$$

where the following quantities have been introduced:

$${s}_{m}^{\pm } = \frac{sin π ( m \pm f )}{P sin [ π ( m \pm f ) / P ]} ; {φ}_{m}^{\pm } = {ⅇ}^{ⅈ π ( m \pm f ) ( ⅈ - 1 ) / P} ; f ≡ \frac{P θ}{π} ; 0 \leq f \leq P / 2 \qquad ( 8.48 )$$

and where the states |A [symbol] , |B [symbol] , |C [symbol] are mutually orthogonal and given by

$$\begin{matrix}\vert A ⟩ & ≡ & \vert G ⟩ - \vert {G}_{1} ⟩ \vert {G}_{2} ⟩ / N {sin}^{2} θ \\ \vert B ⟩ & ≡ & \vert B ⟩ - \vert {B}_{1} ⟩ \vert {B}_{2} ⟩ / N {cos}^{2} θ \\ \vert {C}_{\pm } ⟩ & ≡ & [ \vert {G}_{1} ⟩ \pm ⅈ tan θ \vert {B}_{1} ⟩ ] \times [ \vert {G}_{2} ⟩ ∓ ⅈ tan θ \vert {B}_{2} ⟩ ] / {sin}^{2} θ\end{matrix} \qquad ( 8.49 )$$

At this point one can rewrite formula (8.47) in the general case when f is not an integer, distinguishing three possible cases. In particular, when 0<f<1

|\overline{104}₃ [symbol] =|0 [symbol] |α₁ [symbol] +|1 [symbol] |b₁ [symbol] +|P−1 [symbol] |c₁ [symbol] +|R₁ [symbol] (8.50)

where |R₁ [symbol] is an “error” term including all the other states in |\overline{104}₃ [symbol] not containing the ancillary qubits |0 [symbol] , |1 [symbol] , |P−1 [symbol] . One can show that the total probability amplitude in the first three terms (i.e., the probability that, in a measurement of the first ancillary qubit, one obtains any of the states |0 [symbol] , |1 [symbol] , |P−1 [symbol] ) is given by

$$\begin{matrix}{W}_{1} ≡ ⟨ {a}_{1} \vert {a}_{1} ⟩ + ⟨ {b}_{1} \vert {b}_{1} ⟩ + ⟨ {c}_{1} \vert {c}_{1} ⟩ \\ = \frac{{N}_{1}}{{N}^{′}} \{ 1 + [ ⟨ {G}_{2} \vert {G}_{2} ⟩ ( {Σ}_{1} - 1 ) + {tan}^{2} θ ⟨ {B}_{2} \vert {B}_{2} ⟩ {Σ}_{1} ] / {N}_{1} N {sin}^{2} θ \}\end{matrix} \qquad ( 8.51 )$$

with

$${Σ}_{1} ≡ {( {s}_{0}^{+} )}^{2} + {( {s}_{1}^{+} )}^{2} + {( {s}_{P - 1}^{+} )}^{2} ,$$

and it can be shown that

$$8 / {π}^{2} < {Σ}_{1} \leq 1.$$

When 1<f<P/2, instead,

|\overline{ψ}₃=|P/2−1 [symbol] |α₂ [symbol] +|P/2 [symbol] |b₂ [symbol] +P/2+1 [symbol] |c₂ [symbol] +R₂ [symbol] (8.52)

where the meaning of |R₂) is as in equation (8.50) and the total probability amplitude in the first three terms is now given by

$$\begin{matrix}{W}_{2} ≡ ⟨ {a}_{2} \vert {a}_{2} ⟩ + ⟨ {b}_{2} \vert {b}_{2} ⟩ + ⟨ {c}_{2} \vert {c}_{2} ⟩ \\ = 1 - \frac{{N}_{1}}{{N}^{′}} + [ ⟨ {G}_{2} \vert {G}_{2} ⟩ {Σ}_{2} + {tan}^{2} θ ⟨ {B}_{2} \vert {B}_{2} ⟩ ( {Σ}_{2} - 1 ) ] / {NN}^{′} {sin}^{2} θ\end{matrix} \qquad ( 8.53 )$$

with

$${Σ}_{2} ≡ {( {s}_{P / 2}^{+} )}^{2} + {( {s}_{P / 2 - 1}^{+} )}^{2} + {( {s}_{P / 2 + 1}^{+} )}^{2} ,$$

and it can be shown that

$$8 / {π}^{2} < {Σ}_{2} \leq 1.$$

Finally, in the most general case in which 1<f<P/2−1

|\overline{ψ}₃=|f⁻ [symbol] |α₃ [symbol] +|P−f⁻ [symbol] |b₃ [symbol] +|f⁺ [symbol] |c₃ [symbol] +|P−f⁺ [symbol] |d₃ [symbol] +R₃ [symbol] (8.54)

where |R₃ [symbol] is the usual “correction” term and, by definition f⁻≡[f]+δf and f⁺≡f⁻+1 with 0<δf<1.

The total probability amplitude in the first four terms in this case is given by

$$\begin{matrix}{W}_{3} ≡ ⟨ {a}_{3} \vert {a}_{3} ⟩ + ⟨ {b}_{3} \vert {b}_{3} ⟩ + ⟨ {c}_{3} \vert {c}_{3} ⟩ + ⟨ {d}_{3} \vert {d}_{3} ⟩ \\ = \frac{( ⟨ {G}_{2} \vert {G}_{2} ⟩ + {tan}^{2} θ ⟨ {B}_{2} \vert {B}_{2} ⟩ )}{{NN}^{ ′} {sin}^{2} θ} {Σ}_{3} ,\end{matrix} \qquad ( 8.55 )$$

$${Σ}_{3} ≡ {( {s}_{{f}^{+}}^{+} )}^{2} + {( {s}_{{f}^{-}}^{+} )}^{2} + {( {s}_{P - {f}^{+}}^{+} )}^{2} + {( {s}_{P - {f}^{-}}^{+} )}^{2} ,$$

and again

$$8 / {π}^{2} < {Σ}_{3} \leq 1.$$

The final step of the COUNT algorithm involves measuring the first ancillary qubit in the state |\overline{ψ}₃ [symbol] . To find one of the ancillary qubits |0 [symbol] , |1 [symbol] , |P−1 [symbol] or |P/2±1 [symbol] , |P/2) or |f_{±} [symbol] , |P−f_{±} [symbol] , respectively, for the three cases, and, therefore, still be able to evaluate the number t of “good” states from sin θ=\sqrt{t/N} and equation (8.48) even in the case of an initial entangled state with the same probability as in the case of an initial flat superposition of states, it is desirable to impose the condition

Wₜ≧1//2 (8.56)

The probability can be made exponentially close to one by repeating the whole algorithm many times and using the majority rule. The probabilities Wᵢ can be increased, e.g. by introducing R extra ancillary qubits |m₁ [symbol] . . . |m_{R} [symbol] and then acting with a |m₁ [symbol] . . . |m_{R} [symbol] —“controlled” G_{H}^{m} operation on the state |\overline{ψ} [symbol] .)

Taking for simplicity N=N′ in Equation (8.55) for general case 1<f<P/2-1, Equation (8.56) would lead to the condition on the initial averages

$$\frac{⟨ {\overline{G}}_{2}^{′ ( 0 )} \vert {\overline{G}}_{2}^{′ ( 0 )} ⟩}{{γ}_{G}} + \frac{⟨ {\overline{B}}_{2}^{′ ( 0 )} \vert {\overline{B}}_{2}^{′ ( 0 )} ⟩}{{γ}_{B}} > {( 2 {Σ}_{3} )}^{- 1} > 1 / 2 \qquad ( 8.57 )$$

which, for example, upon the choice |\overline{G}₂′⁽⁰⁾ [symbol] =c|\overline{B}₂′⁽⁰⁾ [symbol] , would require that c²>(2−1/γ_{B})γ_{G}. Furthermore, since in general f is not an integer, the measured \tilde{f} will not match exactly the true value of f and, defining \tilde{t}≡N sin² \tilde{θ}, with \tilde{θ}=\tilde{θ}(\tilde{f}), gives, for the error over t, the same estimate, i.e.

$${\vert Δ t \vert}_{exp} ≡ \vert \tilde{t} - t \vert \leq π \frac{N}{P} [ \frac{π}{P} + 2 \sqrt{\frac{t}{N}} ] \qquad ( 8.58 )$$

so that the accuracy will always remain similar in the cases of an initial unentangled or entangled state.

In the most general case when Grover's algorithm is to be used as a subroutine in a bigger quantum network when the generic form of the initial state is unknown and arbitrary entangled superposition of qubits. In particular, one can preserve a good success probability and a high accuracy in determining the number of “good” items even if the initial state is entangled, again provided that some conditions are satisfied by the averages and variances of the amplitude distribution of the initial state.

Consider the situation where the number of objects satisfying the search criterion is greater than 1. Let a database {wᵢ|=1, 2, . . . , N}, with corresponding orthonormal eigenstates {|wᵢ [symbol] |i=1, 2, . . . , N} in the quantum computing, be given. Let f be an oracle function such that

$$f ( {w}_{j} ) = \{ \begin{matrix}1 , & j = 1 , 2 , … , l , \\ 0 , & j = l + 1 , l + 2 , … , N\end{matrix} .$$

Here the l elements {wⱼ|1≦j≦l} are desired objects of search. All N items w, are subjected to some unknown permutation, which is not necessarily known explicitly. Let [symbol] be the Hilbert space generated by the orthonormal basis B={|wⱼ [symbol] |j=1, . . . , N}. Let Λ=span{|wⱼ [symbol] |1≦j≦1} be the subspace of [symbol] spanned by the vectors of the good objects. (To avoid introducing another layer of subscripts, it is assumed that these good objects are the first l items.)

Now, define a linear operation in terms of the oracle function as follows:

I_{Λ}=(−1)^{f(w}^{ⱼ}⁾|wⱼ [symbol] j=1, 2, . . . , N. (9.1)

Then since I_{Λ} is linear, the extension of I_{Λ} to the entire space H is unique, with an “explicit” representation

$${I}_{Λ} = I - 2 {\sum }_{j = 1}^{l} \vert {w}_{j} ⟩ ⟨ {w}_{j} \vert , \qquad ( 9.2 )$$

where I is the identity operator on [symbol] . I_{Λ} is the operator of rotation (by π) of the phase of the subspace Λ.

The explicitness of (9.2) is misleading because explicit knowledge of {|wⱼ [symbol] |1≦j≦l} in (9.2) is not available. Nevertheless, (9.2) is a well-defined (and unitary) operator on [symbol] because of (9.1).

Now again define |s [symbol] as

$$\vert s ⟩ = \frac{1}{\sqrt{N}} {\sum }_{i = 1}^{N} \vert {w}_{i} ⟩ = \frac{1}{\sqrt{N}} {\sum }_{i = 1}^{l} \vert {w}_{i} ⟩ + \sqrt{\frac{N - l}{N}} \vert r ⟩ \qquad ( 9.3 )$$

where now

$$\vert r ⟩ = \frac{1}{\sqrt{1 - \frac{l}{N}}} ( \vert s ⟩ - \frac{1}{\sqrt{N}} {\sum }_{i = 1}^{l} \vert {w}_{i} ⟩ ) .$$

As before, Tₛ=I−2|s [symbol] [symbol] s|. Note that Iₛ is unitary and hence quantum-mechanically admissible. Iₛ is explicitly known, constructible with the so-called Walsh-Hadamard transformation.

Let \tilde{Λ}=span{Λ∪|r [symbol] }. Then {|wᵢ [symbol] , |r [symbol] |i=1, 2, . . . , l} forms an orthonormal basis of \tilde{Λ}. The orthogonal direct sum H=\tilde{Λ}⊕\tilde{Λ}^{⊥} is an orthogonal invariant decomposition for both operators I_{\tilde{Λ}} and Iₛ. The restriction of Iₛ of \tilde{Λ}^{⊥} is P_{\tilde{Λ}⊥}, the orthogonal projection operator onto \tilde{Λ}^{⊥}. From (9.3),

$$\begin{matrix}{I}_{s} = I - 2 [ \frac{1}{\sqrt{N}} {\sum }_{i = 1}^{l} \vert {w}_{i} ⟩ + \sqrt{\frac{N - l}{N}} \vert r ⟩ ] [ \frac{1}{\sqrt{N}} {\sum }_{j = 1}^{l} ⟨ {w}_{j} \vert + \sqrt{\frac{N - l}{N}} ⟨ r \vert ] \\ = [ {\sum }_{i = 1}^{l} \vert {w}_{i} ⟩ ⟨ {w}_{i} \vert + \vert r ⟩ ⟨ r \vert + {P}_{{\tilde{Λ}}^{⊥}} ] - \\ \{ \frac{2}{N} {\sum }_{i = 1}^{l} {\sum }_{j = 1}^{l} \vert {w}_{i} ⟩ ⟨ {w}_{j} \vert + \frac{2 \sqrt{N - l}}{N} [ {\sum }_{i = 1}^{l} ( \vert {w}_{i} ⟩ ⟨ r \vert + \vert r ⟩ ⟨ {w}_{i} \vert ) ] \} - \\ 2 ( \frac{N - l}{N} ) \vert r ⟩ ⟨ r \vert \\ = {\sum }_{i = 1}^{l} {\sum }_{j = 1}^{l} ( {δ}_{ij} - \frac{2}{N} ) \vert {w}_{i} ⟩ ⟨ {w}_{j} \vert - \\ \frac{2 \sqrt{N - l}}{N} [ {\sum }_{i = 1}^{l} ( \vert {w}_{i} ⟩ ⟨ r \vert + \vert r ⟩ ⟨ {w}_{i} \vert ) ] + ( \frac{2 l}{N} - 1 ) \vert r ⟩ ⟨ r \vert + {P}_{{\tilde{Λ}}^{⊥}}\end{matrix} \qquad ( 9.4 )$$

Furthermore, the conclusion follows: 1) the restriction of Iₛ to \tilde{Λ} admits this real unitary matrix representation with respect to the orthonormal basis

$$\{ \vert {w}_{1} ⟩ , \vert {w}_{2} ⟩ , … , \vert {w}_{1} ⟩ , \vert r ⟩ \} \text{:} A = {[ {a}_{ij} ]}_{( l + 1 ) \times ( l + 1 )} , \qquad ( 9.5 )$$

$${a}_{ij} = \{ \begin{matrix}{δ}_{ij} - \frac{2}{N} , & 1 \leq i , j \leq l \\ - \frac{2 \sqrt{N - l}}{N} ( {δ}_{i , l + 1} + {δ}_{j , l + 1} ) , & i = l + 1 or j = l + 1 , i \neq j \\ \frac{2 l}{N} - 1 , & i = j = l + 1\end{matrix} \qquad ( 9.6 )$$

Consequently, Iₛ|_{\tilde{Λ}}_{^{⊥}}=Iₛ|_{\tilde{Λ}}_{^{⊥}}, where Iₛ|_{\tilde{Λ}}_{^{⊥}} is the identity operator on \tilde{Λ}^{⊥}.

The generalized Grover search engine for multi-object search is now constructed as:

U=−IₛI_{Λ} (9.7)

Substituting (9.2) and (9.4) into (9.7) and simplifying,

$$\begin{matrix}U = - {I}_{s} {I}_{Λ} = … ( simplification ) \\ = {\sum }_{i = 1}^{l} {\sum }_{j = 1}^{l} ( {δ}_{ij} - \frac{2}{N} ) \vert {w}_{i} ⟩ ⟨ {w}_{j} \vert + \\ \frac{2 \sqrt{N - l}}{N} {\sum }_{i = 1}^{l} ( \vert {w}_{i} ⟩ ⟨ r \vert - \vert r ⟩ ⟨ {w}_{i} \vert ) + ( 1 - \frac{2 l}{N} ) \vert r ⟩ ⟨ r \vert - {P}_{{\tilde{Λ}}^{⊥}}\end{matrix}$$

The orthogonal direct sum H=\tilde{Λ}⊕^{⊥} is an invariant decomposition for the unitary operator U, such that the following holds: 1) With respect to the orthonormal basis {|w₁ [symbol] , |w₂ [symbol] , . . . , |w₁ [symbol] , |r [symbol] } of \tilde{Λ}, the operator U admits the real unitary matrix representation

$$U {\vert}_{\tilde{⩓}} = {[ {u}_{ij} ]}_{( l + 1 ) \times ( l + 1 )} , \qquad ( 9.8 )$$

$${u}_{ij} = \{ \begin{matrix}{δ}_{ij} - \frac{2}{N} , & 1 \leq i , j \leq l \\ \frac{2 \sqrt{N - l}}{N} ( {δ}_{i , l + 1} + {δ}_{j , l + 1} ) , & i = l + 1 or j = l + 1 , i \neq j \\ 1 - \frac{2 l}{N} , & i = j = l + 1\end{matrix} \qquad ( 9.9 )$$

2) The restriction of U to \tilde{Λ}^{⊥} is −P_{\tilde{Λ}}_{^{⊥=-I}}_{\tilde{Λ}}_{^{⊥}}.

The results above effect a reduction of the problem to an invariant subspace \tilde{Λ}. However, \tilde{Λ} is a (l+1)—dimensional subspace where l may be fairly large. Another reduction of dimensionality is needed to further simplify the operator U.

Define [symbol] by

$$Ξ = \{ \vert v ⟩ ∈ \tilde{Λ} : \vert v ⟩ = a {\sum }_{i = 1}^{l} \vert {w}_{i} ⟩ + b \vert r ⟩ ; a , b ∈ C \} .$$

Let

$$\vert \tilde{w} ⟩ = \frac{1}{\sqrt{l}} {\sum }_{i = 1}^{l} \vert {w}_{i} ⟩ .$$

Then {|\tilde{w} [symbol] , |r [symbol] } forms an orthonormal basis of [symbol] . Then [symbol] is an invariant two-dimensional subspace of U such that:

1) r, sε [symbol] ; 2) U( [symbol] )= [symbol] .

One has the second reduction, to dimensionality 2.

Using matrix representation (9.8) and (9.9), and the definition of |\tilde{w} [symbol] as

$$\vert \tilde{w} ⟩ = \frac{1}{\sqrt{l}} {\sum }_{i = 1}^{l} \vert {w}_{i} ⟩$$

one obtains the following: With respect to the orthonormal basis {|\tilde{w} [symbol] , |r [symbol] } in the invariant subspace [symbol] , U admits the real unitary matrix representation

$$U = [ \begin{matrix}\frac{N - 2 l}{N} & \frac{2 \sqrt{l ( N - l )}}{N} \\ - \frac{2 \sqrt{l ( N - l )}}{N} & \frac{N - 2 l}{N}\end{matrix} ] = [ \begin{matrix}cos θ & sin θ \\ - sin θ & cos θ\end{matrix} ] \\ θ ≡ {sin}^{- 1} ( \frac{2 \sqrt{l ( N - l )}}{N} ) \qquad ( 9.10 )$$

Since |s [symbol] ε [symbol] , one can calculate U^{m}|s [symbol] using (9.10):

$$\begin{matrix}\begin{matrix}{U}^{m} \vert s ⟩ = {U}^{m} ( \frac{1}{\sqrt{N}} {\sum }_{i = 1}^{l} \vert {w}_{i} ⟩ + \sqrt{\frac{N - l}{N}} \vert r ⟩ ) ( by ) & \\ = {U}^{m} ( \frac{l}{\sqrt{N}} \vert \tilde{w} ⟩ + \sqrt{\frac{N - l}{N}} \vert r ⟩ ) & \end{matrix} & ( 9.3 ) \\ \begin{matrix} = [ \begin{matrix}cos θ & sin θ \\ - sin θ & cos θ\end{matrix} ] [ \begin{matrix}\frac{l}{\sqrt{N}} \\ \sqrt{\frac{N - l}{N}}\end{matrix} ] & ( α ≡ {cos}^{- 1} ( \frac{l}{\sqrt{N}} ) ) \\ = [ \begin{matrix}cos ( m θ - α ) \\ - sin ( m θ - α )\end{matrix} ] & \\ = cos ( m θ - α ) \cdot \vert \tilde{w} ⟩ - sin ( m θ - α ) \cdot \vert r ⟩ & \end{matrix} & ( 9.11 )\end{matrix}$$

Thus, the probability of reaching the state |\tilde{w} [symbol] after m iterations is

Pₘ=cos² (mθ−α) (9.12)

If l<<N, then α is close to

$$\frac{π}{2}$$

and, therefore, equation (9.12) is an increasing function of m initially. This again manifests the notion of amplitude amplification. This probability Pₘ is maximized if [mθ=α],

$$implying m = [ \frac{α}{θ} ] = the integer part of \frac{α}{θ} .$$

When

$$\frac{l}{N}$$

is small

$$θ = {sin}^{- 1} ( \frac{2 \sqrt{l ( N - l )}}{N} ) \\ = {sin}^{- 1} ( 2 \sqrt{\frac{l}{N}} [ 1 - \frac{1}{2} \frac{l}{N} - \frac{1}{8} {( \frac{l}{N} )}^{2} \pm ⋯ ] ) \\ = 2 \sqrt{\frac{l}{N}} + O ( {( \frac{l}{N} )}^{\frac{2}{3}} ) ; \\ α = {cos}^{- 1} ( \frac{l}{\sqrt{N}} ) = \frac{π}{2} - [ \frac{l}{\sqrt{N}} + O ( {( \frac{l}{\sqrt{N}} )}^{3} ) ] . \\ Therefore \\ m \approx \frac{\frac{π}{2} - [ \frac{l}{\sqrt{N}} + O ( {( \frac{l}{\sqrt{N}} )}^{3} ) ]}{2 \sqrt{\frac{l}{N}} + O ( {( \frac{l}{N} )}^{\frac{3}{2}} ) \\ \\ \frac{π}{4} \sqrt{\frac{N}{l}} [ 1 + O ( \frac{l}{N} ) ]} = \qquad ( 9.13 )$$

The generalized Grover algorithm for multi-objective search with operator U given by (9.7) has the success probability Pₘ=cos² (mθ−α) of reaching the state |\tilde{w} [symbol] εΛ after m iterations. For

$$\frac{l}{N}$$

small, after

$$m = \frac{π}{4} \sqrt{\frac{N}{l}}$$

iterations, the probability of reaching |\tilde{w} [symbol] εΛ is close to 1.

The result (9.13) is consistent with Grover's original algorithm for single object search with l=1, which has

$$m \approx \frac{π}{4} \sqrt{N} .$$

Assume that

$$\frac{l}{N}$$

is small. Then, any search algorithm for l objects, in the form of UₚUₚ₋₁ . . . U₁|wₗ [symbol] , where each Uⱼ, j=1, 2, . . . , p is an unitary operator and |wₗ) is an arbitrary superposition state, takes in average

$$p = O ( \sqrt{\frac{N}{l}} )$$

iterations in order to reach the subspace Λ with a positive probability

$$P > \frac{1}{2}$$

independent of N and l.

Unfortunately, if the number l of good items is not known in advance, the above does not show when to stop the iteration. Consider stopping the Grover process after j iterations, and, if a good object is not obtained, starting it over again from the beginning. The probability of success after j iteration is cos² (jθ−α). By a well-known theorem of probability theory, if the probability of success in k “trials” is p, then the expected number of trials before success is achieved will be p⁻¹. In the present case, each trial includes j Grover iterations, so the expected number of iterations before success is M[j]=j·sec²(jθ−α). The optimal number of iterations j is obtained by setting the derivative M′[j] equal to zero:

0=M′[j]=sec²(jθ−α)+2jθsec²(jθ−α)tan(jθ−α), 2jθ=−cot((jθ−α)) (9.14)

Now approximate the solution j of (9.14) iteratively as follows. The first order approximation jₗ for j is obtained by solving

$$\begin{matrix}{j}_{1} = \frac{1}{θ} ( α - \frac{1}{2 θ {j}_{1}} ) \\ {j}_{1}^{2} = \frac{1}{θ} α {j}_{1} - \frac{1}{2 {θ}^{2}} \\ {j}_{1}^{3} = \frac{1}{2 θ} ( α + \sqrt{{α}^{2} - 2} )\end{matrix} \qquad ( 9.15 )$$

Higher order approximations jₙ₊₁ for n=1, 2, . . . , can be obtained by successive iterations

$${j}_{n + 1} = \frac{1}{θ} ( α - {tan}^{- 1} \frac{1}{2 θ {j}_{n}} )$$

based on equation (9.14). This process will yield a convergent solution j to (9.14). Information analysis of this problem in Appendix 4 is developed.

In FIG. 1, the GA 131 produces an optimal solution from single space of solution. The GA 131 compresses the value information from a single solution space with the guarantee of the safety of informative parameters in general signal K of the PID controller 150.

In FIG. 20 the GA 131 produces a number of solutions as structured (sorted) data for the QGSA 2001. The quantum search algorithm on structured (sorted) data searches for a successful solution with higher probability and greater accuracy than a search on unstructured data. The input to the QGSA 2001 is a set of vectors (string) and the output of the QGSA 2001 is a single vector K. A linear superposition of cells of look-up tables of fuzzy controllers in the QGSA 2001 is produced with the Hadamard Transform H. Components of the vector K are coded as qubits, either |0 [symbol] or |1 [symbol] . The Hadamard transform H is formed independent for every qubit a linear superposition of qubits.

For example, consider a qubit

$$\vert 0 ⟩ = ( \begin{matrix}1 \\ 0\end{matrix} ) .$$

With a unitary matrix as a Hadamard transform

$$H = \frac{1}{\sqrt{2}} ( \begin{matrix}1 & 1 \\ 1 & - 1\end{matrix} )$$

Thus

$$\begin{matrix}\begin{matrix}H \vert 0 ⟩ = \frac{1}{\sqrt{2}} ( \begin{matrix}1 & 1 \\ 1 & - 1\end{matrix} ) ( \begin{matrix}1 \\ 0\end{matrix} ) = \frac{1}{\sqrt{2}} ( \begin{matrix}1 \\ 1\end{matrix} ) \\ = \frac{1}{\sqrt{2}} ( ( \begin{matrix}1 \\ 0\end{matrix} ) + ( \begin{matrix}0 \\ 1\end{matrix} ) ) = \frac{1}{\sqrt{2}} ( \vert 0 ⟩ + \vert 1 ⟩ )\end{matrix} \\ and \\ \begin{matrix}H \vert 1 ⟩ = \frac{1}{\sqrt{2}} ( \begin{matrix}1 & 1 \\ 1 & - 1\end{matrix} ) ( \begin{matrix}0 \\ 1\end{matrix} ) = \frac{1}{\sqrt{2}} ( \begin{matrix}1 \\ - 1\end{matrix} ) \\ = \frac{1}{\sqrt{2}} ( ( \begin{matrix}1 \\ 0\end{matrix} ) - ( \begin{matrix}0 \\ 1\end{matrix} ) ) = \frac{1}{\sqrt{2}} ( \vert 0 ⟩ - \vert 1 ⟩ ) .\end{matrix}\end{matrix}$$

The QGSA 2001 evolves classical states as cells of look-up tables from the GA 131 or for the FNN 142 into a superposition and therefore cannot be regarded as classical. The collection of qubits is a quantum register. This leads to the tensor product (product in Hilbert space). The tensor product is identified with the Kronecker product of matrices. The next step involves coding of information. As in the classical case, it can be used to encode more complicated information. For example, the binary form of 9 (decimal) is 1001 and after loading a quantum register with this value is done by preparing four qubits in state |9 [symbol] ≡|1001 [symbol] ≡|1 [symbol] [symbol] |0 [symbol] [symbol] |0 [symbol] [symbol] |1 [symbol] . Consider first the case with two qubits. With the basis |00 [symbol] ≡|0 [symbol] [symbol] |0 [symbol] , |01 [symbol] ≡|0 [symbol] [symbol] |1 [symbol] , |10 [symbol] ≡|1 [symbol] [symbol] |0 [symbol] , |11 [symbol] ≡|1 [symbol] [symbol] |1 [symbol] . If one initialises a quantum memory register so that in the register starts out in the |0z,900 ) state then applies a Hadamard gate to each qubit independently, the net result places the entire n-qubit register in a superposition of all possible bit strings that an n-bit classical register cannot. Thus, using the Hadamard gate, one can effectively enter 2ⁿ bit strings into a quantum memory register using only n basic operations.

Applying qubits individually, one can obtain the superposition of the 2ⁿ numbers that can be represented in n bits.

$$\begin{matrix}H \vert 0 ⟩ ⊗ H \vert 0 ⟩ ⊗ ⋯ H \vert 0 ⟩ = \frac{1}{\sqrt{2}} ( \vert 0 ⟩ + \vert 1 ⟩ ) ⊗ \frac{1}{\sqrt{2}} ( \vert 0 ⟩ + \vert 1 ⟩ ) ⊗ ⋯ ⊗ \frac{1}{\sqrt{2}} ( \vert 0 ⟩ + \vert 1 ⟩ ) \\ = \frac{1}{\sqrt{{2}^{n}}} ( \vert 00 , … , 0 ⟩ + \vert 00 , … , 1 ⟩ + ⋯ + \vert 11 , … , 1 ⟩ ) \to ( in the base 2 notation ) \\ = \frac{1}{\sqrt{{2}^{n}}} ( \vert 0 ⟩ + \vert 1 ⟩ + \vert 3 ⟩ + ⋯ + \vert {2}^{n} - 1 ⟩ ) \to ( in the base 10 notation ) .\end{matrix}$$

Thus one can effectively load exponentially (i.e., 2ⁿ) numbers of cells of look-up tables into computer using only polynomial many (i.e., n) basic gate operations.

In the general case of the PID controller 150, K(t)={k₁(t), k₂(t), k₃(t)}. According to the superposition law for every components kᵢ(t) the Hadamard transform H can be applied to obtain a superposition of “true” |1 [symbol] ) and “false” |0 [symbol] ) signals., Three applications of the Hadamard transform and the vector tensor product gives the logic combination of signals k_{i l (t).}

The tensor product operations: |10 [symbol] ≡|1 [symbol] [symbol] |0 [symbol] means that the logic joint of signal states, as example, between kⁱ₁(t) and kⁱ₂(t) is given for a PID controller. According to the SSCQ 130 the vector tensor product describes the joint probability amplitude of two systems of being in a joint state. The random optimal output of the GA is the single vector K with stochastically independent components kᵢ(t).

Using a Grover-type quantum search algorithm one can realise more simple robust control with the co-ordination of signals kᵢ(t). The entanglement operator in Grover algorithm searches the quantum (hidden) correlation between the signals kᵢ(t) and with the interference operator (Quantum Fast Fourier Transform—QFFT) chooses the successful robust solution.

With this method one can check the robustness of the look-up table as a the knowledge base for the fuzzy PID controller. Grover's quantum algorithm is a tool for searching for a solution as one universal robust look-up table from many look-up tables of fuizzy controllers for an intelligent smart suspension control system.

Consider, for example, the case n=2 and x=01

f(00)=0, f(01)=1, f(10)=0, f(11)=0.

in order to study the robustness of one cell in one look-up table for a fuzzy controller.

The entanglement operator is:

$${U}_{F} = ( \begin{matrix}1 & 0 & 0 & 0 & 0 & 0 & 0 & 0 \\ 0 & 1 & 0 & 0 & 0 & 0 & 0 & 0 \\ 0 & 0 & 0 & 1 & 0 & 0 & 0 & 0 \\ 0 & 0 & 1 & 0 & 0 & 0 & 0 & 0 \\ 0 & 0 & 0 & 0 & 1 & 0 & 0 & 0 \\ 0 & 0 & 0 & 0 & 0 & 1 & 0 & 0 \\ 0 & 0 & 0 & 0 & 0 & 0 & 1 & 0 \\ 0 & 0 & 0 & 0 & 0 & 0 & 0 & 1\end{matrix} )$$

and |input [symbol] =|00 [symbol] [symbol] |1 [symbol] . An entanglement operator defines a permutation of basis vectors of the superposition it is applied, mapping one basis vector into another basis vector, but not into a superposition. By applying the superposition, the entanglement and the interference operator in sequence we obtain the final vector (see, Appendix 1)

$$\vert output ⟩ = \vert 01 ⟩ ⊗ \frac{\vert 0 ⟩ - \vert 1 ⟩}{\sqrt{2}} .$$

Reading the value of the first two qubits after simulation of suspension system stochastic behavior the searched state x is found.

Temporal labeling is used to obtain the signal from the pure initial state

$$\vert {ψ}_{i n} ⟩ = \vert 00 ⟩ = [ \begin{matrix}1 \\ 0 \\ 0 \\ 0\end{matrix} ]$$

by repeating the simulation experiment three times, cyclically permuting the |01 [symbol] , |10 [symbol] and |11 [symbol] state populations before the computation and then summing the results. The calculation starts with a Walsh-Hadamard transform W (H), which rotates each quantum bit (qubit) from |0 [symbol] to (|0 [symbol] +|1 [symbol] )/\sqrt{2}, to prepare the uniform superposition state

$$\vert {ψ}_{0} ⟩ = W \vert {ψ}_{i n} ⟩ = \frac{1}{2} [ \begin{matrix}1 & 1 & 1 & 1 \\ 1 & - 1 & 1 & - 1 \\ 1 & 1 & - 1 & - 1 \\ 1 & - 1 & - 1 & 1\end{matrix} ] [ \begin{matrix}1 \\ 0 \\ 0 \\ 0\end{matrix} ] = \frac{1}{2} [ \begin{matrix}1 \\ 1 \\ 1 \\ 1\end{matrix} ]$$

From physical standpoint W=H_{A} [symbol] H_{B}, where H=X²\overline{Y} (pulses applied from right to left) is a single-spin Hadamard transformation. These rotations are denoted as X≡exp(iπIₓ/2) for a 90° rotation about \hat{x} axis, and Y≡exp(iπI_{y}/2) for a 90° rotation about ŷ axis, with a subscript specifying the affected spin. The operator corresponding to the application of f(x) for x₀=3 is a

$$C = [ \begin{matrix}1 & 0 & 0 & 0 \\ 0 & 1 & 0 & 0 \\ 0 & 0 & 1 & 0 \\ 0 & 0 & 0 & - 1\end{matrix} ] .$$

This conditional sign flip, testing for a Boolean string that satisfies the AND function, is implemented by using the coupled-spin evolution. During a time t the system undergoes the unitary transformation exp(2πiJI_{zA}I_{zB}t) in the doubly rotating frame. Denoting a t=1/2J (2.3 millisecond) period evolution as the operator τ, one finds that C=Y_{A}\overline{X}_{A}\overline{Y}_{A}Y_{B}\overline{X}_{B}\overline{X}_{B}τ (UP to an irrelevant overall phase factor).

An arbitrary logical function can be tested by a network of controlled-NOT and rotation gates, leaving the result in a scratch pad qubit. This qubit can then be used as the source for a controlled phase-shift gate to implement the conditional sign flip.

The operator D in Grover's quantum search algorithm that inverts the states about their mean can be implemented by a Walsh-Hadamard transform W, a conditional phase shift P, and another Was following

$$D = WPW = W [ \begin{matrix}1 & 0 & 0 & 0 \\ 0 & - 1 & 0 & 0 \\ 0 & 0 & - 1 & 0 \\ 0 & 0 & 0 & - 1\end{matrix} ] , W = \frac{1}{2} [ \begin{matrix}- 1 & 1 & 1 & 1 \\ 1 & - 1 & 1 & 1 \\ 1 & 1 & - 1 & 1 \\ 1 & 1 & 1 & - 1\end{matrix} ]$$

Let U DC be the complete iteration. The state after one cycle is

$$\vert {ψ}_{1} ⟩ = UW \vert {ψ}_{0} ⟩ = \vert 11 ⟩ = [ \begin{matrix}0 \\ 0 \\ 0 \\ 1\end{matrix} ]$$

Measurements of the system's state will give with certainty the correct answer, |11 [symbol] .

For further iterations, |ψₙ [symbol] =Uⁿ|ψ₀ [symbol] ,

$$\vert {ψ}_{2} ⟩ = \frac{1}{2} [ \begin{matrix}- 1 \\ - 1 \\ - 1 \\ 1\end{matrix} ] , \vert {ψ}_{3} ⟩ = \frac{1}{2} [ \begin{matrix}- 1 \\ - 1 \\ - 1 \\ - 1\end{matrix} ] , \vert {ψ}_{4} ⟩ = [ \begin{matrix}0 \\ 0 \\ 0 \\ - 1\end{matrix} ]$$

A maximum in the amplitude of the x₀ state |11 [symbol] recurs every third iteration.

In one embodiment, like any computer program that is compiled to a micro-code, the Radio Frequency (RF)—pulse sequence for U can be optimized to eliminate unnecessary operations. In a quantum computer this is desirable to make the best of the available coherence. Ignoring irrelevant overall phase factors, and noting that H=X²\overline{Y} also works, one can simplify U. In an NMR-experiment (see Appendix 6) with the result of a weak measurement on the ensemble, the signal strength gives the fraction of the population with the measured magnetization rather than collapsing the wave function into a measurement eigenstate. The readout can be preceded by a sequence of single spin rotations to allow all terms in the deviation density matrix

ρ_{Δ}=ρ−tr(ρ)/N, ρ_{Δ}_{ₙ}=|ψₙ [symbol] [symbol] ψₙ|−tr(|ψₙ [symbol] [symbol] ψₙ|)/4,

to be measured.

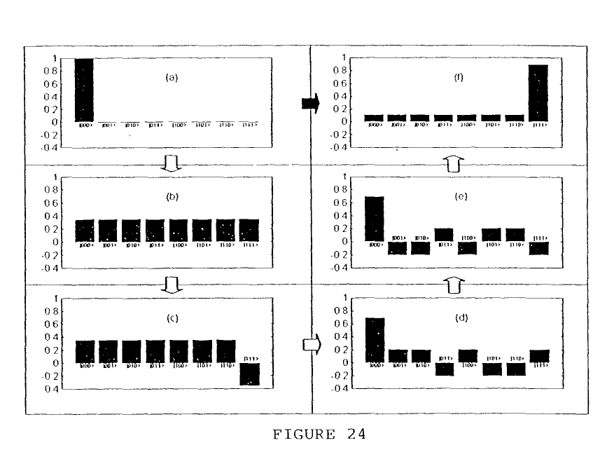

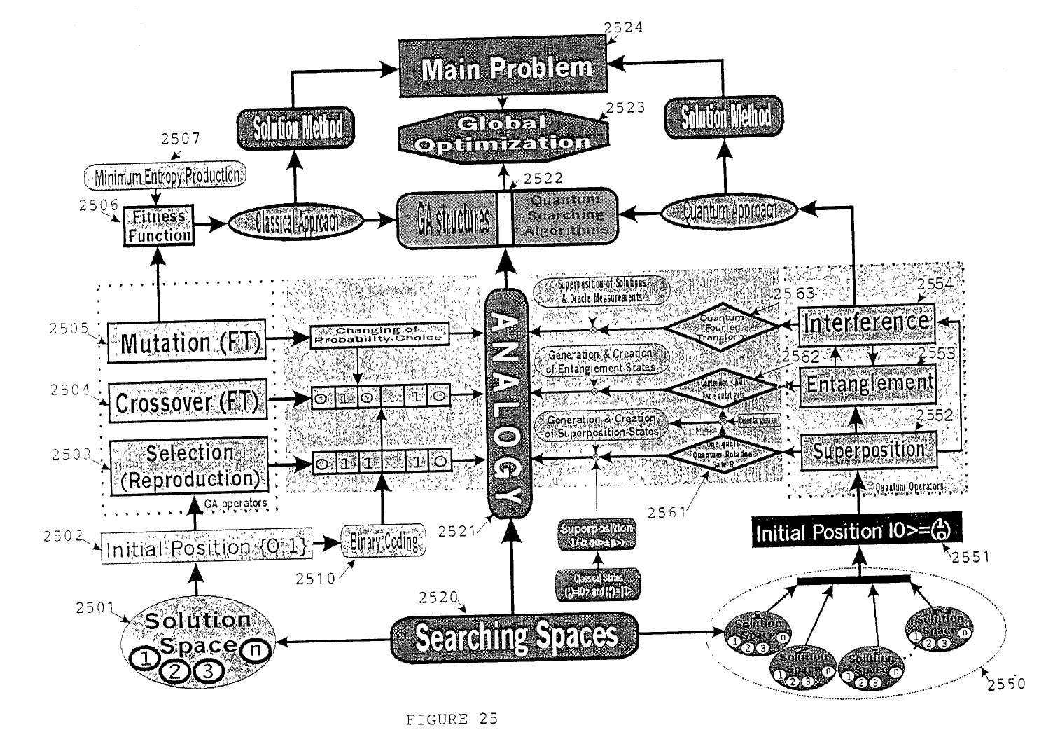

The effect of the elementary rotation G is shown in FIG. 24 for the case of three qubits, i.e. m=3. The first Hadamard transformation H²^{³}⁾ prepares an equally weighted state. The subsequent quantum gate Iₓ_{₀} inverts the amplitude of the searched state |x₀ [symbol] =|111 [symbol] . Together with the subsequent Hadamard transformation and the phase inversion Iₛ this gate sequence G amplifies the probability amplitude of the searched state |x₀ [symbol] =|111 [symbol] . In this particular case an additional Hadamard transformation finally prepares the quantum computation in the searched state |x₀ [symbol] =|111 [symbol] with a probability of 0.88. This method for global optimization and design of KB in fuzzy (P)(I)(D)-controllers is used.

The main application problem of quantum search algorithm in optimization of fuzzy controller KB is the increasing of memory size in simulation on classical computer. An algorithm for this case is provided in Appendix 3, and an example of this the use of this algorithm is described below.

An example for a set of binary patterns of length 2 will help clarify the preceding discussion. Assume that the pattern set for fuzzy P-controller is p={01, 10, 11}. Recall (from Appendix 3) that the x register is the one that corresponds to the various patterns, that the g register is used as a temporary workspace to mark certain states and that the c-register is a control register that is used to determine which states are affected by a particular operator. Now the initial state |00, 0, 00) is generated and the algorithm evolves the quantum state through the series of unitary operations.

First, for any state whose c₂ qubit is in the state |0 [symbol] , the qubits in the x register corresponding to non-zero bits in the first pattern have their states flipped (in this case only the second x qubit's state is flipped) and then the c₁ qubit's state is flipped if the c₂ qubit is |0 [symbol] . This flipping of the c₁ qubit's state marks this state for being operated upon by an Ŝ^{p} operator in the next step. So far, there is only one state, the initial one, in the superposition. This flipping is accomplished with the FLIP operator: |00, 0, 00 [symbol] →^{FLIP}|01, 0, 10

[symbol]

Next, one state in the superposition with the c—register in the state |10 [symbol] (and there will always be only one such state at this step) is operated upon by the appropriate SP operator (with p equal to the number of patterns including the current one yet to be processed, in this case 3). This essentially “carves off” a small piece and creates a new state in the superposition. This operation corresponds to

$$\vert 01 , 0 , 10 ⟩ {->}^{{\hat{S}}^{3}} \frac{1}{\sqrt{3}} \vert 01 , 0 , 11 ⟩ + \sqrt{\frac{2}{3}} \vert 01 , 0 , 10 ⟩$$

Next, the two states affected by the SP operator are processed by the SAVE operator of the algorithm. This makes the state with the smaller coefficient a permanent representation of the pattern being processed and resets the other to generate a new state for the next pattern. At this point one pass through the loop of the algorithm has been performed.

$$\frac{1}{\sqrt{3}} \vert 01 , 0 , 01 ⟩ + \sqrt{\frac{2}{3}} \vert 01 , 0 , 00 ⟩ {->}^{SAVE} \frac{1}{\sqrt{3}} \vert 01 , 0 , 01 ⟩ + \sqrt{\frac{2}{3}} \vert 01 , 0 , 00 ⟩$$

Now, the entire process is repeated for the second pattern. Again, the x register of the appropriate state (that state whose c₂ qubit is in the state |0 [symbol] ) is selectively flipped to match the new pattern. Notice that this time the generator state has its x—register in a state corresponding to the pattern that was just processed. Therefore, the selective qubit state flipping occurs for those qubits that correspond to bits in which the first and second patterns differ—both in this case:

$${->}^{FLIP} \frac{1}{\sqrt{3}} \vert 01 , 0 , 01 ⟩ + \sqrt{\frac{2}{3}} \vert 10 , 0 , 10 ⟩$$

Next, another Sp operator is applied to generate a representative state for the new pattern:

$${->}^{{\hat{S}}^{2}} \frac{1}{\sqrt{3}} \vert 01 , 0 , 01 ⟩ + \frac{1}{\sqrt{2}} \sqrt{\frac{2}{3}} \vert 10 , 0 , 11 ⟩ + \frac{1}{\sqrt{2}} \sqrt{\frac{2}{3}} \vert 10 , 0 , 10 ⟩ .$$

Again, the two states just affected by the Ŝ^{p} operator are operated on by the SAVE operator, the one being made permanent and other being reset to generate a new state for the next pattern,

$${->}^{SAVE} \frac{1}{\sqrt{3}} \vert 01 , 0 , 01 ⟩ + \sqrt{\frac{1}{3}} \vert 10 , 0 , 01 ⟩ + \sqrt{\frac{1}{3}} \vert 10 , 0 , 00 ⟩$$

Finally, the third pattern is considered and the process is repeated a third time. The x register of the generator state is again selectively flipped. In this time, only those qubits corresponding to bits that differ in the second and third patterns are flipped, in this case just qubit x₂

$${->}^{FLIP} \frac{1}{\sqrt{3}} \vert 01 , 0 , 01 ⟩ + \sqrt{\frac{1}{3}} \vert 10 , 0 , 01 ⟩ + \sqrt{\frac{1}{3}} \vert 11 , 0 , 10 ⟩$$

Again a new state is generated to represent this third pattern.

$${->}^{{\hat{S}}^{3}} \frac{1}{\sqrt{3}} \vert 01 , 0 , 01 ⟩ + \frac{1}{\sqrt{3}} \vert 10 , 0 , 01 ⟩ + \frac{1}{\sqrt{1}} \sqrt{\frac{1}{3}} \vert 10 , 0 , 11 ⟩ + \sqrt{\frac{0}{1}} \sqrt{\frac{1}{3}} \vert 10 , 0 , 10 ⟩$$

Finally, proceed once again with the SAVE operation.

$${->}^{SAVE} \frac{1}{\sqrt{3}} \vert 01 , 0 , 01 ⟩ + \sqrt{\frac{1}{3}} \vert 10 , 0 , 01 ⟩ + \sqrt{\frac{1}{3}} \vert 11 , 0 , 01 ⟩$$

At this point, notice that the states of the g and c registers for all the states in the superposition are the same. This means that these registers are in no way entangled with the x register, and therefore since they no longer needed they may be ignored without affecting the outcome of father operations on the x register. Thus, the simplified representation of the quantum state of the system is

$$- \frac{1}{\sqrt{3}} \vert 01 ⟩ + \sqrt{\frac{1}{3}} \vert 10 ⟩ - \sqrt{\frac{1}{3}} \vert 11 ⟩$$

and it may be seen that the set of patterns p is now represented as a quantum superposition in the x register.

In the quantum network representation of the algorithm the FLIP operator is composed of the \hat{F}⁰ operators left of the Ŝ^{p} and the question marks signify that the operator is applied only if the qubit's states differs from the value of the corresponding bit in the pattern being processed. The SAVE operator is composed of the Â operators and the \hat{F}¹ to the right of Ŝ^{p}. The network shown is simply repeated for additional patterns.

In looking for the state |0110 [symbol] , assume that the first two steps of the algorithm (which initialize the system to the uniform distribution) have not been performed, but that instead initial state is described by

$$\vert ψ ⟩ = \frac{1}{\sqrt{6}} ( 1 , 0 , 0 , 1 , 0 , 0 , 1 , 0 , 0 , 1 , 0 , 0 , 1 , 0 , 0 , 1 )$$

that is superposition of only 6 of the possible 16 basis states. The first time through the loop, inverts the phase of the state |τ [symbol] =|0110 [symbol] resulting in

$$\vert ψ ⟩ {->}^{{\hat{I}}_{τ}} \vert ψ ⟩ = \frac{1}{\sqrt{6}} ( 1 , 0 , 0 , 1 , 0 , 0 , - 1 , 0 , 0 , 1 , 0 , 0 , 1 , 0 , 0 , 1 )$$

and then rotates all the basis states about the average, which is

$$\frac{1}{4 \sqrt{6}} ,$$

so

$$\vert ψ ⟩ {->}^{\hat{G}} \vert ψ ⟩ = \frac{1}{2 \sqrt{6}} ( - 1 , 1 , 1 , - 1 , 1 , 1 , 3 , 1 , 1 , - 1 , 1 , 1 , - 1 , 1 , 1 , - 1 )$$

The second time through the loop, again rotates the phase of the desired state giving

$$\vert ψ ⟩ {->}^{\hat{I}} \vert ψ ⟩ = \frac{1}{2 \sqrt{6}} ( - 1 , 1 , 1 , - 1 , 1 , 1 , - 3 , 1 , 1 , - 1 , 1 , 1 , - 1 , 1 , 1 , - 1 )$$

and then again rotates all the basis states about the average which now is

$$\frac{1}{16 \sqrt{6}}$$

so that

$$\vert ψ ⟩ {->}^{\hat{G}} \vert ψ ⟩ = \frac{1}{8 \sqrt{6}} ( 5 , - 3 , - 3 , 5 , - 3 , - 3 , 13 , - 3 , - 3 , 5 , - 3 , - 3 , 5 , - 3 , - 3 , 5 )$$

Now squaring the coefficients gives the probability of collapsing into the corresponding state. In this case, the chance of collapsing into the |τ [symbol] =|0110 [symbol] basis state is 0.66²≈44%.

The chance of collapsing into one of the 15 basis states that is not desired state is approximately 56%. This chance of success is much worse than that seen in above described example, and the reason for this is that there are now two types of undesirable states: those that existed in the superposition to start with but that are not the state we are looking for and those that were not in the original superposition but were introduced into the superposition by the Ĝ operator. The problem comes from the fact that these two types of undesirable states acquire opposite phases and thus to some extent cancel each other out. Therefore, during the rotation about average performed by the Ĝ operator the average is smaller than it should be if it were to just represent the states in the original superposition. As a result, the desired state is rotated about a sub-optimal average and never gets as large a probability associated with it as it should. An analytic expression for the maximum possible probability using Grover's algorithm on an arbitrary starting distribution is

$${P}_{max} = 1 - {\sum }_{j = r + 1}^{N} {\vert {l}_{j} - \overline{l} \vert}^{2} ,$$

where N is the total number of basis states, r is the number of desired states (looking for more than one state is another extension to the original algorithm), lⱼ is the initial amplitude of state j, and they assume without loss of generality that the desired states are number 1 to r and the other states are numbered r+1 to N. \overline{l} is the average amplitude of all the undesired states, and therefore the second term of this equation is proportional to the variance in the amplitudes. The theoretical maximum is, in practice, an upper bound.

Now consider the case of the initial distribution. The variance is proportional to 10·0.13²+5·0.28²=0.56 and thus Pₘₐₓ=0.44. In order to rectify this problem, Grover's algorithm is modified. The difference between this and Grover's original algorithm is first, the algorithm does not begin with the state |\overline{0} [symbol] and transform it into the uniform distribution (such as would be the result of the pattern storage algorithm described above). The second modification, is that the second state rotation operator not only rotates the phase of desired states but also rotates the phases of all the stored pattern states as well. This forces the two different kinds of non-desired states to have the same phase, rather than opposite phases as in the original algorithm. Then one can consider the state of the system as the input into the normal loop of Grover's algorithm.

The number of strings in a population matching (or belonging to) a schema is expected to vary from one generation to the next according to the following theorem:

$$E [ m ( H , t + 1 ) ] \geq m ( H , t ) \cdot \underbrace{\frac{f ( H , t )}{\overline{f} ( t )}}_{Selection} \cdot \underbrace{{( 1 - {p}_{m} )}^{O ( H )}}_{Mutation} \cdot [ \underbrace{1 - \overbrace{{p}_{c} \frac{L ( H )}{N - 1} ( 1 - \frac{m ( H , t ) f ( H , t )}{M \overline{f} ( t )} )}^{{P}_{d} ( H , t )}}_{Crossover} ] \qquad ( 10.1 )$$

where m (H,t) is the number of strings matching the schema H at generation t, f(H,t) is the mean fitness of the strings matching H, \overline{f}(t) is the mean fitness of the strings in the population, pₘ is the probability of mutation per bit, p_{c} is the probability of crossover, N is the number of bits in the strings, M is the number of strings in the population, and E[m(H, t+1)] is the expected number of strings matching the schema H at generation t+1. This is slightly different version of Holland's original theorem. Equation (10.1) applies when crossover is performed taking both parents from the mating pool. The three horizontal curly brackets beneath the equation indicate which operators are responsible for each term. The bracket above the equation represents the probability of disruption of the schema H at generation t due to crossover P_{d}(H,t). Such a probability depends on the frequency of the schema in the mating pool but also on the intrinsic fragility of the schema L(H)/(N-l).

As stated above, the GA searches for a global optimum in a single solution space. It is desirable, however, to search for a global optimum in multiple solution spaces to find a “universal” optimum. A Quantum Genetic Search Algorithm (QGSA) provides the ability to search multiple spaces simultaneously (as described below). The QGSA searches several solution spaces, simultaneously, in order to find a universal optimum, that is, a solution that is optimal considering all solution spaces.

The structure of quantum search algorithm can be described as

$$G = {[ \overbrace{( Int ⊗ {I}_{m} )}^{Interference} ∘ \underbrace{{U}_{F}}_{Entanglement} ]}^{h + 1} ∘ ( \underbrace{{H}_{n} ⊗ {S}_{m}}_{Superposition} ) \qquad ( 10.2 )$$

In quantum algorithm structures and genetic algorithms structure have the following interrelations:

$$\begin{matrix}GA : E [ m ( H , t + 1 ) ] \geq m ( H , t ) \cdot \underbrace{\underbrace{\frac{f ( H , t )}{\overline{f} ( t )}}_{Selection} \cdot \cdot [ \underbrace{1 - \overbrace{{p}_{c} \frac{L ( H )}{N - 1} ( 1 - \frac{m ( H , t ) f ( H , t )}{M \overline{f} ( t )} )}^{{P}_{d} ( H , t )}}_{Crossover} ]}_{⇕} \underbrace{\underbrace{{( 1 - {p}_{m} )}^{O ( H )}}_{Mutation}}_{⇕} \\ QA ( Gate ) : {[ \overbrace{( Int ⊗ {I}_{m} )}^{Interference} ∘ {{U}_{F}}^{\overbrace{Entanglement}} ]}^{h + 1} ∘ ( \underbrace{{H}_{n} ⊗ {S}_{m}}_{Superposition} ) \end{matrix} \qquad ( 10.3 )$$

FIG. 25 illustrates the similarities between a GA and a QSA. As shown in FIG. 25, in the GA search, a solution space 2501 leads to an initial position (input) 2502. The initial position 2502 is coded into binary strings using a binary coding scheme 2510. GA operators such as selection 2503, crossover 2504, and mutation 2505 are applied to the coded strings to generate a population. Through a fitness function 2506 (such as a fitness function based on minimum entropy production or some other desirable property) a global optimum for the space 2501 is found.

By contrast, in the QSA shown in FIG. 25, a group of N solution spaces 2550 are used to create an initial position (input) 2551. Quantum operators such as superposition 2552, entanglement 2553, and interference 2554 operate on the initial position to produce a measurement. Superposition is created using a Hadamard transformation 2561 (a one-bit operation). Entanglement is created through a Controlled-NOT operation 2562 (a two-bit operation). Interference is created through a Quantum Fourier Transform (QFT) 2563. Using the quantum operators, a universal optimum for covering all the spaces in the group 2550 is found.

Thus, the classical process of selection is loosely analogous to the quantum process of creating a superposition. The classical process of crossover is loosely analogous to the quantum process of entanglement. The classical process of mutation is loosely analogous to the quantum process of interference.

In the GA a starting population is randomly generated. Mutation and crossover operators are then applied in order to change the genome of some individuals and create some new genomes. Some individuals are then cut off according to a fitness function and selection of good individuals is used to generate a new population. The procedure is then repeated on this new population until an optimum is found.

By analogy, in the QSA an initial basis vector is transformed into a linear superposition of basis vector by the superposition operator. Quantum operators such as entanglement and interference then act on this superposition of states generating a new superposition where some states (the non-interesting states) have reduced their probability amplitude in modulus and some other states (the most interesting) have increased probability amplitude. The process is repeated several times in order to get to a final probability distribution where an optimum can be easily observed.

The quantum entanglement operator acts in analogy to the genetic mutation operator: in fact it maps every basis vector in the entering superposition into another basis vector by flipping some bits in the ket label. The quantum interference operator acts like the genetic crossover operator by building a new superposition of basis states from the interaction of the probability amplitudes of the states in the entering superposition. But the interference operator includes also the selection operator. In fact, interference increases the probability amplitude modulus of some basis states and decreases the probability amplitude modulus of some other ones according to a general principle, that is maximizing the quantity

$${𝔍}_{T} ( \vert output ⟩ ) = 1 - \frac{{E}_{T}^{Sh} ( \vert output ⟩ ) - {E}_{T}^{VN} ( \vert output ⟩ )}{\vert T \vert} \qquad ( 10.4 )$$

with T={1, . . . , n} This quantity is called the intelligence of the output state and it measures how the information encoded into quantum correlation by entanglement is accessible by measurement. The role of the interference operator is, in fact, to preserve the Von Neumann entropy of the entering entangled state and to reduce (minimize) the Shannon entropy, which has been increased to its maximum by the superposition operator. Note that there is a strong difference between GA and QSA: in GA the fitness functions changes with different instances of the same problem, whereas mutation and crossover are always random. In the QSA, the fitness function is always the same (the intelligence of the output state), whereas the entanglement operator strongly depends on the input function f.

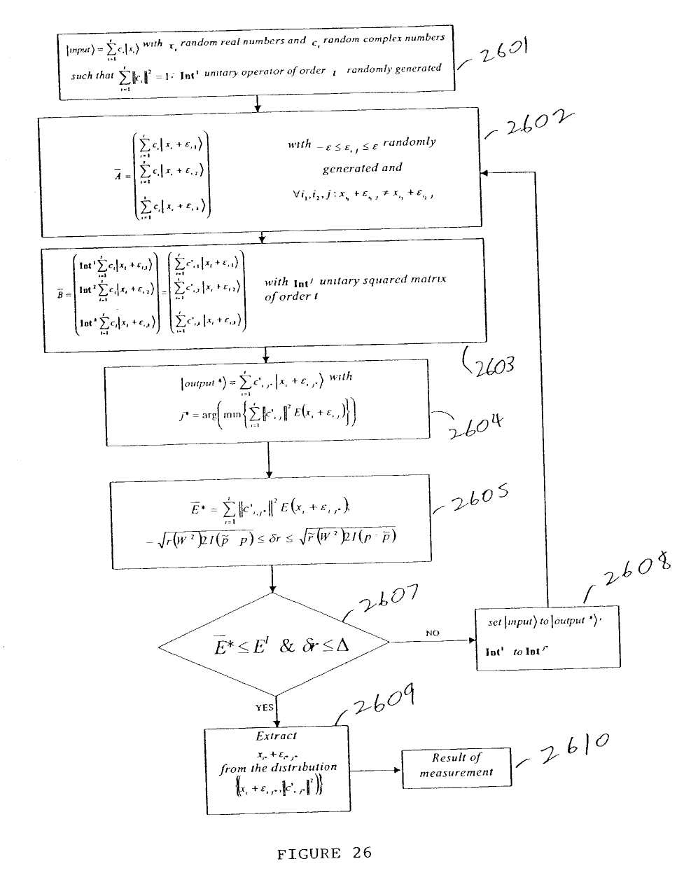

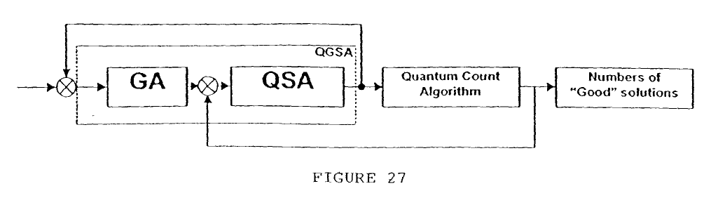

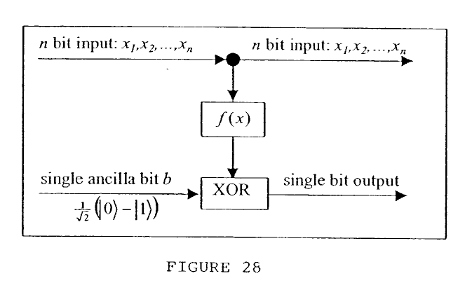

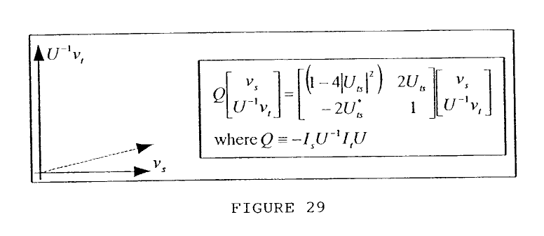

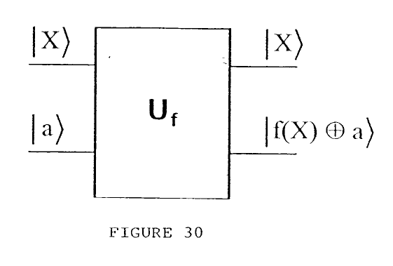

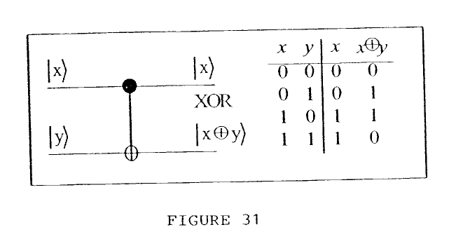

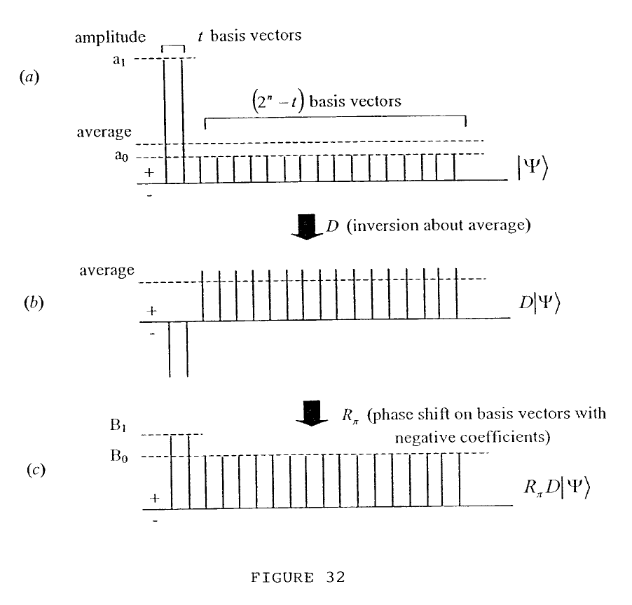

The QGSA merges the two schemes of GA and QSA. FIG. 26 is a flowchart showing the structure of the QGSA. In FIG. 26, an initial superposition with t random non-null probability amplitude values is generated

$$\vert input ⟩ = {\sum }_{i = 1}^{t} {c}_{i} \vert {x}_{i} ⟩ \qquad ( 10.5 )$$

Every ket corresponds to an individual of the population and in the general case is labelled by a real number. So, every individual corresponds to a real number xᵢ and is implicitly weighted by a probability amplitude value cᵢ. The action of the entanglement and interference operators is genetically simulated: k different paths are randomly chosen, where each path corresponds to the application of an entanglement and interference operator.

The entanglement operator includes an infective map transforming each basis vector into another basis vector. This is done by defining a mutation ray ε>0 and extracting t different values εₗ, . . . , εₜ such that −ε≦εᵢ≦ε. Then the entanglement operator U_{F}^{j} for path t is defined by the following transformation rule:

$$\vert {x}_{i} ⟩ {\to }^{{U}_{F}^{J}} \vert {x}_{i} + {ϵ}_{i} ⟩ \qquad ( 10.6 )$$

When U_{F}^{j} acts on the initial linear superposition, all basis vectors in it undergo mutation

$$\vert ψ ⟩ = {\sum }_{i = 1}^{t} {c}_{i} \vert {x}_{i} + {ϵ}_{i} ⟩ \qquad ( 10.7 )$$

The mutation operator ε can be described as following relation

$$ϵ = \{ \begin{matrix}1 & for & bit & permutation & 0 \\ 0 & for & bit & permutation & 1 \\ - 1 & for & phase & permutation & \end{matrix} \qquad ( 10.8 )$$

Assume, for example, there are eight states in the system, encoded in binary as 000, 001, 010, 011, 100, 110, 111. One of the possible states that may be found during a computation is

$$\frac{i}{\sqrt{2}} \vert 000 ⟩ + \frac{1}{\sqrt{2}} \vert 100 ⟩ + \frac{1}{\sqrt{2}} \vert 110 ⟩ .$$

A unitary transform is usually constructed so that it is performed at the bit level. For example, the unitary transformation

$$\begin{matrix}0 \\ 1\end{matrix} {( \begin{matrix}0 & 1 \\ 1 & 0\end{matrix} )}^{0 \; 1}$$

will switch the state |0 [symbol] to |1 [symbol] and |1 [symbol] to |0 [symbol] (NOT operator).

Mutation of a chromosome in the GA alters one or more genes. It can also be described by changing the bit at a certain position or positions. Switching the bit can be simply carried out by the unitary NOT-transform. The unitary transformation that acts, as example on the last two bits will transform the state |1001 [symbol] to state |1011 [symbol] and the state |0111 [symbol] to the state |0101 [symbol] and so on can be described as the following matrix

$$\begin{matrix}00 \\ 01 \\ 10 \\ 11\end{matrix} ( \begin{matrix}{1}^{00} & {0}^{01} & {0}^{10} & {0}^{11} \\ 0 & 0 & 0 & 1 \\ 0 & 0 & 1 & 0 \\ 0 & 1 & 0 & 0\end{matrix} ) \qquad ( 10.9 )$$

which is a mutation operator for the set of vectors |0000 [symbol] , |0001 [symbol] , . . . , |1111 [symbol] .

A phase shift operator Z can be described as the following

$$Z \text{:} \begin{matrix}\vert 0 ⟩ & \to & \vert 0 ⟩ \\ \vert 1 ⟩ & \to & - \vert 1 ⟩\end{matrix}$$

and an operator

$$Y \text{:} \begin{matrix}\vert 0 ⟩ & \to & \vert 1 ⟩ \\ \vert 1 ⟩ & \to & - \vert 0 ⟩\end{matrix}$$

is a combination of negation NOT and a phase shift operator Z.

As an example, consider the following matrix

$$\begin{matrix}00 \\ 01 \\ 10 \\ 11\end{matrix} ( \begin{matrix}{1}^{00} & {0}^{01} & {0}^{10} & {0}^{11} \\ 0 & 1 & 0 & 0 \\ 0 & 0 & 0 & 1 \\ 0 & 0 & 1 & 0\end{matrix} ) \qquad ( 10.10 )$$

which operates a crossover on the last two bits transforming 1011 and 0110 in 1010 and 0111, where the cutting point is at the middle (one-point crossover).

The two-bit conditional phase shift gate has the following matrix form

$$\begin{matrix}00 \\ 01 \\ 10 \\ 11\end{matrix} ( \begin{matrix}{1}^{00} & {0}^{01} & {0}^{10} & {0}^{11} \\ 0 & 1 & 0 & 0 \\ 0 & 0 & 1 & 0 \\ 0 & 0 & 0 & {ⅇ}^{ⅈ φ}\end{matrix} )$$

and the controlled NOT (CNOT) gate that can created entangled states is described by the following matrix:

$$CNOT \text{:} \begin{matrix}\vert 00 ⟩ & \to & \vert 00 ⟩ \\ \vert 01 ⟩ & \to & \vert 01 ⟩ \\ \vert 10 ⟩ & \to & \vert 11 ⟩ \\ \vert 11 ⟩ & \to & \vert 10 ⟩\end{matrix} ⇒ \begin{matrix}00 \\ 01 \\ 10 \\ 11\end{matrix} ( \begin{matrix}{1}^{00} & {0}^{01} & {0}^{10} & {0}^{11} \\ 0 & 1 & 0 & 0 \\ 0 & 0 & 0 & 1 \\ 0 & 0 & 1 & 0\end{matrix} )$$

The interference operator Int¹ is chosen as a random unitary squared matrix of order t whereas the interference operators for the other paths are generated from Int¹ according to a suitable law. Examples of such matrices are the Hadamard transformation matrix Hₜ and the diffusion matrix Dₜ, that have been defined above. The application of entanglement and interference operators produces a new superposition of maximum length t:

$$\vert {output}^{j} ⟩ = {\sum }_{i = 1}^{t} {c}_{i , j}^{′} \vert {x}_{i} + {ϵ}_{i , j} ⟩ \qquad ( 10.11 )$$

The average entropy value for this state is now evaluated. Let E(x) be the entropy value for individual x. Then

$$E ( \vert {output}^{j} ⟩ ) = {\sum }_{i = 1}^{t} {‖ {c}_{i , j}^{′} ‖}^{2} E ( {x}_{i} + {ϵ}_{i , j} ) \qquad ( 10.12 )$$

The average entropy value is calculated by averaging every entropy value in the superposition with respect to the squared modulus of the probability amplitudes.

According to this sequence of operations, k different superpositions are generated from the initial one using different entanglement and interference operators. Every time the average entropy value is evaluated. Selection involves keeping only the superposition with minimum average entropy value. When this superposition is obtained, it becomes the new input superposition and the process starts again. The interference operator that has generated the minimum entropy superposition is kept and Int¹ is set to this operator for the new step. The computation stops when the minimum average entropy value falls under a given critical limit. At this point measurement is simulated, that is a basis value is extracted from the final superposition according to the squared modulus of its probability amplitude. The algorithm is shown in FIG. 26 as follows:

$$1. \vert input ⟩ = {\sum }_{i = 1}^{t} {c}_{i}^{′} \vert {x}_{i} ⟩$$

with xᵢ random real numbers and cᵢ random complex numbers such that

$${\sum }_{i = 1}^{t} {‖ {c}_{i} ‖}^{2} = 1 ;$$

Int¹ unitary operator of order t randomly generated (block 2601);

$$2. \overline{A} = ( \begin{matrix}{\sum }_{i = 1}^{t} {c}_{i} \vert {x}_{i} + {ϵ}_{i , 1} ⟩ \\ {\sum }_{i = 1}^{t} {c}_{i} \vert {x}_{i} + {ϵ}_{i , 2} ⟩ \\ … \\ {\sum }_{i = 1}^{t} {c}_{i} \vert {x}_{i} + {ϵ}_{i , k} ⟩\end{matrix} )$$

with −ε≦ε_{i,j}≦ε randomly generated and ∀iₗ, i₂, j:xᵢ_{₁}+ε₁_{ₗ}_{,j}≠xᵢ_{₂}+εᵢ_{₂}ⱼ (block 2602);

$$3. B = ( \begin{matrix}{Int}^{1} {\sum }_{i = 1}^{t} {c}_{i} \vert {x}_{i} + {ϵ}_{i , 1} ⟩ \\ {Int}^{2} {\sum }_{i = 1}^{t} {c}_{i} \vert {x}_{i} + {ϵ}_{i , 2} ⟩ \\ … \\ {Int}^{k} {\sum }_{i = 1}^{t} {c}_{i} \vert {x}_{i} + {ϵ}_{i , k} ⟩\end{matrix} ) = ( \begin{matrix}{\sum }_{i = 1}^{t} {c}_{i , 1}^{′} \vert {x}_{i} + {ϵ}_{i , 1} ⟩ \\ {\sum }_{i = 1}^{t} {c}_{i , 2}^{′} \vert {x}_{i} + {ϵ}_{i , 2} ⟩ \\ … \\ {\sum }_{i = 1}^{t} {c}_{i , k}^{′} \vert {x}_{i} + {ϵ}_{i , k} ⟩\end{matrix} )$$

with Int^{j} unitary squared matrix of order t (block 2603);

$$4. \vert {output}^{*} ⟩ = {\sum }_{i = 1}^{t} {c}_{i , {j}^{*}}^{′} \vert {x}_{i} + {ϵ}_{i , {j}^{*}} ⟩ with {j}^{*} = arg ( min \{ {\sum }_{i = 1}^{t} {‖ {c}_{i , j}^{′} ‖}^{2} E ( {x}_{i} + {ϵ}_{i , j} ) \} ) ( block 2604 ) ;$$

$$5. {\overline{E}}^{*} = {\sum }_{i = 1}^{t} {‖ {c}_{i , {j}^{*}}^{′} ‖}^{2} E ( {x}_{i} + {ϵ}_{i , {j}^{*}} ) ( block 2605 )$$

6. If \overline{E}*<E¹ and information risk increment is lower than a pre-established quantity Δ then extract x_{i*}+ε_{i*,j*} from the distribution {(xᵢ+ε_{i,j*}, ∥c¹_{i,j*}∥²)}; (block 2609)

7. Else set |input [symbol] to |output * [symbol] , Int¹ to Int^{j*} (block 2608) and go back to step 2 (block 2602).

Step 6 includes methods of accuracy estimation and reliability measurements of the successful result.

The simulation of the quantum search algorithm is represented through information flow analysis, information risk increments and entropy level estimations:

1) Applying a quantum gate G on the input vector stores information into the system state, minimizing the gap between the classical Shannon entropy and the quantum Von Neumann entropy;

2) Repeating the step of applying the calculation (estimation) of information risk increments (see below);

3) Measuring the basis vector for estimation of the level of the average entropy value;

4) Decoding the basis vector of a successful result for computation time stopping when the minimum average entropy value falls under a given critical level limit.

The information risk increments are calculated (estimated) according to the following formula:

−{square root over (r(W²)2I(\tilde{p})}:p)≦(δr=\tilde{r}−r)≦\sqrt{\tilde{r}}(W²)2I(p:\tilde{p})

where:

W is the loss function;

r(W²)=∫∫W²p(x,θ)dxdθ is an average risk for the corresponding probability density function p(x,θ);

x=(x₁, . . . xₙ) is a vector of measured values;

θ is an unknown parameter;

$$\cdot I ( p : \tilde{p} ) = \int \int p ( x , θ ) ln \frac{p ( x , θ )}{\tilde{p} ( x , θ )} ⅆ x ⅆ θ$$

is the relative entropy (the Kullback-Leibler measure of information divergence).

As stated above, the GA searches for a global optimum in a single solution space. As shown in FIG. 25, in the GA search, a solution space 2501 leads to an initial position (input) 2502. The initial position 2502 is coded into binary strings using a binary coding scheme 2510. GA operators of selection 2503, crossover 2504, and mutation 2505 are applied to the coded strings to generate a population. Through a fitness function 2506 (such as a fitness function based on minimum entropy production rate or some other desirable property) a global optimum for the single space 2501 is found.

The “single solution space” can include coefficient gains of the PID controller of a plant under stochastic disturbance with fixed statistical properties as the correlation function and probability density function. After stochastic simulation of dynamic behaviour of the plant under stochastic excitation with the GA one can obtain the optimal coefficient gains of intelligent PID controller only for stochastic excitation with fixed statistical characteristics. In this case the “single space of possible solutions” is the space 2501. Using a stochastic excitation on the plant, with another statistical characteristics, then the intelligent PID controller can not realize a control law with the fixed KB. In this case, a new space of possible solutions, shown as the space 2550, is defined.

If a universal look-up table for the intelligent PID controller is to be found from many single solution spaces, then the application of the GA does not give a final corrected result (the GA operators not include superposition and quantum correlation as entanglement). The GA gives the global optimum on the single solution space. In this case important information about statistical correlation between coefficient gains in the universal look-up table is lost.

By contrast, in the QSA shown in FIG. 25, a group of N solution spaces 2550 are used to create an initial position (input) 2551. Quantum operators such as superposition 2552, entanglement 2553, and interference 2554 operate on the initial position to produce a measurement. Superposition is created using a Hadamard transformation 2561 (one-bit operation). Entanglement is created through a Controlled-NOT (CNOT) operation 2562 (a two-bit operation). Interference is created through a Quantum Fourier Transform (QFT) 2563. Using the quantum operators, a universal optimum for covering all the spaces in the group 2550 is found. The structure of the QGSA with a quantum counting algorithm COUNT is shown in FIG. 27.

The structure of intelligent suspension control system is shown in FIG. 21. FIG. 33 shows a look-up table fragment simulation for the fuzzy P-controller by the GA of FIG. 21. This example shows the application of the QGSA for the optimization of a look-up table for the P-controller of a suspension system using two look-up tables. The two look-up tables from GA simulations for Gaussian and non-Gaussian (with Rayleigh probability density function) roads corresponding to the road profiles in FIGS. 4 and 6.

Stepper motors of dampers in the suspension system make the positions from the discrete interval [1, 2, . . . , 9]. In this example, there is a relation between the error control (ε) and the change of error control (\dot{ε}) as [PM→NB] for the different position states of two dampers. The two look-up tables cannot be simply averaged together. Only with a quantum approach using superposition operator the Cell1 of look-up table 1 be made logically integral with the Cell2 of look-up table 2.

Assume, for example, the selection operator of the GA codes randomly the position of a damper in the Cell1 with two last positions of the Cell2 and amplitude probability of positions in superposition is presented as [1,0,0,1,0,0,1,0,0,1,0, 0,1,0, 0,1]. The desired position is |τ [symbol] =0101 [symbol] and target positions are found with the modified Grover's algorithm presented herein.

With the modification of the quantum search algorithm described above

$$\vert ψ ⟩ = \frac{1}{\sqrt{6}} ( 1 , 0 , 0 , 1 , 0 , 0 , 1 , 0 , 0 , 1 , 0 , 0 , 1 , 0 , 0 , 1 ) .$$

The first two steps are identical to those above:

$$\vert ψ ⟩ {\to }^{{\hat{I}}_{τ}} \vert ψ ⟩ = \frac{1}{\sqrt{6}} ( 1 , 0 , 0 , 1 , 0 , 0 , - 1 , 0 , 0 , 1 , 0 , 0 , 1 , 0 , 0 , 1 ) and$$

$$\vert ψ ⟩ {\to }^{\hat{G}} \vert ψ ⟩ = \frac{1}{2 \sqrt{6}} ( - 1 , 1 , 1 , - 1 , 1 , 1 , 3 , 1 , 1 , - 1 , 1 , 1 , - 1 , 1 , 1 , - 1 ) .$$

Now, all the states present in the original superposition are phase rotated and then all states are again rotated about average:

$$\begin{matrix}\vert ψ ⟩ {\to }^{\hat{I}} \vert ψ ⟩ = \frac{1}{2 \sqrt{6}} ( \text{1,1,1,1,1,1,} - 3 , \text{1,1,1,1,1,1,1,1,1)} and \\ \vert ψ ⟩ {\to }^{\hat{G}} \vert ψ ⟩ = \frac{1}{4 \sqrt{6}} ( \text{1,1,1,1,1,1,} 9 , \text{1,1,1,1,1,1,1,1,1)} . \\ Finally , \\ \begin{matrix}\vert ψ ⟩ {\to }^{\hat{I}} \vert ψ ⟩ = \frac{1}{4 \sqrt{6}} ( \text{1,1,1,1,1,1,} - 9 , \text{1,1,1,1,1,1,1,1,1)} and \\ \vert ψ ⟩ {\to }^{\hat{G}} \vert ψ ⟩ = \frac{1}{16 \sqrt{6}} ( \text{-1,-1,-1,-1,-1,-1,} 39 , \\ \text{-1,-1,-1,-1,-1,-1,-1,-1,-1).}\end{matrix}\end{matrix}$$

Squaring the coefficients gives the probability of collapsing into the desired |τ [symbol] =|0110 [symbol] basis state as 99%—a significant improvement that is critical for the Quantum Associative Memory described in the next section.

Quantum Associative Memory Structure

A quantum associative memory (QuAM) can now be constructed from these algorithms. Define \hat{P} as an operator that implements the algorithm for memorizing patterns described above. Then the operation of the QuAM can be described as follows. Memorizing a set of patterns is simply

|ψ [symbol] =\hat{P}|\hat{0} [symbol] ,

with |ψ [symbol] being a quantum superposition of basis states, one for each pattern. Now, assume n−1 bits of a pattern are known and the goal is to recall the entire pattern. The modified Grover's algorithm can be used to recall the pattern as

$$\vert ψ ⟩ = \hat{G} \underbrace{{\hat{I}}_{τ} \hat{G} {\hat{I}}_{τ}} \vert ψ ⟩$$

followed by

|ψ [symbol] =\hat{GI}|ψ [symbol] ,

repeated T times (how to calculate T is covered in Appendix 3 and below), where τ=b₁b₂b₃? with bᵢ being the value of the i-th known bit. Since there are two states whose first three bits would match those of τ, there will be 2 states that have their phases rotated, or marked, by the Î_{τ} operator. Thus, with 2n+1 neurons (qubits) the QuAM can store up to N=2ⁿ patterns in O(mn) steps and requires O(\sqrt{N}) time to recall a pattern.

As an example of the QuAM, assume a set of patterns p={0000,0011,0110,1001,1100,1111} is known. Then using the notation of the above described example, a quantum state that stores the pattern set is created as

$$\vert \overline{0} ⟩ {\to }^{\hat{P}} \vert ψ ⟩ = \frac{1}{\sqrt{6}} ( 1 , 0 , 0 , 1 , 0 , 0 , 1 , 0 , 0 , 1 , 0 , 0 , 1 , 0 , 0 , 1 ) .$$

Now assume that the pattern whose first three bits are 011 is to be recalled. Then τ=011?, and applying this equation gives

$$\begin{matrix}\vert ψ ⟩ {\to }^{{\hat{I}}_{τ}} \vert ψ ⟩ = \frac{1}{\sqrt{6}} ( 1 , 0 , 0 , 1 , 0 , 0 , - 1 , 0 , 0 , 1 , 0 , 0 , 1 , 0 , 0 , 1 ) , \\ ↓ \\ \vert ψ ⟩ {\to }^{\hat{G}} \vert ψ ⟩ = \frac{1}{2 \sqrt{6}} ( - 1 , 1 , 1 , - 1 , 1 , 1 , 3 , 1 , 1 , - 1 , 1 , 1 , - 1 , 1 , 1 , - 1 ) , \\ ↓ \\ \vert ψ ⟩ {\to }^{\hat{{I}_{τ}}} \vert ψ ⟩ = \frac{1}{2 \sqrt{6}} ( 1 , 1 , 1 , 1 , 1 , 1 , - 3 , 1 , 1 , 1 , 1 , 1 , 1 , 1 , 1 , 1 ) , \\ ↓ \\ \vert ψ ⟩ {\to }^{\hat{G}} \vert ψ ⟩ = \frac{1}{8 \sqrt{6}} ( 1 , 1 , 1 , 1 , 1 , 1 , 17 , 9 , 1 , 1 , 1 , 1 , 1 , 1 , 1 , 1 ) .\end{matrix}$$

At his point, there is a 96.3% probability of observing the system and finding the state |011 ?). Of course there are two states that match and state |0111) has a 22% chance. This may be resolved by a standard voting scheme. Observation of the system shows that the completion of the pattern 011 is 0110.

Dynamic analysis is described here and in Appendix 4. The results of information analysis, together with dynamic evolution of quantum gate for Grover's algorithm, begins by considering the operator that encoding the input function as:

$${U}_{F} = [ \begin{matrix}I & 0 & 0 & 0 & 0 & 0 & 0 & 0 \\ 0 & C & 0 & 0 & 0 & 0 & 0 & 0 \\ 0 & 0 & I & 0 & 0 & 0 & 0 & 0 \\ 0 & 0 & 0 & I & 0 & 0 & 0 & 0 \\ 0 & 0 & 0 & 0 & I & 0 & 0 & 0 \\ 0 & 0 & 0 & 0 & 0 & I & 0 & 0 \\ 0 & 0 & 0 & 0 & 0 & 0 & I & 0 \\ 0 & 0 & 0 & 0 & 0 & 0 & 0 & I\end{matrix} ]$$

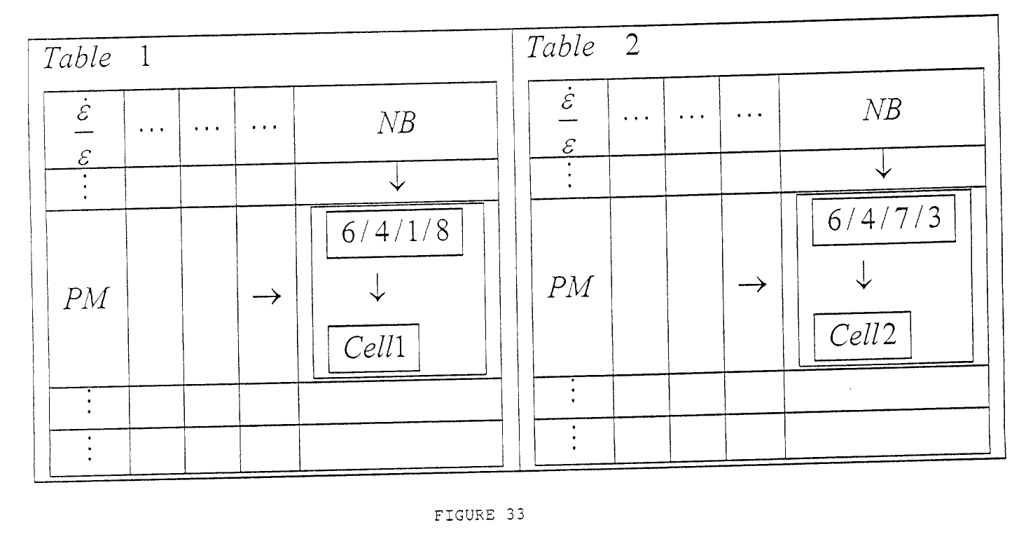

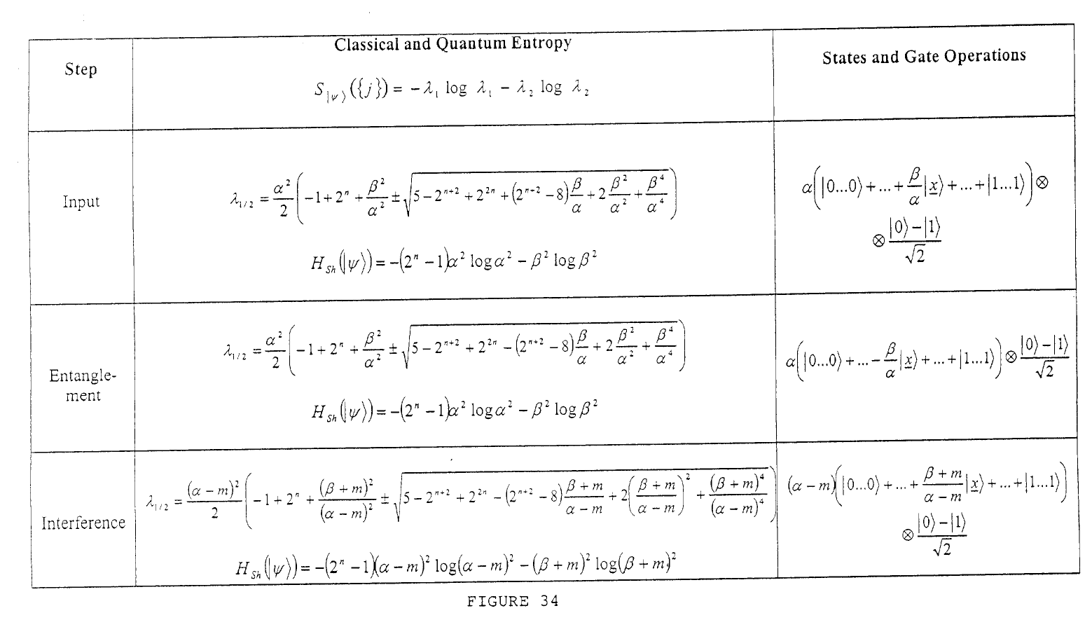

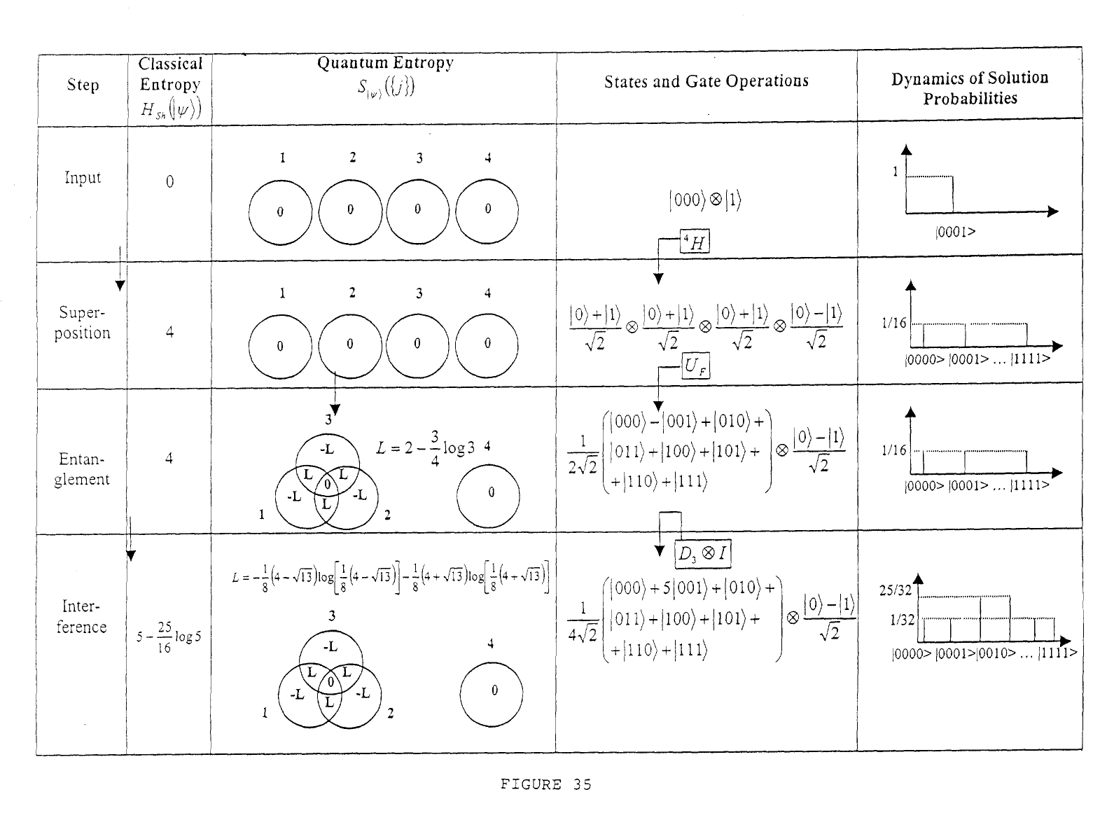

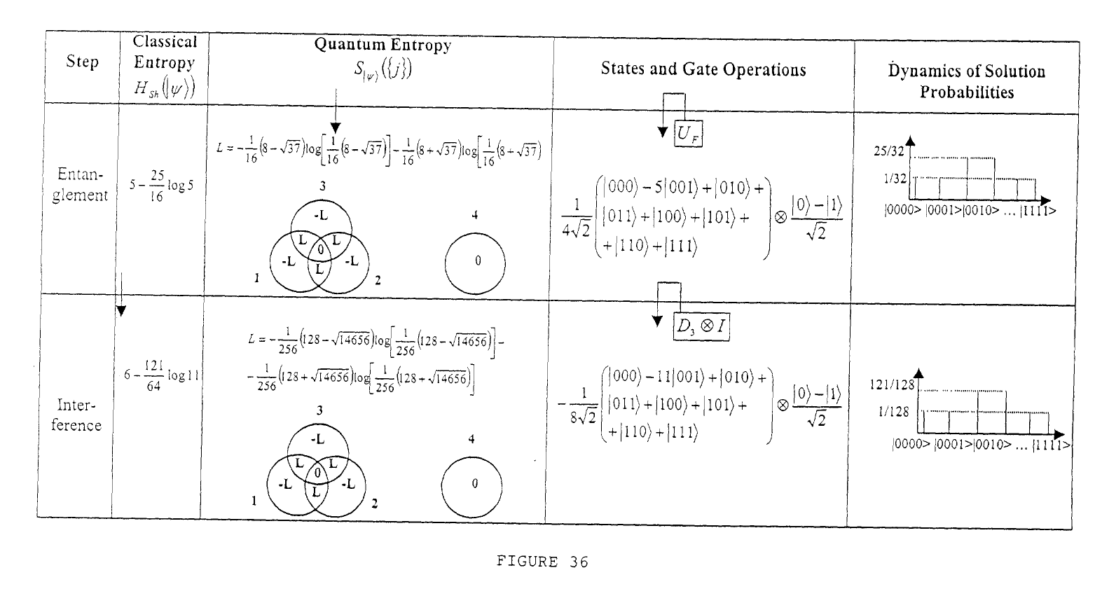

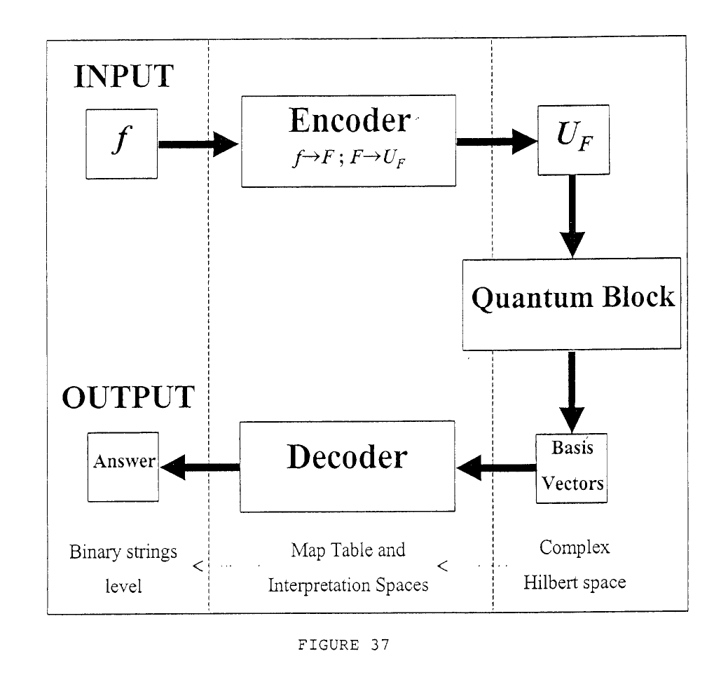

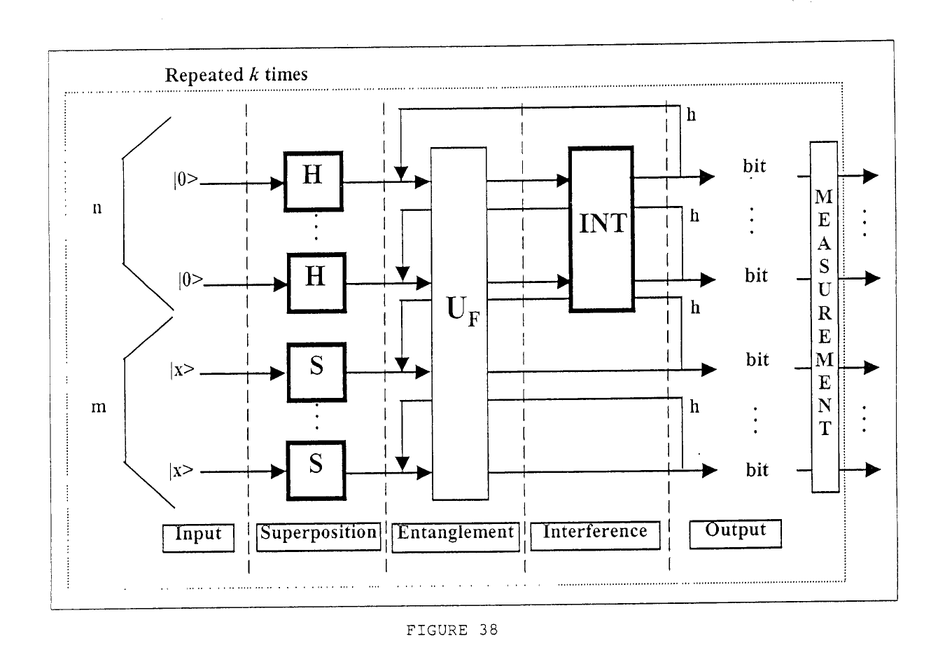

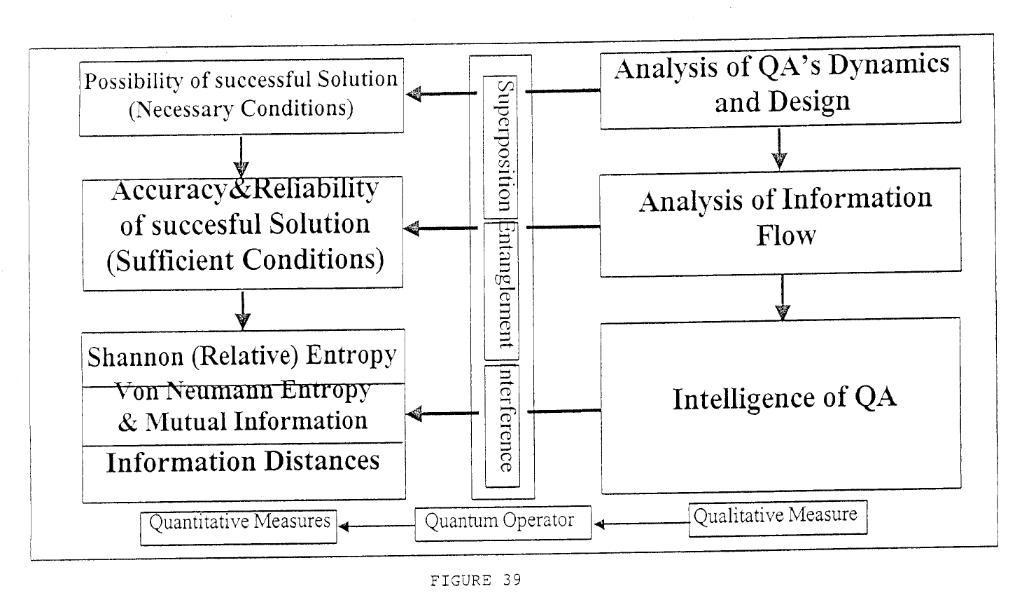

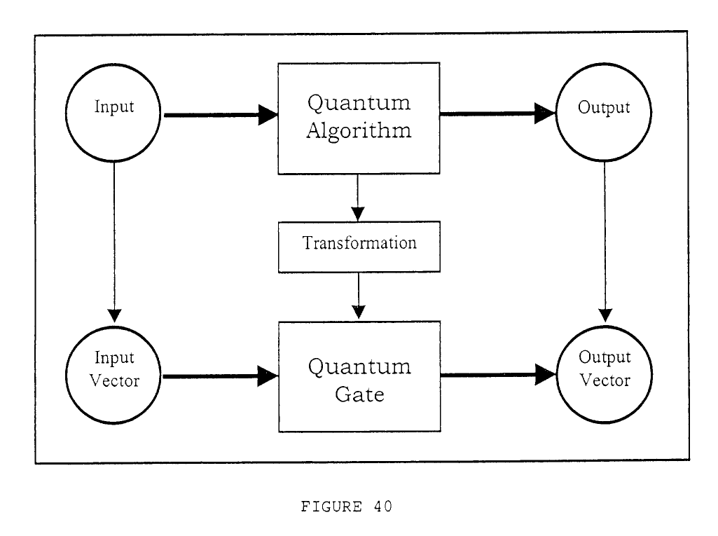

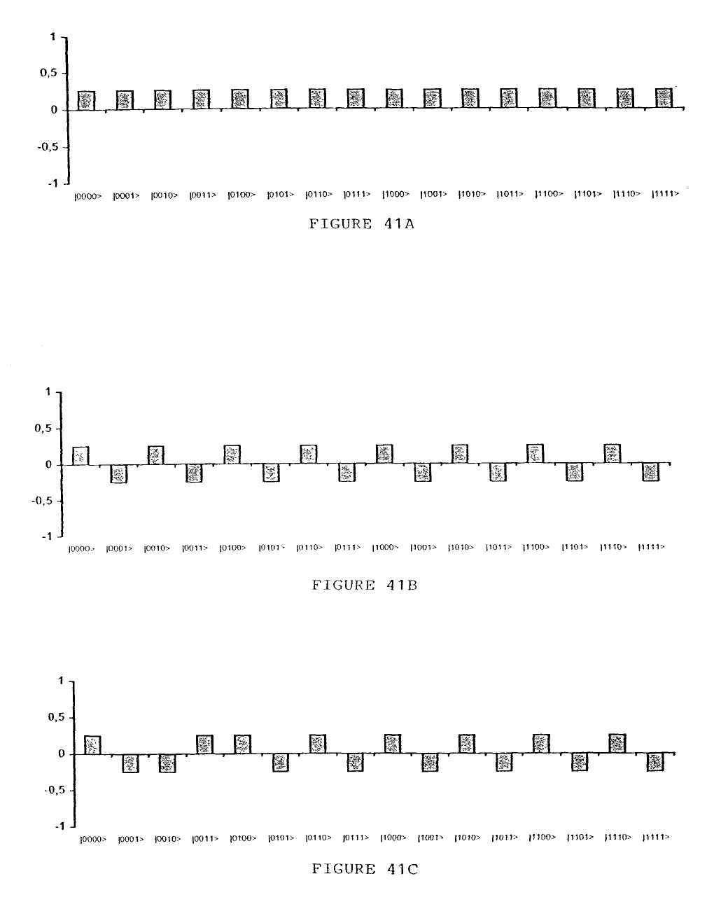

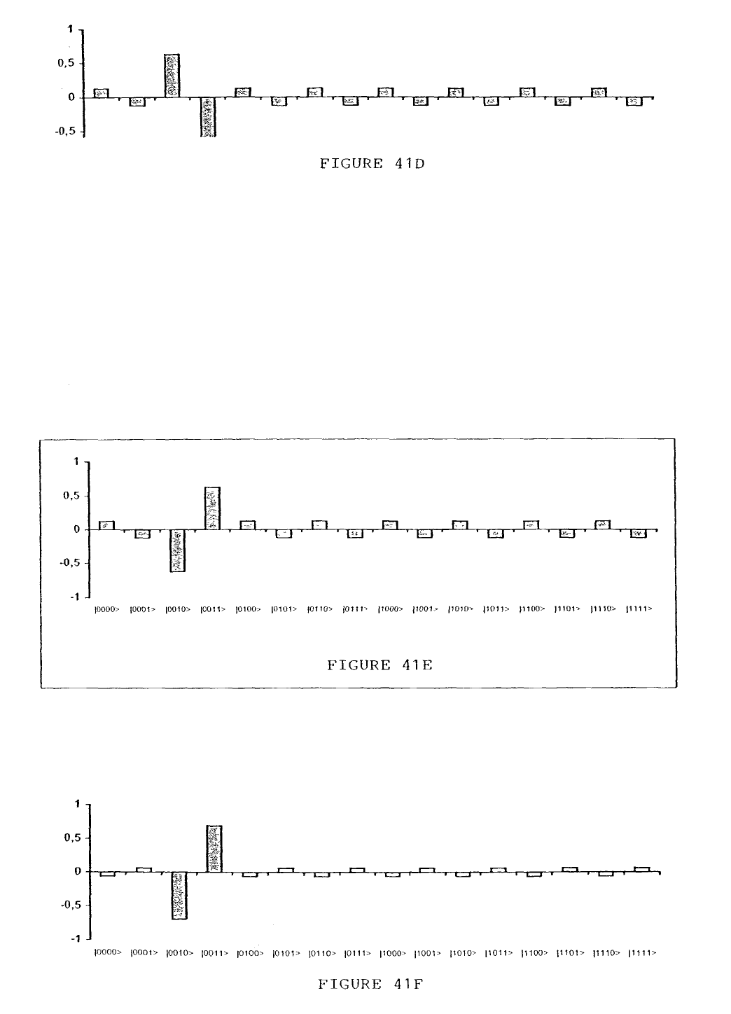

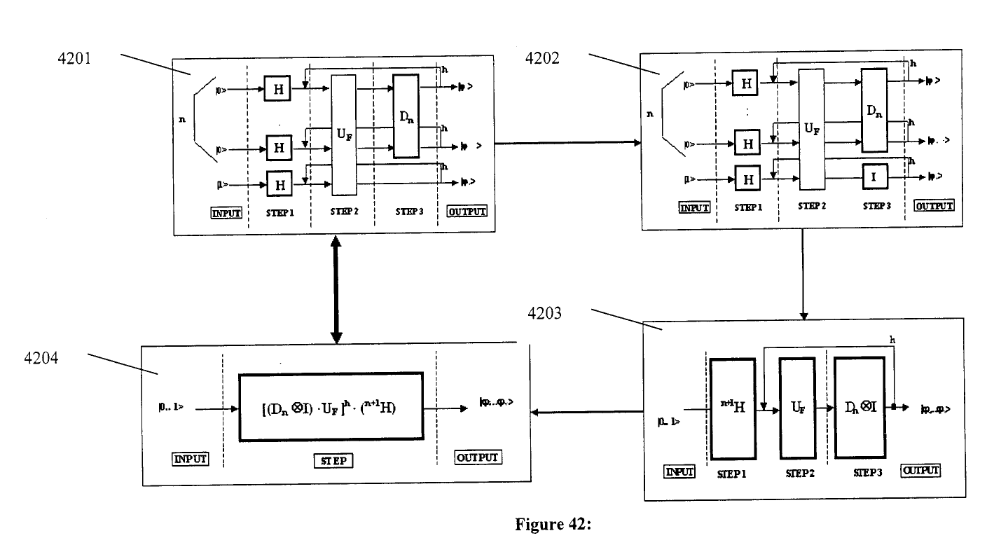

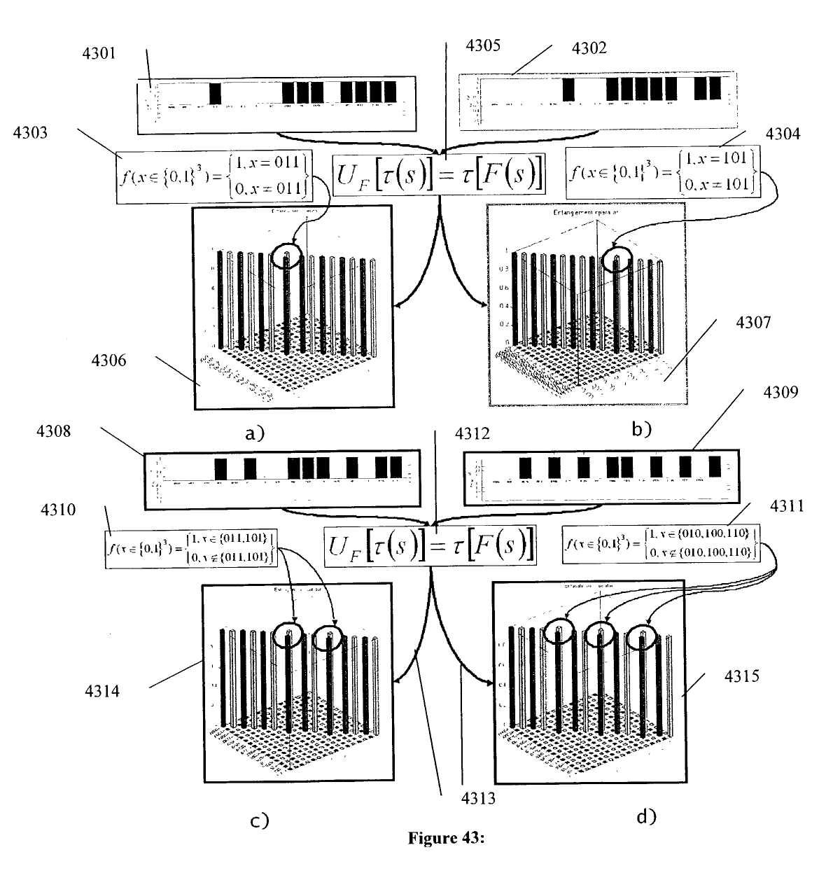

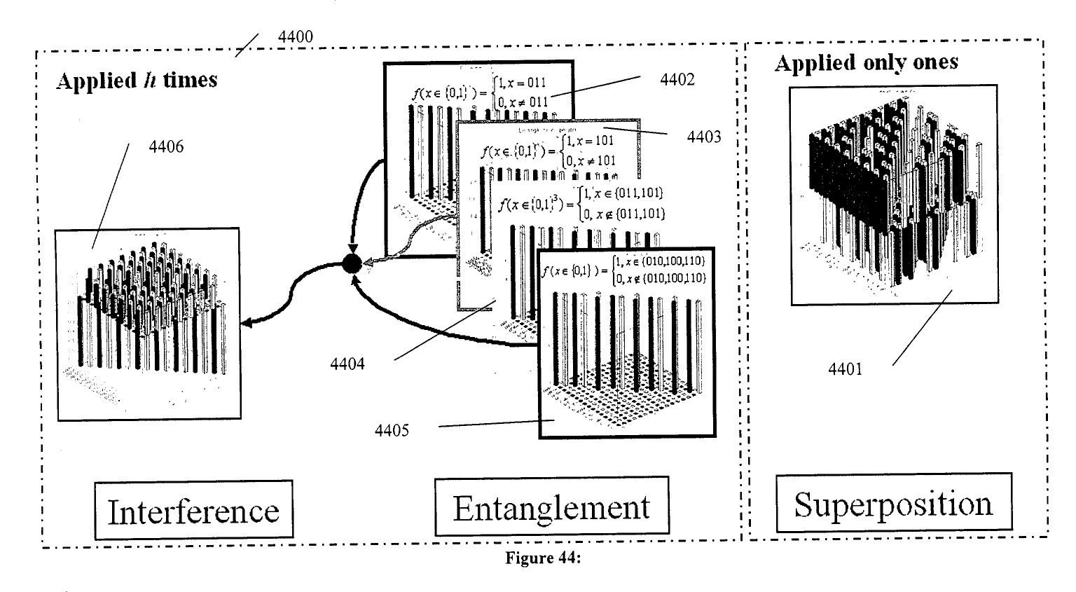

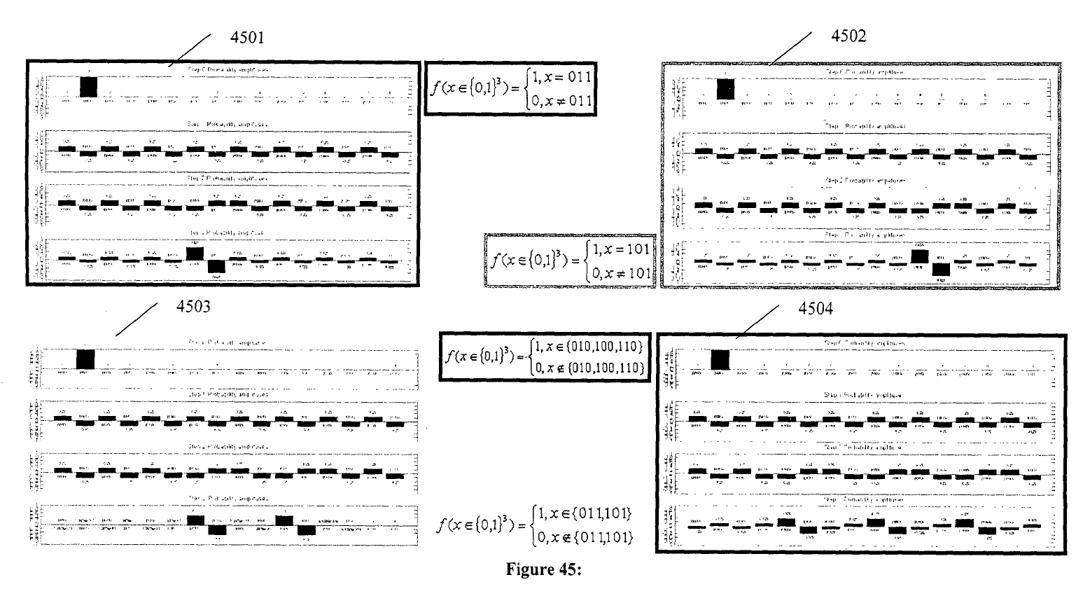

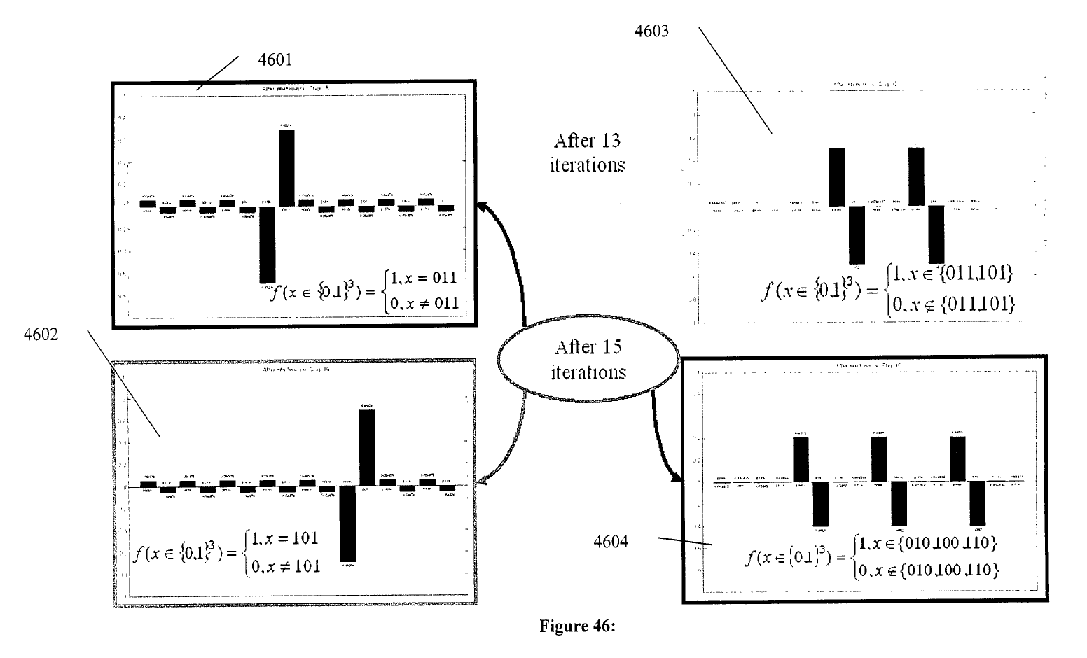

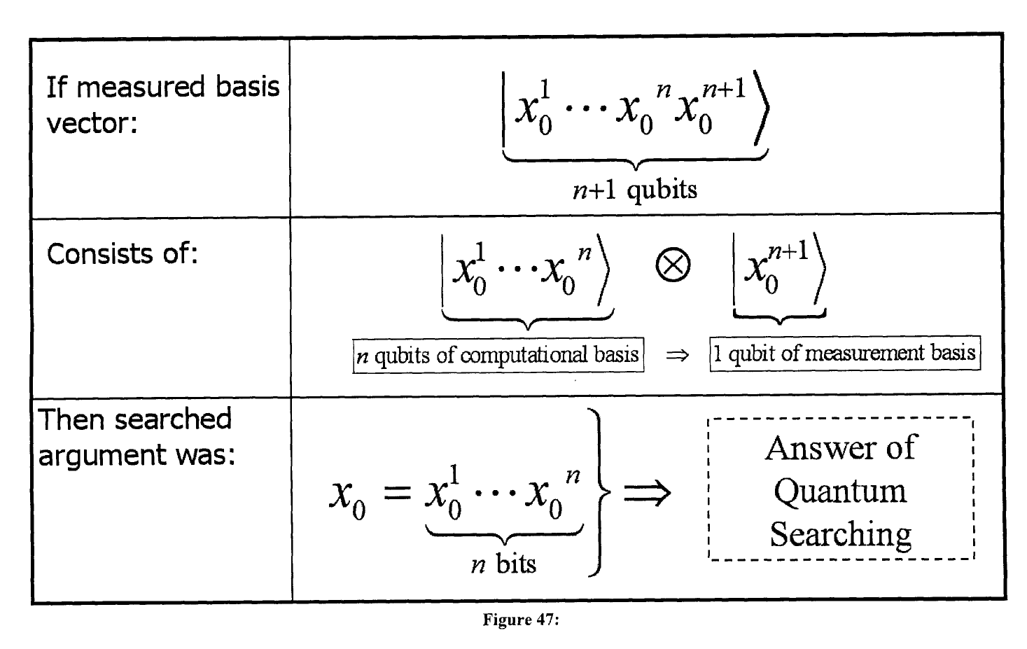

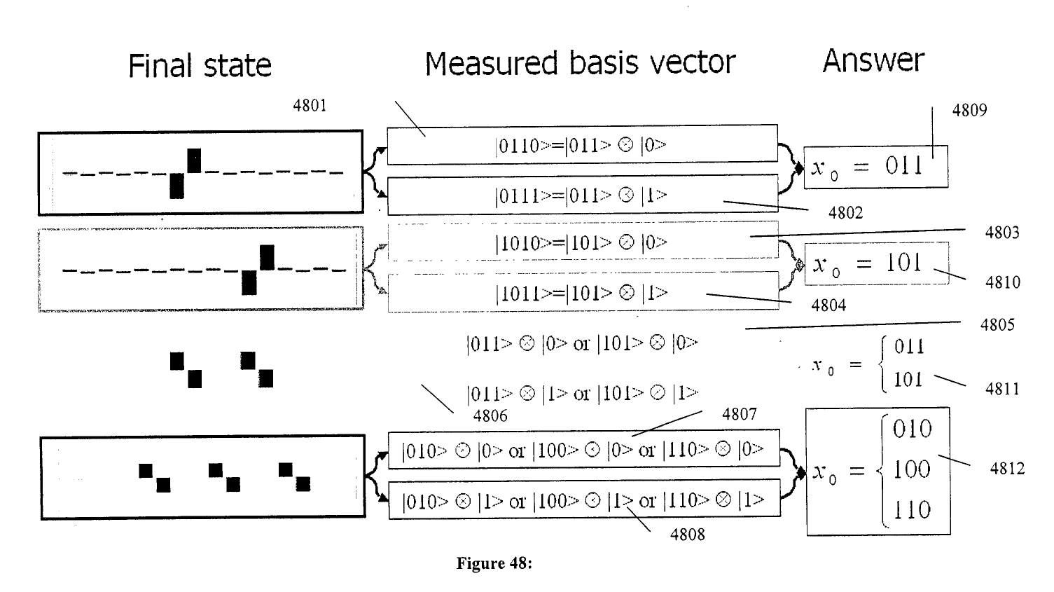

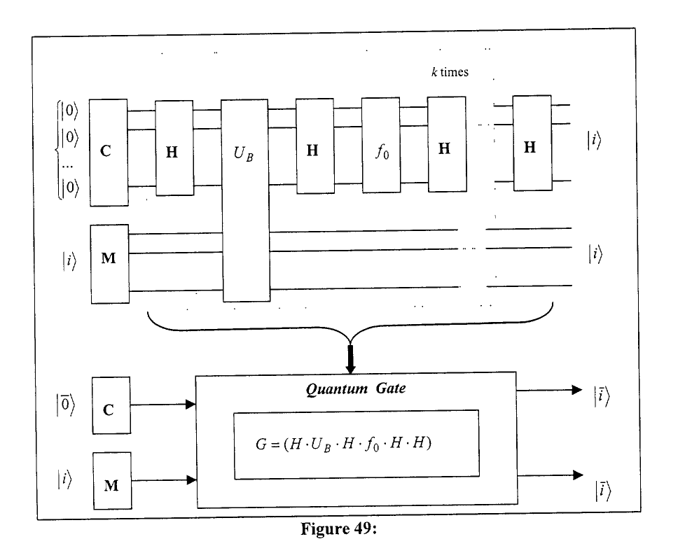

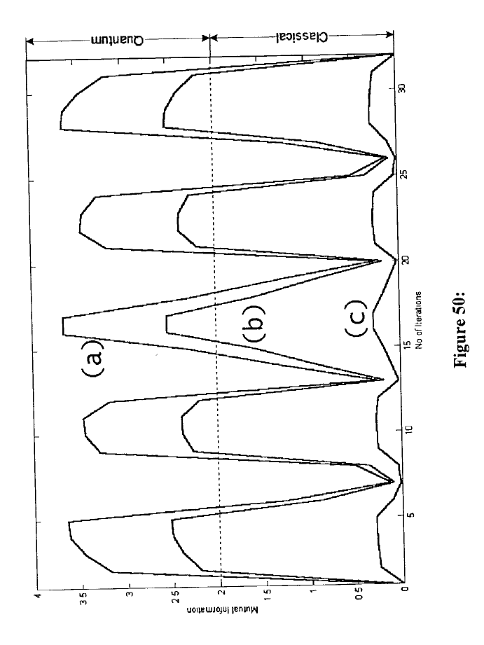

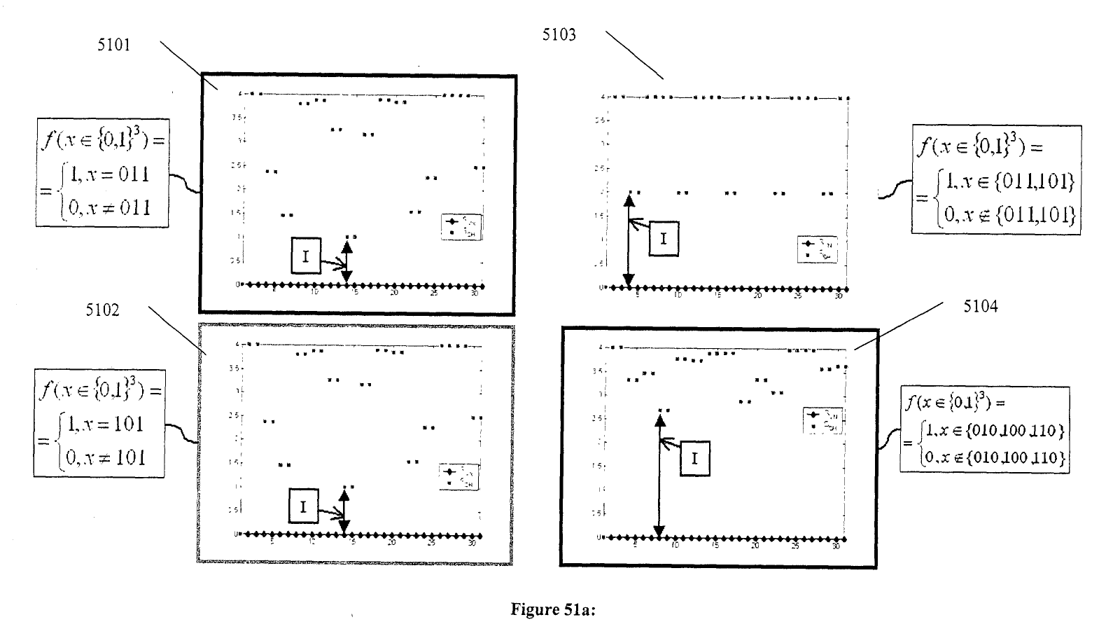

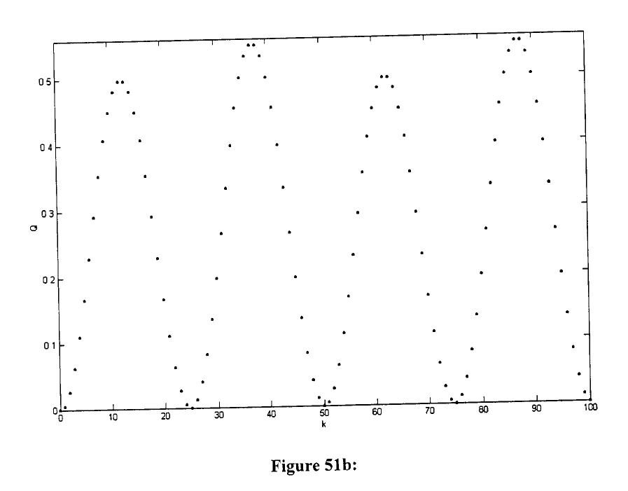

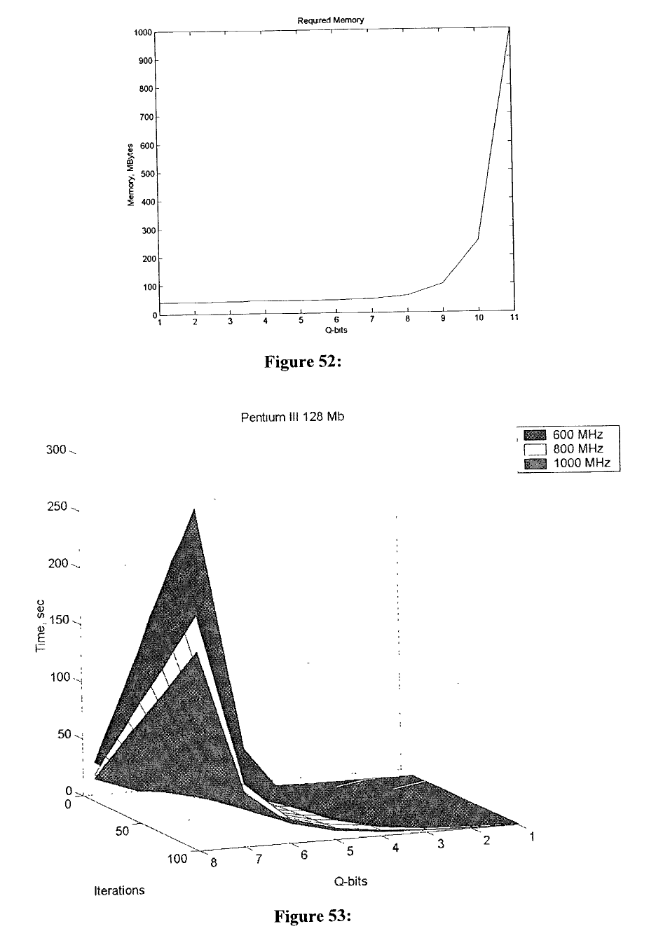

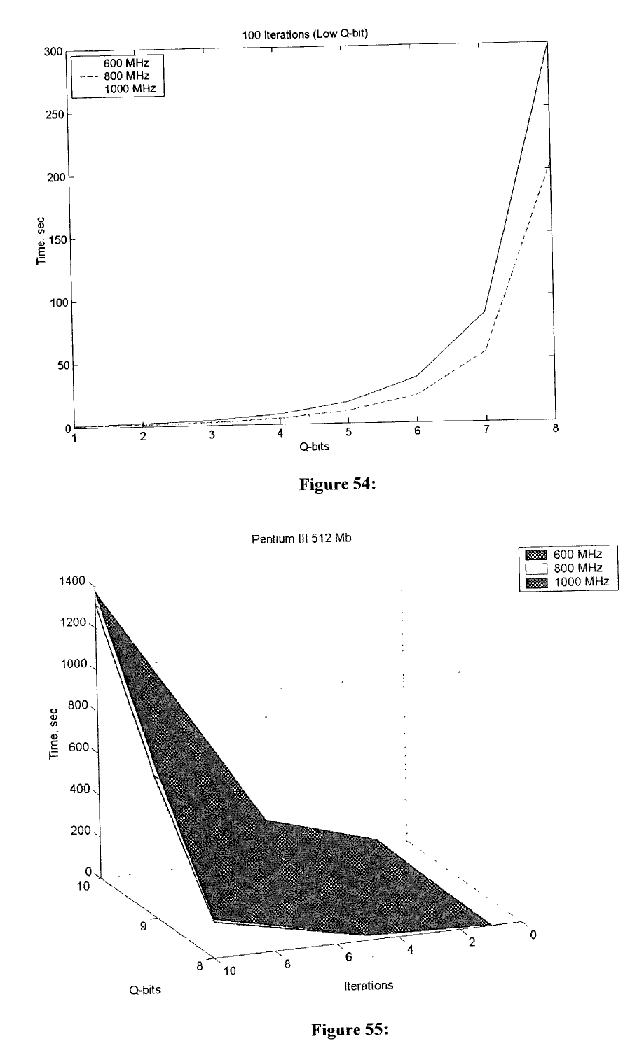

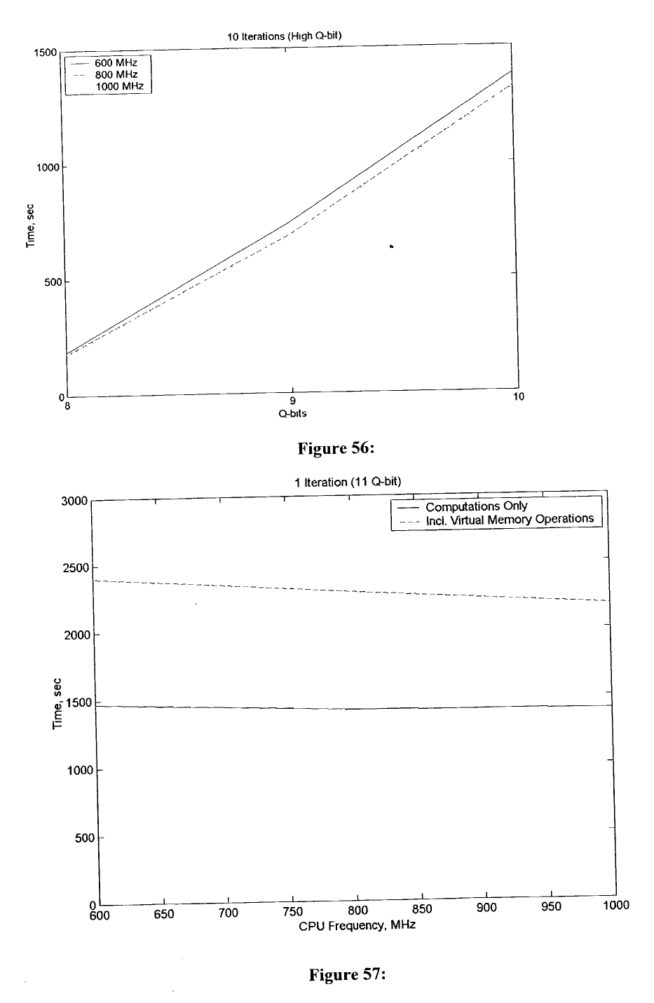

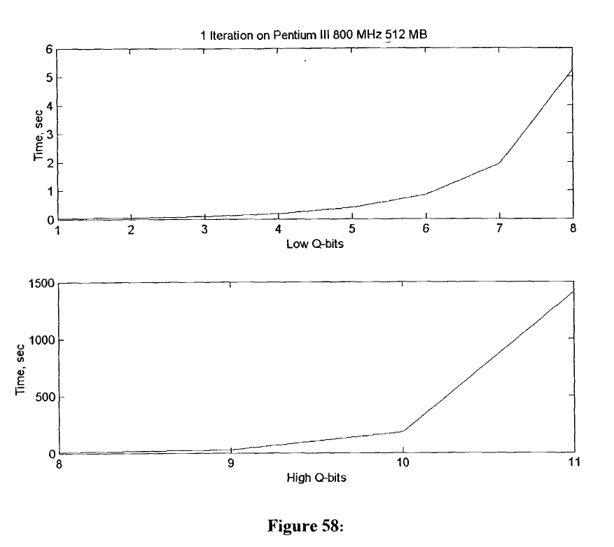

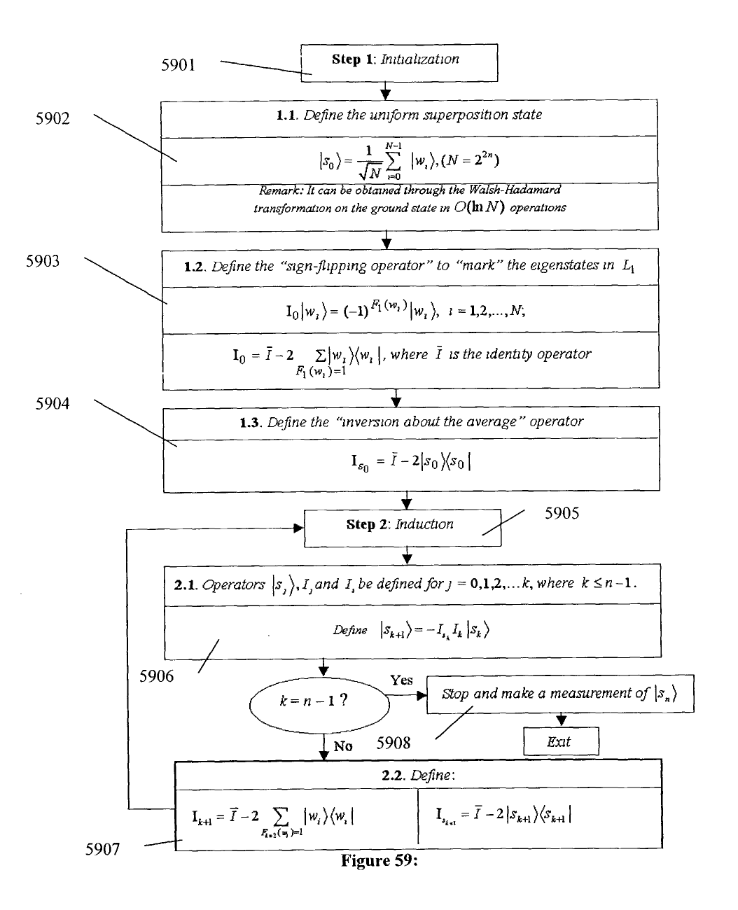

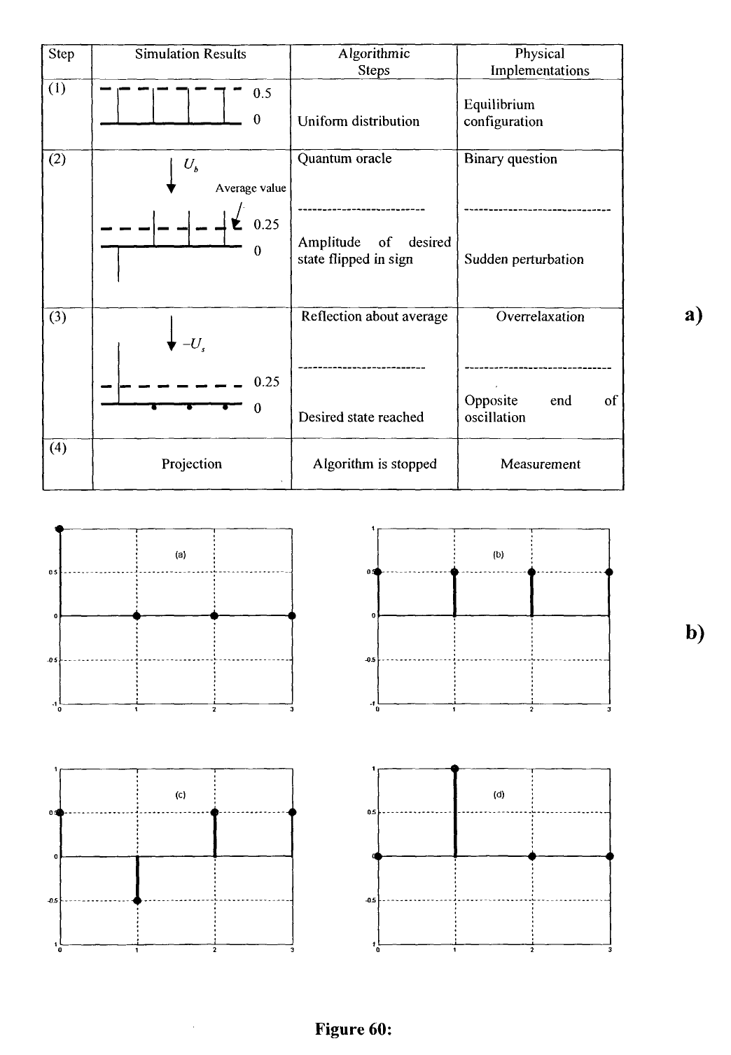

FIG. 34 shows a general iteration algorithm for information analysis of Grover's QA. In FIGS. 35 and 36 two iterations of this algorithm are reported. From these figures it is observed that:

1. The entanglement operator in each iteration increases correlation among the different qubits;

2. The interference operator reduces the classical entropy but, as side effect, it destroys part of the quantum correlation measure by the Von Neumann entropy.

Grover algorithm builds intelligent states in several iterations. Every iteration first encodes the searched function by entanglement, but then partly destroys the encoded information by the interference operator. Several iterations are needed in order to conceal both the need to have encoded information and the need to access it. The Principle of Minimum Classical (Quantum) Entropy in the output of QA leads to a successful result on intelligent output states. The searching QA's (such as Grover's algorithm) check for minimum of Classical Entropy and co-ordination of the gap with Quantum Entropy Amount. The ability of co-ordination of these two values characterises the intelligence of searching QA's.

When the output vector from the quantum gate has been measured, it must interpret it in order to find x. This step follows from the analyses above. In fact, it is sufficient to choose a large h in order to get the searched vector |x> [symbol] |0> or |x> [symbol] |1> with probability near to 1. The output vector is encoded back into binary values using the first n basis vector in the resulting tensor product, obtaining string x as the final answer.

For example, assume that n=2⁴ and m=2¹⁴ (let m be less than maximum possible 2¹⁶ to allow for some generalization and to avoid the contradictory patterns that would otherwise result). Then the QuAM requires O(mn)=O(mn)=O(2¹⁸)<10⁶ operations to memorize the patterns and O({square root over (N))}=O(\sqrt{2¹⁶})<10³ operators to recall a pattern. Further, the algorithm would require only 2n+1=2·16+1=33 qubits. The QuAM compares favorably with other quantum computational algorithms because it requires far fewer qubits to perform significant computation that appears to be impossible classically.

A probability of success search can be developed by letting N be the total number of basis states, r₁ be the number of marked states that correspond to stored patterns, r₀ be the number of marked states that do not correspond to stored patterns, and p be the number of patterns stored in the QuAM. The goal is to find the average amplitude \overline{k} of the marked states and the average amplitude \overline{l} of the unmarked states after applying the above-described equation. It can be shown that

k₀=4a−ab,

k₁=4a−ab+1,

l₀=2a−ab,

l₁=4a−ab−1.

Here k₀ is the amplitude of the spurious marked states, k₁ is the amplitude of the marked states that corresponds to stored patterns, l₀ is the amplitude of the spurious unmarked states, l₁ is the amplitude of the unmarked states that corresponds to stored patterns after applying above described equation, and

$$a = \frac{2 ( p - 2 {r}_{1} )}{N} , b = \frac{4 ( p + {r}_{0} )}{N} .$$

A little more algebra gives the averages as

$$\overline{k} = 4 a - ab + \frac{{r}_{1}}{{r}_{0} + {r}_{1}} , and \overline{l} = - ab + \frac{2 a ( N + p - {r}_{0} - 2 {r}_{1} )}{N - {r}_{0} - {r}_{1}} - \frac{( p - {r}_{1} )}{N - {r}_{0} - {r}_{1}} .$$

Now consider this new state described by these equations as the arbitrary initial distribution to which the results can be applied. These can be used to calculate the upper bound on the accuracy of the QuAM as well as the appropriate number of times to apply this equation in order to be as close to that upper bound as possible. The upper bound on accuracy is given by

Pₘₐₓ=1−(N−p−r₀)|l₀−\overline{l}|²−(p−r₁)|l₁−\overline{l}|²,

whereas the actual probability at a given time t is

P(t)=Pₘₐₓ−(N−r₀−r₁)|\overline{l}(t)|².

The first integer time step T for which the actual probability will be closest to this upper bound is given by rounding the function

$$T = \frac{\frac{π}{2} - arctan [ \frac{\overline{k}}{\overline{l}} \sqrt{\frac{{r}_{0} + {r}_{1}}{N - {r}_{0} - {r}_{1}}} ]}{arccos [ 1 - 2 \frac{{r}_{0} + {r}_{1}}{N} ]}$$

to the nearest integer.

The algorithm described above can handle only binary patterns. Nominal data with more than two values can be handled by converting the multiple values into a binary representation. 11. Quantum Optimization, Quantum Learning and Robustness of the Fuzzy Intelligent Controller

One embodiment includes extraction of knowledge from the simulation results and forming a robust Knowledge Base (KB) for the fuzzy controller in the intelligent suspension control system (ISCS). The basises for this approach are Grover's QSA (optimization of unified look-up table structure) and quantum learning (KB production rules with relatively minimal sensitivity to different random excitations of the control object).

According to the structure in FIG. 20, consider the summarization role of Grover's QSA in the process of forming the teaching signal for the KB fuzzy controller. Appendices 2, 3 and 4 provide further descriptions of Grover's QSA operations and model structures.

11.1. Standard Grover's QSA structure and Results of the Measurement Process. The individual outcomes of a measurement process can be understood within standard quantum mechanics in terms of executing Grover's QSA. A measurement interaction first entangles system S with the measuring process X. In general, one obtains the state

$$\vert ψ ⟩ = {\sum }_{i = 1}^{n} {c}_{i} \vert {S}_{i} ⟩ \vert {X}_{i} ⟩$$

where the states |Xᵢ [symbol] span the pointer basis. This is a unitary Schrodinger process and it correlates every state |Sᵢ [symbol] with a definite apparatus state |Xᵢ [symbol] . Since, this is an entangled state, it must be reduced to a particular state |Sᵢ [symbol] |Xᵢ [symbol] before the result can be read off. This is achieved by a non-unitary process by projecting the state |ψ [symbol] to this state with the help of the projection operator Πᵢ=|Xᵢ [symbol] [symbol] Xᵢ|. One can obtain the reduced density matrix

$$ρ \to {ρ}^{′} = {\sum }_{i}^{} {\prod }_{i} ρ {\prod }_{i}$$

which is diagonal and represents a heterogeneous mixture with probabilities lc. 2.

The algorithm amplifies the amplitude of an identified target (the amplitude corresponding to a particular eigenstate in this case) at the cost of all other amplitudes to a point where the latter becomes so small that they cannot be recorded by detectors of finite efficiency (see Appendix 2).

Let the set {|Sᵢ [symbol] |Xᵢ [symbol] } (where i=1, 2, . . . , N) be the search elements that a quantum computer apparatus is to deal with. Let these elements be indexed from 0 to N−1. This index can be stored in n bits where N≡2ⁿ. Let the search problem have exactly M solutions with 1≦M≦N. Let f(ξ) be a function with ξ an integer in the range 0 to N−1. By definition, f(ξ)=1 if ξ is a solution to the search problem and f(ξ)=0 if ξ is not a solution to the search problem. One then needs an oracle that is able to recognize solutions to the search problem (see Appendix 3). This is signaled by making use of a qubit.

The oracle is a unitary operator 'ο defined by its action on computational basis as follows:

'ο:|ξ [symbol] |q [symbol] →|ξ|q⊕f(ξ)

[symbol]

where |ξ [symbol] is the index register and the oracle qubit |q [symbol] is a single qubit that is flipped if f(ξ)=1 and is unchanged otherwise (see Appendix 4). Thus,

|ξ [symbol] |0 [symbol] →|ξ [symbol] |0 [symbol] if |ξ [symbol] is not a solution

|ξ [symbol] |0 [symbol] →|ξ [symbol] |1 [symbol] if |ξ [symbol] is a solution

It is convenient to apply the oracle with the oracle qubit initially in the state

$$\vert q ⟩ = \frac{1}{\sqrt{2}} ( \vert 0 ⟩ - \vert 1 ⟩ )$$

so that 'ο: |ξ [symbol] |q [symbol] →(−1)^{f(ξ)}|ξ [symbol] |q [symbol] . Then the oracle marks the solutions to the search by shifting the phase of the solution (see Appendices 3 and 4). If there are M solutions, it turns out that one need only apply the search oracle

$$O ( \sqrt{\frac{N}{M}} )$$

times on the QC. Initially, the QC, assumed to be an integral part of the final detector, is always in the state |0 [symbol] ⁿ [symbol]. The first step in the Grover's QSA is to apply a Hadamard transform to put the computer in the equal superposition state

$$\vert ψ ⟩ = \frac{1}{\sqrt{N}} {\sum }_{ξ = 0}^{N - 1} \vert ξ ⟩ .$$

The search algorithm then involves repeated applications of the Grover's iteration (or Grover's operator G) which can be broken up into the following four operations: 1) The oracle 'ο; 2) The Hadamard transform H ⁿ [symbol]; 3) A conditional phase shift on the computer with every computational basis state except |0 [symbol] receiving a phase shift of (−1), i.e., |ξ [symbol] →(−1)^{f(ξ)}|ξ [symbol] ; 4) The Hadamard transform H ⁿ [symbol].

The combined effect of steps 2, 3 and 4 is (see Appendix 3)

G=H ⁿ [symbol](2|0 [symbol] [symbol] 0|−I)H ⁿ [symbol]=2|ψ [symbol] [symbol] ψ|−I

where

$$\vert ψ ⟩ = \frac{1}{\sqrt{N}} {\sum }_{ξ = 0}^{N - 1} \vert ξ ⟩ .$$

The Grover's operator G can be regarded as a rotation in the two dimensional space spanned by the vector |ψ [symbol] (see Appendices 3 and 4) which is a uniform superposition of the solutions to the search problem. To see this, define the normalized states

$$\vert α ⟩ = \frac{1}{\sqrt{N - M}} {\sum }_{ξ are solutions} \vert ξ ⟩ \\ \vert β ⟩ = \frac{1}{\sqrt{M}} {\sum }_{ξ are not solutions} \vert ξ ⟩$$

where

$${\sum }_{ξ are solutions} \vert ξ ⟩$$

indicates a sum over all ξ that are solutions to the search problem

and

$${\sum }_{ξ are not solutions} \vert ξ ⟩$$

a sum over all, that are not solutions to the search problem. The initial state are not solutions can be written as

$$\vert ψ ⟩ = \frac{1}{\sqrt{N}} {\sum }_{ξ = 0}^{N - 1} \vert ξ ⟩ = \sqrt{\frac{N - M}{N}} \vert α ⟩ + \sqrt{\frac{M}{N}} \vert β ⟩ \qquad ( 11.1 )$$

so that the apparatus (with quantum computing) is the space spanned by |α [symbol] and |β [symbol] to start with. Now notice (according to Appendix 4) that the oracle operator performs a rotation about the vector |α [symbol] in the plane defined by |α [symbol] and |β [symbol] , i.e.,

'ο(a|α [symbol] +b|β [symbol] )=a|α [symbol] −b|β [symbol] .

Similarly, G also performs a reflection in the same plane about the vector |ψ [symbol] , and the effect of these two reflections is a rotation. Therefore, the state Gk|ψ [symbol] remains in the plane spanned by |α [symbol] and |β [symbol] for all k. The rotation angle can be found as follows. Let

$$cos ( \frac{θ}{2} ) = \sqrt{\frac{N - M}{N}}$$

so that

$$\vert ψ ⟩ = cos ( \frac{θ}{2} ) \vert α ⟩ + sin ( \frac{θ}{2} ) \vert β ⟩ .$$

Then one can show (see Appendix 4) that

$$G \vert ψ ⟩ = cos ( \frac{3 θ}{2} ) \vert α ⟩ + sin ( \frac{3 θ}{2} ) \vert β ⟩$$

so that θ is indeed the rotation angle, and so

$${G}^{k} \vert ψ ⟩ = cos ( \frac{2 k + 1}{2} θ ) \vert α ⟩ + sin ( \frac{2 k + 1}{2} θ ) \vert β ⟩ .$$

Thus, the repeated applications of the Grover's operator are rotated the vector |ψ [symbol] close to |β [symbol] .

When this happens, an observation in the computational basis produces one of the outcomes superposed in |β [symbol] with high probability. In a quantum measurement, only one outcome must occur and hence, the number M of simultaneous solutions that Grover's QSA searches is unity.

11.2. Grover's Search Algorithm and Quantum Lower Bounds. Searching an item in an unsorted DB with size N costs a classical computer O(N) running time. A search algorithm consults the DB only O(AN) times. In contrast to algorithms based on the quantum Fourier transformation, with exponential speed-up, the search algorithm only provides a quadratic improvement. However, the algorithm is important because it has broad applications and the same technique can be used to improve solutions of NP-complete problems. Grover's search algorithm is optimal. At least Ω(\sqrt{N}) queries are needed to solve the problem. The following example illustrates the QSA and its lower bound respectively (see Appendices 4 and 5).

Let f:[N]→{0, 1} be a Boolean function. Assume a quantum black box U_{f} for computing f:U_{f}:|x [symbol] |y [symbol] →|x [symbol] |y⊕f(x) [symbol] . Set |y [symbol] as |0 [symbol] , then U_{f}:|x [symbol] |0 [symbol] →|x [symbol] |f(x) [symbol] .

If |y [symbol] is initialized to

$$\frac{( \vert 0 ⟩ - \vert 1 ⟩ )}{\sqrt{2}} ,$$

the oracle acts as

$${U}_{f} \text{:} \vert x ⟩ ( \frac{( \vert 0 ⟩ - \vert 1 ⟩ )}{\sqrt{2}} ) \to {( - 1 )}^{f ( x )} \vert x ⟩ ( \frac{( \vert 0 ⟩ - \vert 1 ⟩ )}{\sqrt{2}} ) .$$

Assume that there is a single value k such that f(k)=1. If f is specified by a black box, the lower bound is the fewest queries needed to f to determine k.

11.2.1. Inversion about the average and its application in the iterative procedure. The unitary transform

$${D}_{n} = {\sum }_{i = 0}^{N - 1} {a}_{i} \vert i ⟩ -> {\sum }_{i = 0}^{N - 1} ( 2 E - {a}_{i} ) \vert i ⟩ , N = {2}^{n} ,$$

where E is the average of {aᵢ|0≦i≦N}, can be performed by the matrix

$${D}_{n} = ( \begin{matrix}- 1 + \frac{2}{N} & \frac{2}{N} & ⋯ & \frac{2}{N} \\ \frac{2}{N} & - 1 + \frac{2}{N} & ⋯ & \frac{2}{N} \\ ⋮ & ⋮ & ⋰ & ⋮ \\ \frac{2}{N} & \frac{2}{N} & ⋯ & - 1 + \frac{2}{N}\end{matrix} ) .$$

Appendix 4 describes the properties of the operator D.

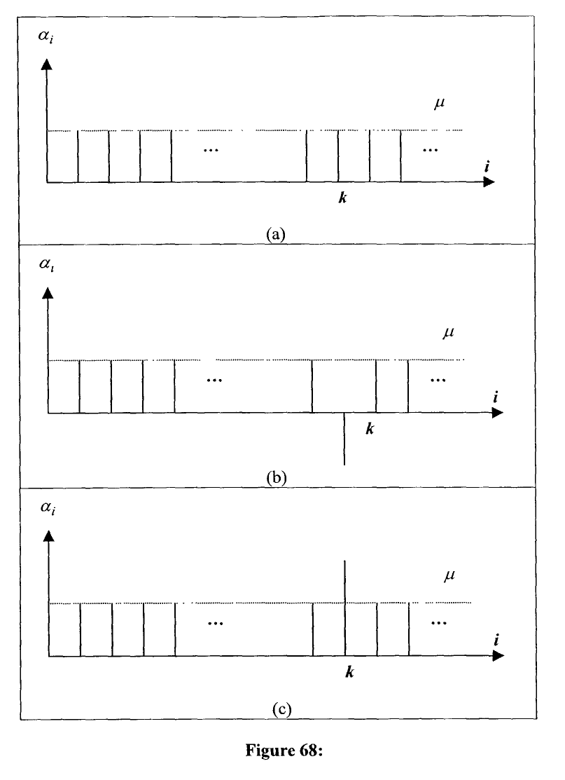

As shown in FIG. 67, the operator D increases (decreases) amplitudes that are originally below (above) the mean value μ.

The QSA iteratively improves the probability of measuring a solution. In each iteration, this algorithm performs two operations: first it consults the oracle U_{f} and then is applies the “inversion about the mean” operator D. The quantum state evolves as

|φᵢ₊₁ [symbol] =DU_{f}|φᵢ

[symbol]

along with iteration i to iteration (i+1).

For example, assume it is desired to find one out of N items. In the first step, as shown in FIG. 68A, prepare the initial state as a uniform superposition over these N items. In each iteration, the entanglement operator U_{f} marks the only solution k, f(k)=1, with a phase shift as indicated in FIG. 68B. The D operation amplifies αₖ, the amplitude of the marked item, and suppresses those of all other items as shown in FIG. 68C. Repeating the process before measurement increases the probability of measuring k.

For example, after the first iteration,

$${α}_{k} \approx \frac{3}{\sqrt{N}} ;$$

after the second iteration,

$${α}_{k} \approx \frac{5}{\sqrt{N}} .$$

More formally, at iteration t, αₖ and αₗ(l=0, 1, . . . , N−1;≠k) are

$$\begin{matrix}{α}_{k}^{( t )} = ( 1 - \frac{2}{N} ) {α}_{k}^{( t - 1 )} + ( 2 - \frac{2}{N} ) {α}_{l}^{( t - 1 )} \\ {α}_{l}^{( t )} = ( - \frac{2}{N} ) {α}_{k}^{( t - 1 )} + ( 1 - \frac{2}{N} ) {α}_{l}^{( t - 1 )}\end{matrix}$$

Initially, αₖ⁽⁰⁾=αₗ^{(t)}=1/\sqrt{N}. After O(AN) steps, αₖ becomes constant. Therefore, in the measurement, the probability of observing k becomes constant.

Increasing the number of iterations does not always increase the chance of measuring the right answer. The amplitude of the marked solution goes up and down as a cycle. If the iterations are not stopped at the right time, the chance of measuring the correct item is reduced.

11.2.2. The geometric interpretation. When finding M solutions from a sample space with N entries, one can cluster these items into two orthogonal bases, say

$$\vert k ⟩ = \frac{1}{\sqrt{M}} {\sum }_{x ∈ {f}^{- 1} ( 1 )}^{} \vert x ⟩$$

(the collection of the M solutions) and

$$\vert u ⟩ = \frac{1}{\sqrt{N - M}} {\sum }_{x ∈ {f}^{- 1} ( 0 )}^{} \vert x ⟩$$

(the collection of the remaining items).

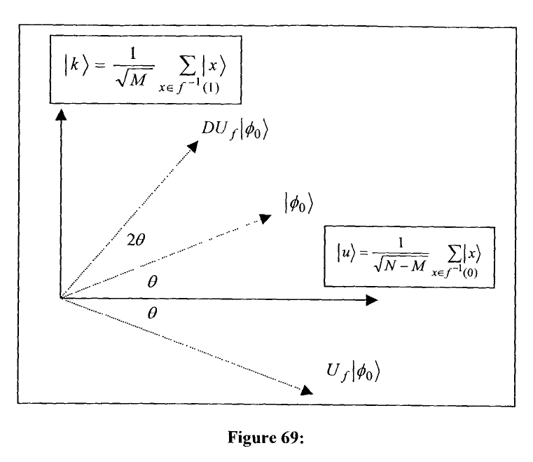

FIG. 69 helps in visualizing the iterative steps in a single plane spanned by these two vectors.

For original state

$$\vert {φ}_{0} ⟩ = \frac{1}{\sqrt{N}} {\sum }_{x = 0}^{N - 1 } \vert x ⟩ ,$$

according to Eq.(11.1), it can be rewritten as

$$\begin{matrix}\vert {φ}_{0} ⟩ = \frac{\sqrt{M}}{\sqrt{N}} ( \frac{1}{\sqrt{M}} {\sum }_{x ∈ {f}^{- 1} ( 1 )}^{} \vert x ⟩ ) + \frac{\sqrt{N - M}}{\sqrt{N}} ( \frac{1}{\sqrt{N - M}} {\sum }_{x ∈ {f}^{- 1} ( 0 )}^{} \vert x ⟩ ) \\ = \sqrt{\frac{M}{N}} \vert k ⟩ + \sqrt{\frac{N - M}{N}} \vert u ⟩ .\end{matrix}$$

In the oracle consultation, the operator U_{f} shifts the phase in the |k [symbol] component and therefore reflects the acted vector about |u [symbol] . Meanwhile, since D is a reflection about |00 . . . 0) in the Hadamard basis (as shown in Appendix 4), it reflects the acted vector about |φ₀ [symbol] . The product of these two operators, DU_{f}, performs an equivalent 2θ-rotation operation, where

$$θ ≡ {sin}^{- 1} \sqrt{\frac{M}{N}} = {cos}^{- 1} \sqrt{\frac{N - M}{N}} .$$

After i such iterations, the state becomes

(DU_{f})^{j}|φ₀ [symbol] =sin((2j+1)θ)|k [symbol] +cos((2j+1)θ)|u

[symbol]

In the special case of N items (N>>1), θ≧sin θ=1/\sqrt{N}, to maximize the probability of obtaining the correct measurement, the needed number of iterations is:

$$≅ \frac{π / 2}{2 θ} \leq \frac{π \sqrt{N}}{4} .$$

Consequently, Grover's search algorithm makes O(\sqrt{N}) queries.

Through this visualization, it can be seen that if the number of iterations is not chosen properly, the final vector might not be rotated to a desired angle, which results in a small magnitude is projected onto the |k [symbol] direction, which means a small probability of measuring the right answer.

11.2.3 Quantum Lower Bounds. In light of the previously-developed quantum algorithms, one might ask if a quantum computer can solve NP-complete problems in polynomial time. Consider the satisfiability (SAT) problem, the first proven NP-complete problem. It can be formulated as a search problem. That is, given a Boolean formula f(xₗ, x₂, . . . , xₙ), search an assignment under which the value of the expression is 1. The task is to devise a quantum algorithm to search within poly(n), or log N (N=2ⁿ), steps. A quantum algorithm that solves this problem must make Ω(\sqrt{N}) queries to the quantum oracle U_{f}. Two arguments can be used to show this: the hybrid argument, and the quantum adversary method.

For the hybrid argument, consider any quantum algorithm A for solving the search problem. First do a test run of A on function f≡0. Define the query magnitude of x to be

$${\sum }_{t} {\vert {α}_{x , t} \vert}^{2} ,$$

where α_{x,t} is the amplitude with which A queries x at time t. The expectation value of the query magnitudes

$${E}_{x} ( {\sum }_{t} {\vert {α}_{x , t} \vert}^{2} ) = \frac{T}{N} . Thus , {min}_{x} ( {\sum }_{t} {\vert {α}_{x , t} \vert}^{2} ) \leq \frac{T}{N} .$$

For such an x, by Cauchy-Schwarz inequality,

$${\sum }_{t} \vert {α}_{x , t} \vert \leq \frac{T}{\sqrt{N}} .$$

Let |φ₀ [symbol] , |φ₁ [symbol] , . . . , |φ_{T} [symbol] be the states of A_{f}. Now run the algorithm A on the function g: g(x)=1, g(y)=0 ∀y≠x. Then ∥|φ_{T} [symbol] −|ψ_{T} [symbol] ∥ must be small.

It can be shown that |ψ_{T} [symbol] =|φ_{T} [symbol] +|E₀ [symbol] +|E₁ [symbol] + . . . +|E_{T-1} [symbol] , where ∥|Eₜ [symbol] ∥≦|α_{x,t}|. To show this, consider two runs of algorithm A, which differ only on the t-th step: one queries the function f and the other queries the function g. Both runs query the functionf in the first t−1 steps. Then at the end of the t-th step, the state of the first run is |φₜ [symbol] , whereas the state of the second run is |φₜ [symbol] +|Fₜ [symbol] , where ∥|Fₜ [symbol] ∥≦|α_{x,t}|. Now, if U is the unitary transform describing the remaining (T−t) steps, then the final state after T steps for the two runs are U|φₜ [symbol] and U(|φₜ [symbol] +|Fₜ [symbol] ), respectively. The latter state can be written as U|φₜ [symbol] +|Eₜ [symbol] , where |Eₜ [symbol] =U|Fₜ [symbol] . Thus switching the queried function only on the t-th step results in a change in the final state of the algorithm by |Fₜ [symbol] , where ∥|Eₜ [symbol] ∥≦|α_{x,t}|. Therefore switching the queried function in all the steps results in the change |E₀ [symbol] +|E₁ [symbol] + . . . +|E_{T-}1 [symbol] in the final state, where ∥|Eₜ [symbol] ∥≦|α_{x,t}|.

It follows that

$$‖ \vert {ψ}_{T} ⟩ - \vert {φ}_{T} ⟩ ‖ \leq {\sum }_{t} \vert {α}_{x , t} \vert \leq \frac{T}{\sqrt{N}} .$$

Measuring |ψ_{T} [symbol] results in (a sample from) a distribution that is

$$O ( \frac{T}{\sqrt{N}} )$$

of the distribution that results from measuring |φ_{T} [symbol] .

Thus, any algorithm that distinguishes f from g with constant probability must take a number of steps T=Ω(\sqrt{N}).

One can repeat the argument with another function h, and thus show that the final state of A while querying h satisfies

$$‖ \vert {X}_{T} ⟩ - \vert {φ}_{T} ⟩ ‖ \leq {\sum }_{t} \vert {α}_{x , t} \vert \leq \frac{T}{\sqrt{N}} .$$

By the triangle inequality it is true that

$$‖ \vert {X}_{T} ⟩ - \vert {φ}_{T} ⟩ ‖ \leq \frac{2 T}{\sqrt{N}} .$$

Thus any quantum algorithm that distinguishes h from g with constant probability must take a number of steps T=Ω(\sqrt{N}).

For the quantum adversary method assume initially one has two unentangled registers, an input-register and a work-register, with states

$$( {\sum }_{x ∈ [ N ]} \vert x ⟩ ) ⊗ \vert 0 ⟩ .$$

And a quantum algorithm queries the first register and operates on the second register. If the algorithm works correctly, the final states of these registers must be strongly entangled, that is

$${\sum }_{x ∈ [ N ]} ( \vert x ⟩ ⊗ \vert x , junk ⟩ ) .$$

The amplitudes in the above two expressions are omitted. A suitable measure of entanglement increases from 0 to N in queries from the initial state to final state. Moreover, the entanglement can only increase during a query and this increase is bounded by O(\sqrt{N}) per query, thus yielding as Ω(\sqrt{N}) a lower bound (see Appendices 3 and 4).

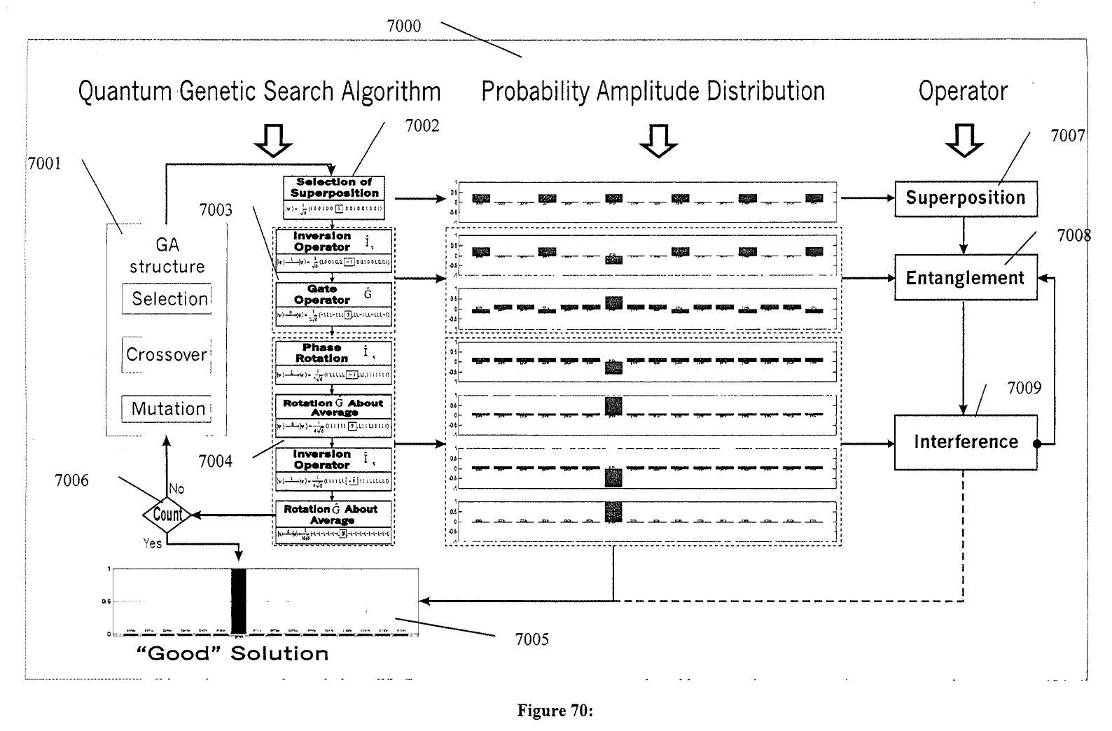

11.3. The forming of unified teaching signal by Grover's QSA. FIG. 21 shows the forming process of a KB of fuzzy P-controller in the ICSS. The box 131, based on the GA, forms the set of teaching signals for different stochastic road signals with different statistics. Box 2101, using the information compressor, produces individual robust teaching signals. This set of signals is an input for the QGSA in box 2001. FIG. 70 shows the preparation of the generalized teaching signal K⁰ using the properties of Grover's QSA. Box 7001 produces teaching signals according to simulations of the dynamic behavior of the ISCS. This set of teaching signals is provided to a box 7002 that produces the selection of the superposition in the present set of teaching signals and achieves the parallel massive computation in the QSA. Box 7007 illustrates this main superposition operator in the QSA computation. Boxes 7003 and 7008 show calculation of the entanglement operator in the QSA computation. Boxes 7004 and 7009 are show simulation of the interference operator in the QSA computation. Box 7006 shows calculation of the number of “good” solutions according to FIG. 27. Box 7805 shows the final measurement result of the quantum computing.

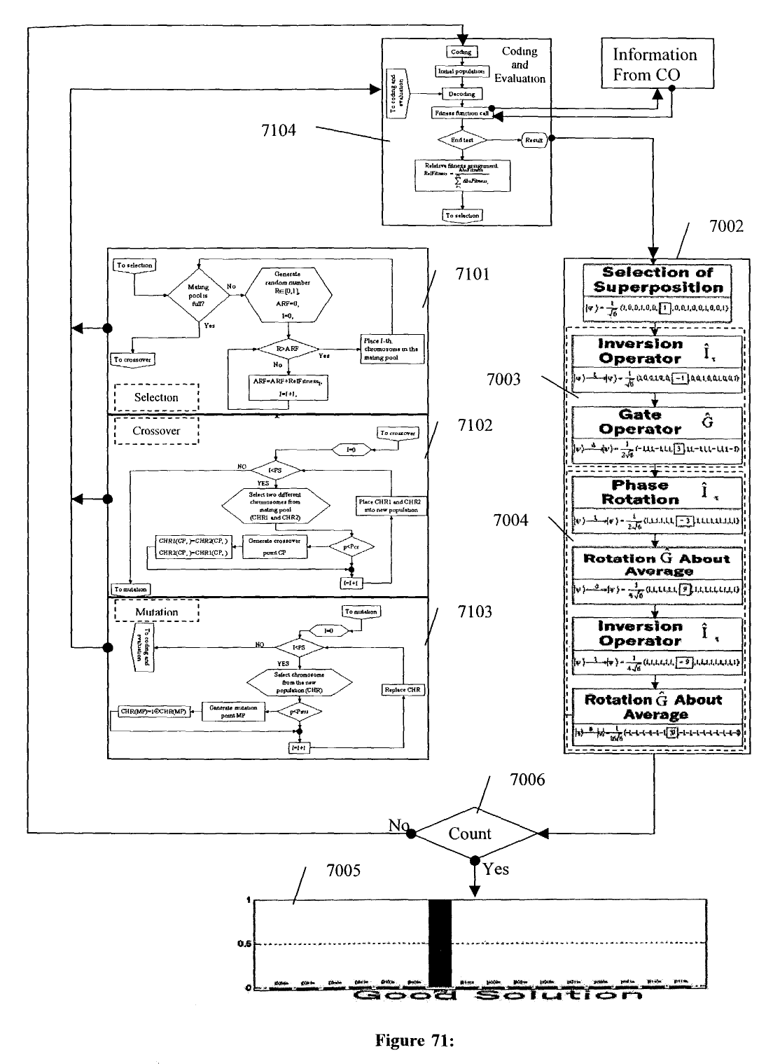

FIG. 71 shows the working structure of the QGSA. Box 7105 shows production of information about the dynamic behavior of the ISCS under stochastic road signals, which are provided to Box 7104. In Box 7104 the fitness function is calculated according the working structure of the GA in Box 7001. Box 7101 shows the selection operator of the GA. Box 7102 is shows the structure of the crossover operator, and Box 7103 shows the structure of the mutation operator of the GA. An output of Box 7001 is provided to Box 7104. Box 7104 shows coding and evaluation of control signal fitness. Box 7006 evaluates the “good” solution in look-up table of the P-controller, and Box 7005 shows monitoring of this solution.

Fast exponential speed-up QSA for forming at KB of the fuzzy P-controller. In the case of an ISCS, with four position-controlled (P-controller) dampers, there are four solutions in the unsorted DB of damper positions produced after the GA from different road signals for fixed sampling control time. According to Appendix 5, one can introduce the following additional quantum black box U_{f}, which is a unitary transformation meant to provide certain information about the oracle when an n-qubit state vector |x [symbol] is fed into it (see Eq.(A5.25)):

U_{f}:|x [symbol] [symbol] |y [symbol] [symbol] |x [symbol] [symbol] |y⊕f_{ω}(x))

Here, |y [symbol] is the (1-qubit) register that described in Section A5.3, and ⊕ means XOR (exclusive OR) operation. Then have

$${U}_{f} : \vert x ⟩ ⊗ \frac{1}{\sqrt{2}} ( \vert 0 ⟩ - \vert 1 ⟩ ) ↦ {( - 1 )}^{{f}_{ω} ( x )} \vert x ⟩ ⊗ \frac{1}{\sqrt{2}} ( \vert 0 ⟩ - \vert 1 ⟩ ) .$$

The effect of U_{f} is to invert the phase of the oracle while leaving all the other states intact. If one queries the state after one application of U_{f} on |s [symbol] , the success probability is

$$1 - {\vert ⟨ s \vert {U}_{f} \vert s ⟩ \vert}^{2} \approx \frac{4}{N} .$$

Thus the U_{f} operation enhanced the probability of finding the oracle by four times compared to the case of using a one-time blind guess. Grover's strategy is to repeat the operation of applying U_{f} followed by (2|s [symbol] [symbol] s|−1) about \sqrt{N} times to successively amplify the probability amplitude of finding the oracle.

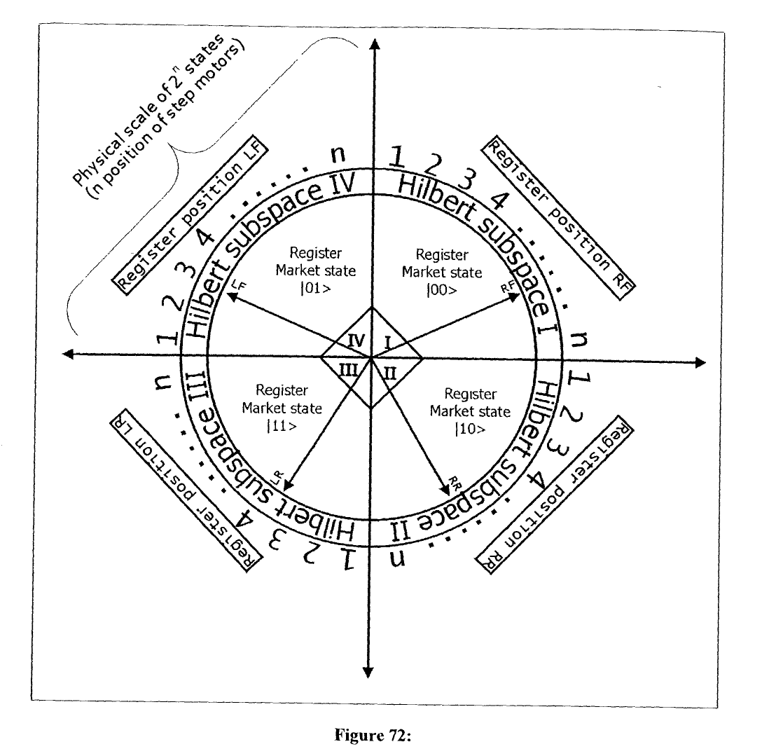

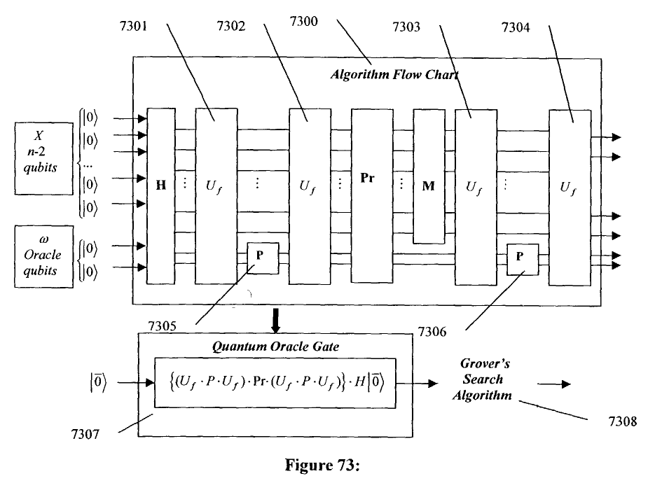

The observation above is described in Appendix 5 and leads to an alternative way to find the oracle: subdivide the total Hilbert space into N/4 subspaces using the first n−2 qubits and then pinpoint the subspace containing the oracle. FIG. 72 shows the geometrical interpretation of a new oracle model. Box 7300 in FIG. 73 shows the algorithm flow chart of new oracle based on four entanglement operators U_{f} (in Boxes 7301, 7302, 7303, and 7304) for definition of the damper position's properties. Permutation operators P in Boxes 7305 and 7306 are described by Eq.(A5.30). The role of these operators in finding damper positions is described in Appendix 5. Operator Pr is the projection operator, and M is the measurement operator (additional query) that can be ignored. Box 7307 shows the quantum oracle gate. An output of box 7307 is provided as an input for Box 7308 (which describes the Grover's QSA).

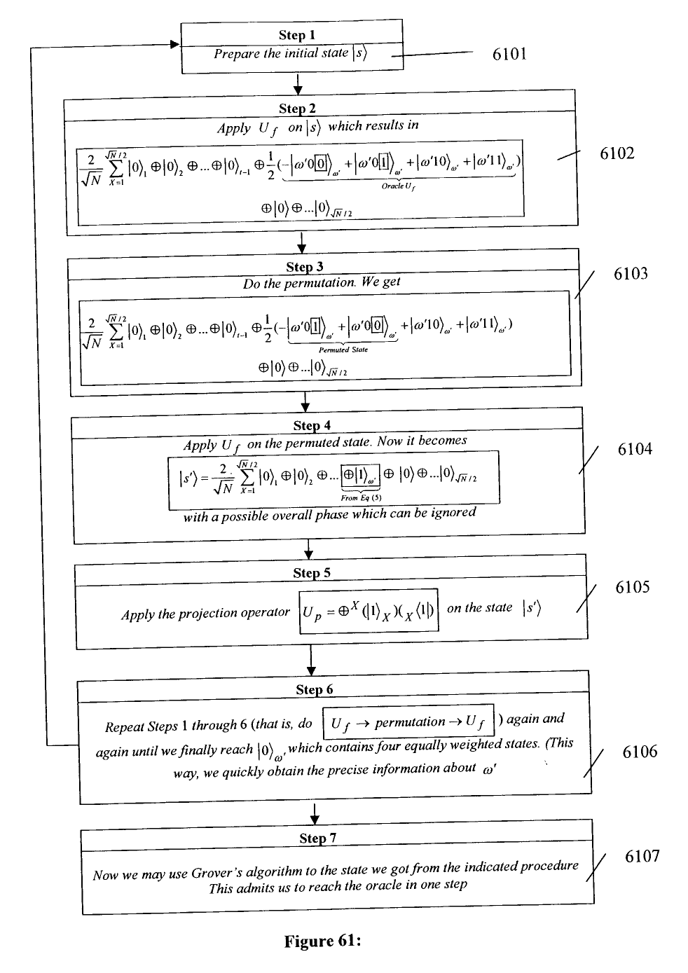

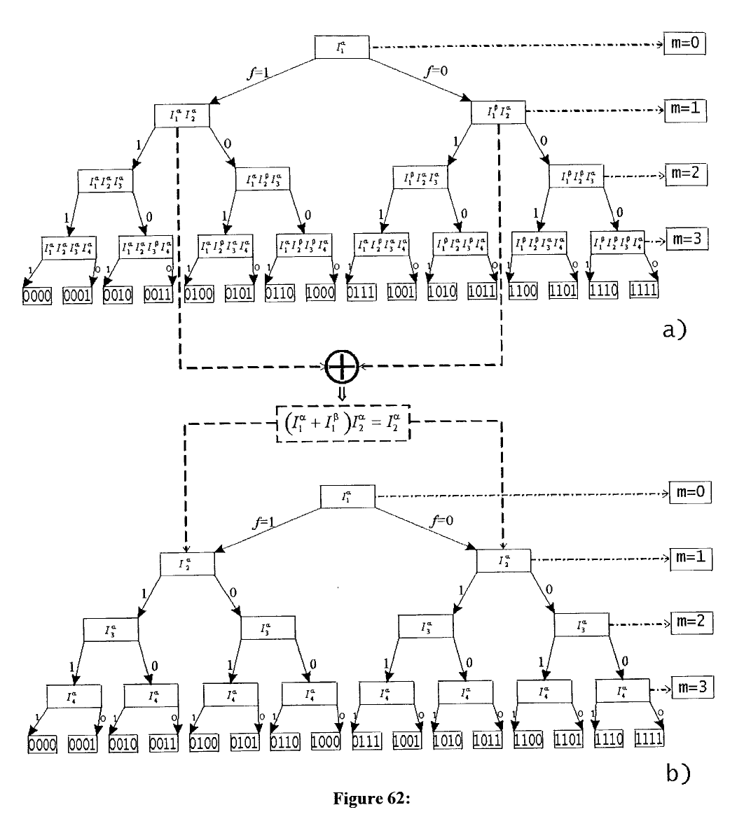

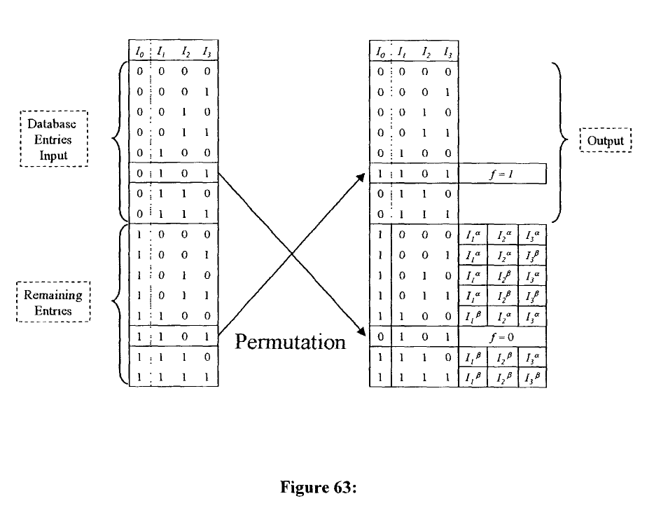

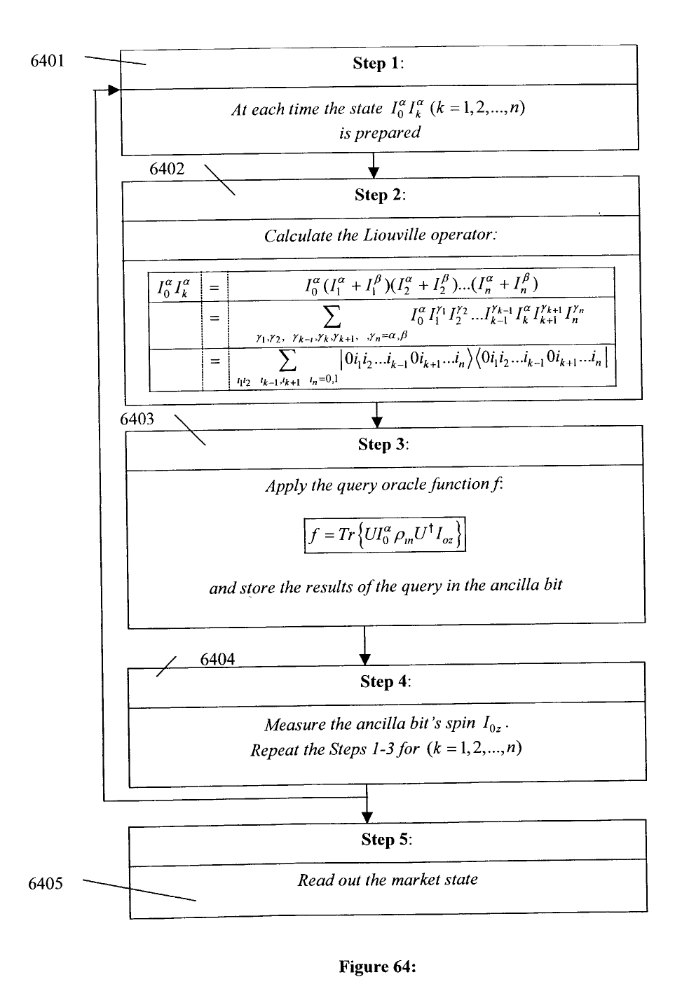

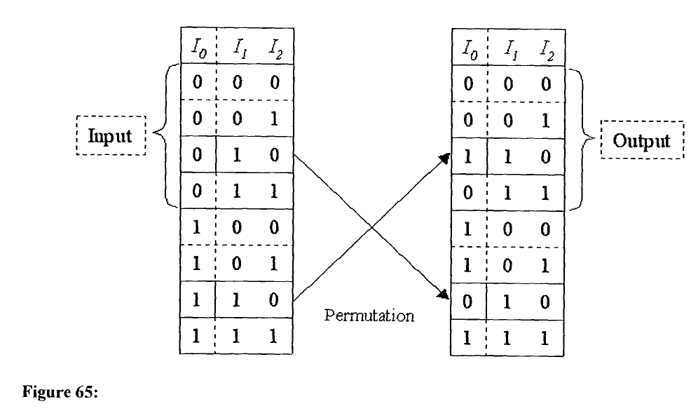

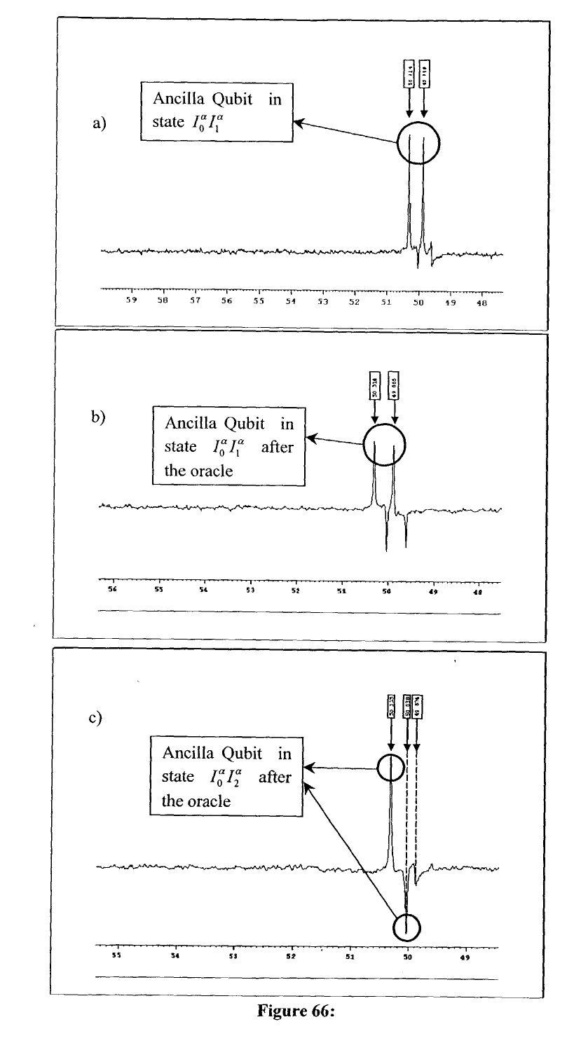

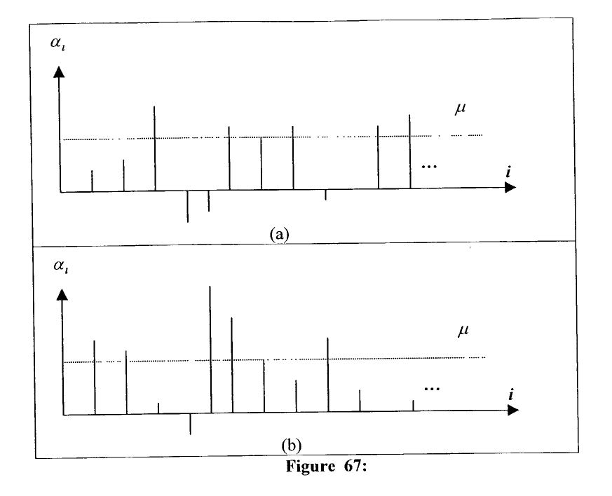

Marked states of the P-controllers as register positions RF, LF, RR, LR for damper positions in the ISCS are described by Eqs.(A5.28) and (A5.29)—for marked states in FIG. 72. For convenience, adopt |s [symbol] [symbol] |y [symbol] as the initial state and defined this state as in Section 11.1 from the measurement process viewpoint. Appendix 5, Section A5.3, shows that other initial conditions will yield the same conclusion so that choosing the correct initial condition is not an issue. Now, drop the register qubit Iy) from the notation to simplify the notation since it remains invariant after each operation. FIG. 61 shows details of this algorithm as described in Appendix 5.

The strategy is to partition the space of all possibilities into subspaces and use a judiciously-chosen projection operator as a polarizer in every subspace to filter out the states, which have the correct first n−2 qubits.

FIG. 73 shows the quantum gate for the new oracle described in Appendix 5.

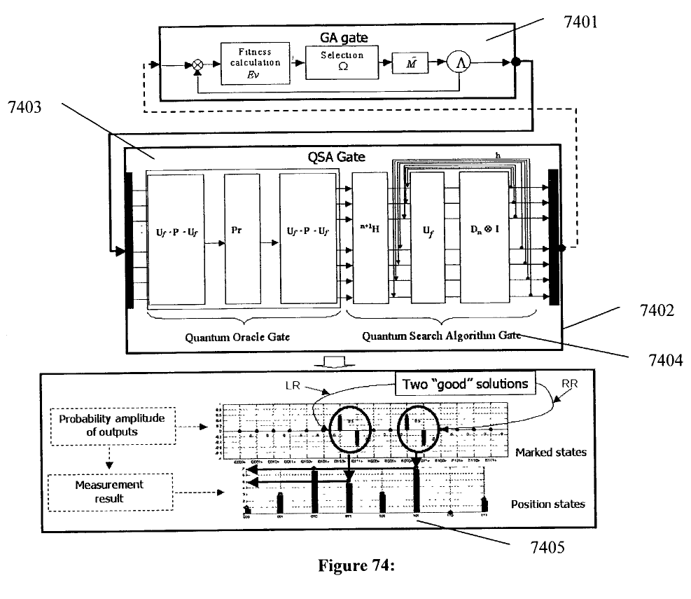

One can use Grover's algorithm to determine which one of the four survived states is the oracle. FIG. 74 shows the forming process of a KB from look-up tables described in FIG. 33. Registers LR1 and RR1 in Table 1, and registers LR2 and RR2 in Table 2 (from FIG. 33 and in FIG. 72) have positions 1/8 and 7/3, corresponding to Cell1 and Cell2 in FIG. 33. These positions are produced by the GA in Box 7401 in FIG. 74. Box 7403 shows a search for new positions for registers LR and RR. Box 7402 and Box 7404 realize Grover's QSA. Box 7405 shows the results of measurements after Grover's QSA for registers LR and RR as 5/7.

This algorithm has three advantages compared to prior algorithms: it is exponentially fast; it zeros in to the oracle with probability one; and it admits an extra degree of freedom in the choice of the initial state.

The present description is organized as a main body and Appendices 1-5. The material in Appendices 1-5 is part of the disclosure, and is placed in the appendices merely to organize the material and not to indicate that it is inferior to the material in the main body. Although this invention has been described in terms of certain embodiments, other embodiments apparent to those of ordinary skill in the art also are within the scope of this invention. Various changes and modifications may be made without departing from the spirit and scope of the invention. Accordingly, the scope of the invention is defined by the claims that follow Appendix 5.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. A quantum search system for global optimization of a knowledge base and a robust fuzzy control algorithm design for an intelligent mechatronic control suspension system based on quantum soft computing, comprising:
a quantum genetic search module configured to develop a teaching signal for a fuzzy-logic suspension controller, said teaching signal configured to provides a desired set of control qualities over different types of roads;
a genetic analyzer module configured to produce a plurality of solutions, at least one solution for each of said different types of roads; and
a quantum search module configured to search said plurality of solutions for information to construct said teaching signal.

2. The quantum search system of claim 1, further comprising a quantum-logic feedback module for simulation of look-up tables for said fuzzy-logic suspension controller.

3. The quantum search system of claim 1, where said genetic analyzer module uses a fitness function that reduces entropy production in a suspension system controlled by said fuzzy-logic controller.

4. The quantum search system of claim 1, where said genetic analyzer module comprises a fitness function that is based on physical laws of minimum entropy and biologically inspired constraints relating to rider comfort or driveability.

5. The quantum search system of claim 1, wherein said genetic analyzer is used in an off-line mode to develop said plurality of solutions for one or more roads having different statistical characteristics.

6. The quantum search system of claim 1, wherein each of said solutions is optimized by the genetic analyzer module for a particular type of road.

7. The quantum search system of claim 1, wherein an information filter is used to filter said plurality of solution to produce a plurality of compressed solutions.

8. The quantum search system of claim 7, further comprising a fuizzy controller that approximates said teaching signal using knowledge from a knowledge base.

9. A control system for a plant comprising:
a neural network configured to control a fuzzy controller, said fuzzy controller configured to control linear controller that controls said plant;
a genetic analyzer configured to train said neural network, said genetic analyzer comprising a fitness function that reduces sensor information while reducing entropy production based on biologically-inspired constraints.

10. The control system of claim 9, wherein said genetic analyzer uses a difference between a time derivative of entropy in a control signal from a learning control unit and a time derivative of an entropy inside the plant as a measure of control performance.

11. The control system of claim 10, wherein entropy calculation of an entropy inside said plant is based on a thermodynamic model of an equation of motion for said plant that is treated as an open dynamic system.

12. The control system of claim 9, wherein said genetic analyzer generates a teaching signal for each of a plurality of solution spaces.

13. The control system of claim 9, wherein said linear control system produces a control signal based on data obtained from one or more sensors that measure said plant.

14. The control system of claim 13, wherein said plant comprises a suspension system and said cone or more sensors comprise angle and position sensors that measure angle and position of elements of the suspension system.

15. The control system of claim 9, wherein fuzzy rules used by said fuzzy controller are evolved using a kinetic model of the plant in an offline learning mode.

16. The control system of claim 15, wherein data from said kinetic model are provided to an entropy calculator that calculates input entropy production and output entropy production of the plant.

17. The control system of claim 16, wherein said input entropy production and said output entropy production are provided to a fitness function calculator that calculates a fitness function as a difference in entropy production rates constrained by one or more constraints obtained from rider preferences.

18. The control system of claim 17, wherein said genetic analyzer uses said fitness function to develop a set of training signals for an off-line control system, each training signal corresponding to a different operational environment.

19. The control system of claim 18, wherein a quantum search algorithm is used to reduce the complexity of said set of training signals by developing a universal training signal.

20. The control system of claim 9, wherein control parameters in the form of a knowledge base from an off-line control system are provided to an online control system that, using information from said knowledge base, develops a control strategy, said knowledge base developed in part by using a quantum search algorithm.

21. A method for controlling a nonlinear plant by obtaining an entropy production difference between a time derivative dSᵤ/dt of an entropy of the plant and a time derivative dS_{c}/dt of an entropy provided to the plant from a controller; using a genetic algorithm that uses the entropy production difference as a performance function to evolve a control rule in an off-line controller; filtering control rules from an off-line controller to reduce information content and providing filtered control rules to an online controller to control the plant.

22. The method of claim 21, further comprising using said online controller to control a damping factor of one or more shock absorbers in the vehicle suspension system.

23. The method of claim 21, further comprising evolving a control rule relative to a variable of the controller by using of a genetic algorithm, said genetic algorithm using a fitness function based on said entropy production difference.

24. A self-organizing control system, comprising: a simulator configured to use a thermodynamic model of a nonlinear equation of motion for a plant, a fitness function module that calculates a fitness function based on an entropy production difference between a time differentiation of an entropy of said plant dSᵤ/dt and a time differentiation dS_{c}/dt of an entropy provided to the plant by a linear controller that controls the plant; a genetic analyzer that uses said fitness function to provide a plurality of teaching signals, each teaching signal corresponding to a solution space; a quantum search algorithm module configured to find a global teaching signal from said plurality of teaching signals; a fuzzy logic classifier that determines one or more fuzzy rules by using a learning process and said global teaching signal; and a fuzzy logic controller that uses said fuzzy rules to set a control variable of the linear controller.

25. The self-organizing control system of claim 24, wherein said global teaching signal is filtered to remove stochastic noise.

26. A control system comprising: a genetic algorithm that provides a plurality of teaching signals corresponding to a plurality of spaces using a fitness function that provides a measure of control quality based on reducing production entropy in each space; a local entropy feedback loop that provides control by relating stability of a plant and controllability of the plant; and a quantum search module to provide a global control teaching signal from said plurality of teaching signals.

27. The control system of claim 26, wherein said quantum search module comprises a quantum associative memory.

28. The control system of claim 27, wherein said quantum associative memory is used in a quantum neural network.

29. The control system of claim 28, wherein said plant is a vehicle suspension system.

30. The control system of claim 29, wherein each of said spaces corresponds stochastic characteristics of a selected stretch of road.

31. An optimization control method for a shock absorber comprising the steps of:
obtaining a difference between a time differential of entropy inside a shock absorber and a time differential of entropy given to said shock absorber from a control unit that controls said shock absorber; and
optimizing at least one control parameter of said control unit by using a genetic algorithm and a quantum search algorithm, said genetic algorithm using said difference as a fitness function, said fitness function constrained by at least one biologically-inspired constraint.

32. The optimization control method of claim 31, wherein said time differential of said step of optimizing reduces an entropy provided to said shock absorber from said control unit.

33. The optimization control method of claim 31, wherein said control unit is comprises a fuzzy neural network, and wherein a value of a coupling coefficient for a fuzzy rule is optimized by using said genetic algorithm.

34. The optimization control method of claim 31, wherein said control unit comprises an offline module and a online control module, said method further including the steps of optimizing a control parameter based on said genetic algorithm by using said performance function, determining said control parameter of said online control module based on said control parameter and controlling said shock absorber using said online control module.

35. The optimization control method of claim 34, wherein said offline module provides optimization using a simulation model, said simulation model based on a kinetic model of a vehicle suspension system.

36. The optimization control method of claim 34, wherein said shock absorber is arranged to alter a damping force by altering a cross-sectional area of an oil passage, and said control unit controls a throttle valve to thereby adjust said cross-sectional area of said oil passage.

37. A method for control of a plant comprising the steps of: calculating a first entropy production rate corresponding to an entropy production rate of a control signal provided to a model of said plant; calculating a second entropy production rate corresponding to an entropy production rate of said model of said plant; determining a fitness function for a genetic optimizer using said first entropy production rate and said second entropy production rate; providing said fitness function to said genetic optimizer; providing a teaching output from said genetic optimizer to a quantum search algorithm followed by an information filter; providing a compressed teaching signal from said information filter to a fuzzy neural network, said fuzzy neural network configured to produce a knowledge base; providing said knowledge base to a fuzzy controller, said fuzzy controller using an error signal and said knowledge base to produce a coefficient gain schedule; and providing said coefficient gain schedule to a linear controller.

38. The method of claim 37, wherein said genetic optimizer minimizes entropy production under one or more constraints.

39. The method of claim 38, wherein at least one of said constraints is related to a user-perceived evaluation of control performance.

40. The method of claim 37, wherein said model of said plant comprises a model of a suspension system.

41. The method of claim 37, wherein said second control system is configured to control a physical plant.

42. The method of claim 37, wherein said second control system is configured to control a shock absorber.

43. The method of claim 37, wherein said second control system is configured to control a damping rate of a shock absorber.

44. The method of claim 37, wherein said linear controller receives sensor input data from one or more sensors that monitor a vehicle suspension system.

45. The method of claim 44, wherein at least one of said sensors is a heave sensor that measures a vehicle heave.

46. The method of claim 44, wherein at least one of said sensors is a length sensor that measures a change in length of at least a portion of said suspension system.

47. The method of claim 44, wherein at least one of said sensors is an angle sensor that measures an angle of at least a portion of said suspension system with respect to said vehicle.

48. The method of claim 44, wherein at least one of said sensors is an angle sensor that measures an angle of a first portion of said suspension system with respect to a second portion of said suspension system.

49. The method of claim 37, wherein said second control system is configured to control a throttle valve in a shock absorber.

50. A control apparatus comprising: off-line optimization means for determining a control parameter from an entropy production rate to produce a knowledge base from a compressed teaching signal found by a quantum search algorithm; and online control means for using said knowledge base to develop a control parameter to control a plant.
